(19) United States
(12) Patent Application Publication
(10) Pub. No.: US 2025/0391289 A1
(43) Pub. Date: Dec. 25, 2025

(54) Mobile Application and Method for Assisting Visually Impaired Users in Accurate Makeup Application

(71) Applicant: ELC MANAGEMENT LLC, Melville, NY (US)

(72) Inventor: Christopher Aidan, Austin, TX (US)

(21) Appl. No.: 18/748,805

(22) Filed: Jun. 20, 2024

(51) Int. Cl. G09B 21/00; A45D 44/00; G06T 7/246; G06T 7/73; G06T 17/20; G06T 19/00; G06V 40/16; G08B 6/00

(52) U.S. Cl. CPC G09B 21/006; A45D 44/005; G06T 7/251; G06T 7/75; G06T 17/20; G06T 19/006; G06V 40/166; G08B 6/00; G09B 21/003; G06T 2200/04; G06T 2200/08; G06T 2200/24; G06T 2207/30201; G09B 21/008

(57) ABSTRACT

Systems and methods assist users of cosmetic products in performing cosmetic routines, such as the application, adjustment and/or removal of one or more cosmetic products. More particularly, generated assistance may be of particular use to users having one or more visual impairments such as colorblindness, severe farsightedness, cataracts, etc., by providing audial and/or haptic input and/or output to guide users through accurate performance of desired cosmetic routines. Assistance is provided via obtaining and manipulating a three-dimensional face mesh digitally representing detected points and features of interest on the face of the user, and guiding the user through use of the cosmetic product(s) with respect to the detected features. Various technologies also enable users to explore and share cosmetic products, styles of applying products, and “looks” combining products and/or styles.

### FIELD OF THE DISCLOSURE

The present disclosure is related generally to augmented reality and facial analysis applications, and more particularly, to techniques for assisting visually impaired users in accurately executing cosmetic routines such as the application of cosmetic products.

### BACKGROUND

Creators of cosmetics products (“cosmetics”), such as skincare products, eye products, lip products, etc. provide products to suit the unique desires, needs, and features of users spanning across myriad, ages, sexes, gender expressions, physical features, and ethnic or cultural backgrounds. Even with the wide range of available cosmetic products, though, many users experience challenges in successfully performing cosmetic routines (for example involving applying, adjusting, or removing their cosmetics) without assistance from another person. For instance, users with less experience with cosmetics may have difficulties applying cosmetics to their own liking. Additionally, users with one or more visual impairments (e.g., severe hyperopia (farsightedness), partial or full blindness, colorblindness, macular degeneration, cataracts, glaucoma, etc.) may particularly experience difficulties in their cosmetic routines. Users may find it particularly difficult, for example, to visually conceptualize and/or execute steps of a cosmetic routine, and to verify they have completed each step successfully. When a user requires human assistance to perform a cosmetic routine, such assistance may not be readily available. Moreover, even when assistance is available, need for assistance can still adversely affect the user's confidence and independence and prevent the user from exploring and experiencing a full range of cosmetic products.

### SUMMARY

The present disclosure, at a high level, provides systems and methods to virtually assist users in performing cosmetic routines, for example involving the application, removal, adjustment, or other management of one or more cosmetic products. The virtual assistance (or “guidance”) methods of this disclosure may be of particular help to users having one or more visual impairments, for example by enabling audial and/or haptic input/output to walk users through their routines. Moreover, various social functionalities described herein enable users to find, save, subscribe to, and share their favorite cosmetic products and/or routines, thus providing social and inclusive functionalities for a wide array of cosmetic users.

Embodiments of this disclosure involve generating a three-dimensional (3D) face mesh of a user based upon image data representing the user's face. Systems herein may generate the 3D face mesh via artificial intelligence and/or computer vision techniques, examples of which will be provided herein. The 3D face mesh identifies a plurality of points on the face of the user, including information associated with each point (e.g., location, color, etc.). From the plurality of identified points, the 3D face mesh identifies various facial features of the user, including for example the user's eyes, eyebrows, forehead, nose, nostrils, lips, cheekbones, chin, ears, hairline, etc. Furthermore, the 3D face mesh characterizes the facial features of the user, for example to identify sizes, proportions, relative locations, and skin condition of features. Based on upon the user's features, systems and methods of this disclosure recommend cosmetic products and/or cosmetic routines specifically suited to user's desires and needs. Recommendation systems provided herein may be based upon artificial intelligence techniques, improving and refining recommendations based upon explicit feedback and/or other information obtained throughout use of technologies of this disclosure. Moreover, in embodiments, the user may particularly provide feedback regarding the accuracy of their generated 3D face mesh, to enable systems herein to adapt the 3D face mesh to more accurately and robustly represent the user's unique facial composition. Moreover, in embodiments, the user may provide feedback regarding the 3D face mesh technology itself, e.g. to refine facial points defined therein and to help validate and/or adapt machine learning models via which the 3D face mesh is generated.

Embodiments of this disclosure further involve generating and presenting step-by-step guidance for performing cosmetic routines. Technologies of this disclosure may present directions via visual, audial, and/or haptic output, e.g., to instruct the user toward performing each step, verify that each step was performed successfully, and/or correct or redirect the user when appropriate. Technologies of this disclosure may evaluate how the user performs routines (e.g., which routines the user performs and whether the user completes the routines accurately) in order to further customize subsequent guidance and/or generate recommendations of other cosmetic routines or products for the user (e.g., recommendations to suit the user's unique features, goals, preferences, sensitivities, and skill level).

Still additionally, in embodiments, technologies of this disclosure enable a user to virtually apply or “try-on” various cosmetic products. Specifically, technologies of this disclosure manipulate the generated 3D face mesh to produce a representation of the user's appearance with a chosen cosmetic product. Even more particularly, the user may modify the particular manner or “style” by which a cosmetic product is virtually applied, so as to explore a range of potential uses for any chosen product. Still additionally, in embodiments, the user may virtually explore, try on, and share cosmetic “looks” comprised of combinations of two or more cosmetic products and unique styles for applying each. New and experimental looks can be generated and recommended to the user, for example based upon their favorite or saved photos, products, styles, looks, or routines. Moreover, various social functionalities of this disclosure allow the user to find, save, subscribe to, and/or share the cosmetic products, styles, looks, and routines with their friends and family, and/or with the cosmetic community at large.

In embodiments, technologies of this disclosure integrate with still other smart computing components. For example, technologies herein may integrate with smart packaging of cosmetic products (e.g., RFID, Bluetooth or near field communication (NFC) elements), for example, to help the user identify cosmetic products in their possession, or to obtain recommendations of related cosmetic products or routines. As another example, in embodiments, smart mirrors may be used to capture facial image data to generate the 3D face mesh, and/or to guide the user through a cosmetic routine by virtually representing the performance of cosmetic routine steps and/or by verifying whether the user has successfully completed each step.

In an embodiment, one or more non-transitory computer readable media are provided. The one or more non-transitory computer readable media store instructions that, when executed via one or more processors of one or more computers, cause the one or more computers to (1) obtain first image data representing a face of a user, (2) generate a three-dimensional face mesh based upon the obtained first image data, the three-dimensional face mesh representing a plurality of facial features corresponding to the face of the user, (3) obtain a first indication of at least one of (i) a cosmetic product, or (ii) a cosmetic routine to be performed upon the face of the user, (4) responsive to obtaining the first indication, generate a first one or more directions to the user for performing the cosmetic routine using the cosmetic product, the first one or more directions being generated based upon one or more features from among the plurality of facial features in the three-dimensional face mesh, and/or (5) cause a representation of the generated first one or more directions to be presented to the user via one or more output devices of one or more computing devices accessible to the user. The one or more non-transitory computer readable media may comprise additional, fewer, and/or alternate instructions, including instructions to perform various actions described herein.

In another embodiment, a computer-implemented method is provided, the method being performed via one or more computer processors. The computer-implemented method may include (1) obtaining first image data representing a face of a user, (2) generating a three-dimensional face mesh based upon the obtained first image data, the three-dimensional face mesh representing a plurality of facial features corresponding to the face of the user, (3) obtaining a first indication of at least one of (i) a cosmetic product, or (ii) a cosmetic routine to be performed upon the face of the user, (4) responsive to obtaining the first indication, generating a first one or more directions to the user for performing the cosmetic routine using the cosmetic product, the first one or more directions being generated based upon one or more features from among the plurality of facial features in the three-dimensional face mesh, and/or (5) causing a representation of the generated first one or more directions to be presented to the user via one or more output devices of one or more computing devices accessible to the user. The method may include additional, fewer, and/or alternate actions, including various actions described herein.

In still another embodiment, a computing system is provided. The computing system includes one or more processors, and one or more non-transitory memories. The one or more non-transitory memories may store instructions that, when executed via one or more processors of one or more computers, cause the one or more computers to (1) obtain first image data representing a face of a user, (2) generate a three-dimensional face mesh based upon the obtained first image data, the three-dimensional face mesh representing a plurality of facial features corresponding to the face of the user, (3) obtain a first indication of at least one of (i) a cosmetic product, or (ii) a cosmetic routine to be performed upon the face of the user, (4) responsive to obtaining the first indication, generate a first one or more directions to the user for performing the cosmetic routine using the cosmetic product, the first one or more directions being generated based upon one or more features from among the plurality of facial features in the three-dimensional face mesh, and/or (5) cause a representation of the generated first one or more directions to be presented to the user via one or more output devices of one or more computing devices accessible to the user. The computing system may include additional, fewer, and/or alternate components, and may be configured to perform additional, fewer, and/or alternate actions, including various actions described herein.

Advantages will become more apparent to those of ordinary skill in the art from the following description of the preferred aspects, which have been shown and described by way of illustration. As will be realized, the present aspects can be capable of other and different aspects, and their details are capable of modification in various respects. Accordingly, the drawings and description are to be regarded as illustrative in nature and not as restrictive.

### BRIEF DESCRIPTION OF THE DRAWINGS

FIG. 1A depicts example image data associated with a user device, in accordance with some embodiments of this disclosure;

FIG. 1B depicts an example three-dimensional (3D) face mesh, in accordance with some embodiments;

FIG. 1C depicts example identification of features from a 3D face mesh, in accordance with some embodiments;

FIG. 2 depicts a block diagram of an example facial processing module, in accordance with some embodiments;

FIG. 3 depicts a block diagram of an example virtual cosmetics module, in accordance with some embodiments;

FIG. 4 depicts a block diagram of an example computing environment, in accordance with some embodiments;

FIG. 5A depicts an example graphical user interface (GUI) associated with exploring cosmetic products, in accordance with some embodiments;

FIG. 5B depicts another example GUI associated with exploring cosmetic products, in accordance with some embodiments;

FIG. 5C depicts an example GUI for viewing a cosmetic product, in accordance with some embodiments;

FIG. 5D depicts the GUI of FIG. 5C with an additional functionality to save a cosmetic product, in accordance with some embodiments;

FIG. 5E depicts the GUI of FIG. 5C with an additional functionality to subscribe to a cosmetic product, in accordance with some embodiments;

FIG. 5F depicts an example user profile GUI, in accordance with some embodiments;

FIG. 6A depicts an example GUI indicating cosmetic products available for virtual try-ons, in accordance with some embodiments;

FIG. 6B depicts another example GUI indicating cosmetic products available for virtual try-ons, in accordance with some embodiments;

FIG. 6C depicts an example virtual try-on GUI, in accordance with some embodiments;

FIG. 6D depicts the virtual try-on GUI of FIG. 6C with a cosmetic product virtually applied to a face of a user, in accordance with some embodiments;

FIG. 7A depicts an example GUI indicating looks available for virtual try-ons, in accordance with some embodiments;

FIG. 7B depicts an example virtual try-on GUI with functionality to add cosmetic products to a user-generated look; in accordance with some embodiments;

FIG. 7C depicts an example GUI for adding cosmetic products to the user-generated look from FIG. 7B, in accordance with some embodiments;

FIG. 7D depicts another example GUI for adding cosmetic products to the user-generated look from FIG. 7B, in accordance with some embodiments;

FIG. 8A depicts an example GUI indicating available virtual tutorials, in accordance with some embodiments;

FIG. 8B depicts another example GUI indicating available virtual tutorials, in accordance with some embodiments;

FIG. 8C depicts an example GUI indicating steps of a virtual tutorial, in accordance with some embodiments;

FIG. 8D depicts an example execution of a step from the virtual tutorial GUI of FIG. 8C, in accordance with some embodiments;

FIG. 8E depicts an example full-screen GUI for executing a step of a virtual tutorial, in accordance with some embodiments;

FIG. 8F depicts example evaluation of execution of the step from the GUI of FIG. 8E, in accordance with some embodiments;

FIG. 8G depicts an example GUI indicating available virtual guidance for saved looks, in accordance with some embodiments;

FIG. 8H depicts an example GUI indicating steps of virtual guidance for applying a look, in accordance with some embodiments;

FIG. 9 depicts another example user profile GUI, in accordance with some embodiments;

FIG. 10A depicts an example recommendations GUI, in accordance with some embodiments;

FIG. 10B depicts an example skin analysis GUI, in accordance with some embodiments;

FIG. 10C depicts another representation of the skin analysis GUI of FIG. 10B, in accordance with some embodiments;

FIG. 10D depicts an example look inspiration GUI, in accordance with some embodiments;

FIG. 11A depicts still another example user profile GUI, in accordance with some embodiments;

FIG. 11B depicts an example 3D face mesh adaptation GUI, in accordance with some embodiments;

FIG. 11C depicts an example use case of the 3D face mesh adaptation GUI of FIG. 11B, in accordance with some embodiments;

FIG. 11D depicts another example use case of the 3D face mesh adaptation GUI of FIG. 11B, in accordance with some embodiments;

FIG. 11E depicts an example virtual try-on feedback GUI, in accordance with some embodiments;

FIG. 11F depicts an example user case of the virtual try-on feedback GUI from FIG. 11E, in accordance with some embodiments;

FIG. 12A depicts example computing elements associated with use of smart cosmetic product packaging, in accordance with some embodiments;

FIG. 12B depicts an example GUI associated with use of smart cosmetic product packaging, in accordance with some embodiments;

FIG. 13A depicts a flow diagram of an example computer-implemented method associated with virtual guidance, in accordance with some embodiments;

FIG. 13B depicts a flow diagram of an example computer-implemented method associated with generating a personalized cosmetic arrangement, in accordance with some embodiments;

FIG. 13C depicts a flow diagram of an example computer-implemented method associated with user feedback for a 3D face mesh, in accordance with some embodiments; and

FIG. 13D depicts a flow diagram of an example computer-implemented method associated with generating a personalized look, in accordance with some embodiments;

The figures depict embodiments of this disclosure for purposes of illustration only. One skilled in the art will readily recognize from the following discussion that alternate embodiments of the structures and methods illustrated herein may be employed without departing from the principles set forth herein. The figures are not to scale. Instead, they are drawn to clarify aspects of this disclosure. Connecting lines or connectors shown in the various figures presented are intended to represent example functional relationships, physical couplings, or logical couplings between the various elements. In general, the same reference numbers will be used throughout the drawing(s) and accompanying written description to refer to the same or like parts.

### DETAILED DESCRIPTION

Reference will now be made in detail to the various embodiments and aspects of this disclosure illustrated in the accompanying drawings. Wherever possible, the same or like reference numbers will be used throughout the drawings to refer to the same or like features. Certain terminology is used in the following description for convenience only and is not limiting.

As used herein, the terms “cosmetic product,” “cosmetics,” and the like can refer to any of a variety of products applied to a face and/or surrounding body parts of a person (e.g., scalp, neck, hair, etc.). Cosmetic products for example include, but are not necessarily limited to, skincare products (e.g., moisturizers, ointments, cleansers, toners, creams, oils, sunscreens, chemical peels, scrubs, etc.), other facial cosmetic products (e.g., foundations, concealers, powders, blushes, bronzers, etc.), lip products (e.g., lipsticks, lip glosses, lip balms, lip oils, primers, lacquers, etc.), eye cosmetic products (e.g., artificial lashes, under-eye concealers, eyeliners, eyebrow pencils, mascaras, eye shadows, etc.), dental cosmetic products (e.g., tooth brightening products), hair products (e.g., shampoos, conditioners, serums, dyes, hairsprays, waxes, gels, mousses, hair trimming/removal products, etc.), facial prostheses, etc. Still additionally or alternatively, cosmetic products can include fragrances, such as perfumes or colognes. Cosmetic products may include products applied for various purposes, including for example aesthetic purposes, functional purposes, medical purposes, or some combination thereof. Moreover, cosmetic products, as referred to herein, may include natural and/or artificial (i.e., human-made) products.

A “cosmetic routine,” as referred to herein, is routine that is executable by a human and that relates to the use of one or more cosmetic products. A cosmetic routine may, for example, involve applying, removing, or adjusting one, two, three, four or more cosmetic products. Still additional examples of cosmetic routines will be provided herein, for example involving the organization or management of cosmetic products, safe disposal of cosmetic products, and/or sanitization of a user's face in preparation for cosmetics. A cosmetic routine may be characterized as comprising one or more discrete “steps,” where systems and methods of this disclosure generate and output directions to the user that, when followed thoroughly and accurately, result in the completion of one or more steps. Steps of a cosmetic routine may be ordered (i.e., requiring completion in a particular sequence) or unordered.

Various benefits of technologies of this disclosure will be described. At least some of these benefits will be evidenced by consideration of the experiences of users having one or more visual impairments. However, it will be evident that benefits of the technologies herein may be realized by all users, e.g. users having various capabilities, limitations, preferences, and skill levels.

### Example Three-Dimensional (3D) Face Mesh Technologies

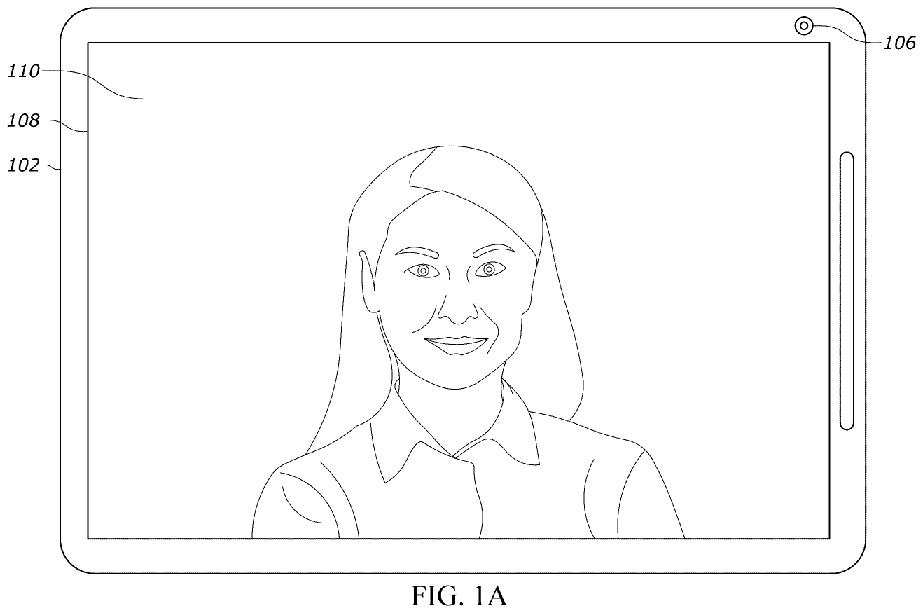

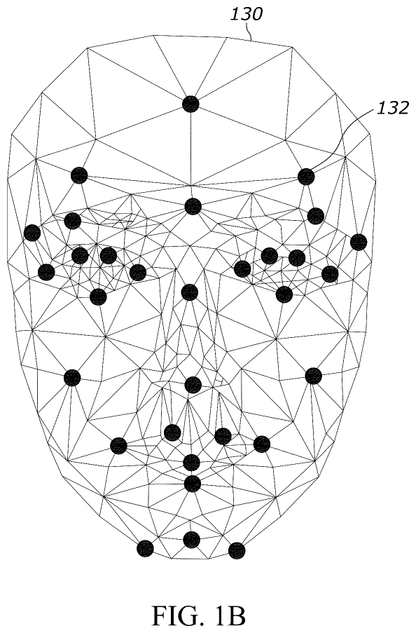

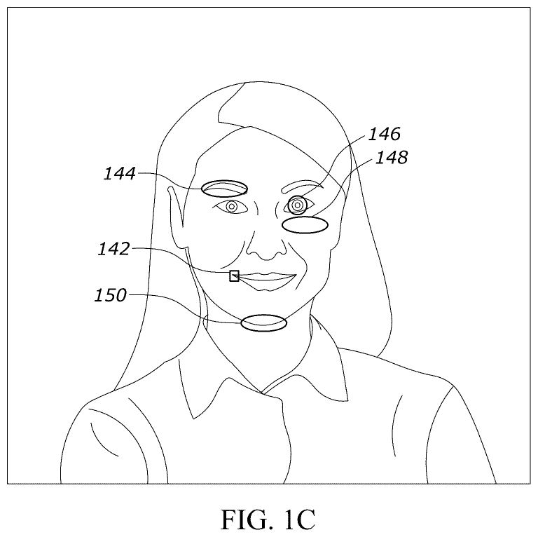

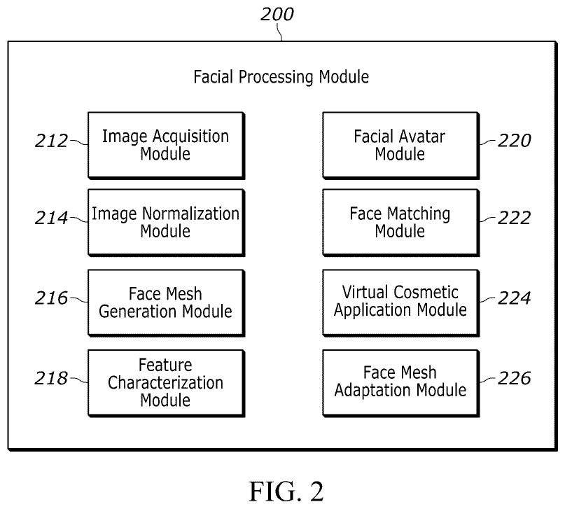

Various technologies of this disclosure generally involve generating, adjusting, storing, manipulating, and/or displaying a three-dimensional (3D) mesh digitally representing a face of a human user (hereinafter referred to as a “3D face mesh”). Examples of these technologies will be described with respect to FIGS. 1A-1C and FIG. 2.

FIG. 1A depicts an example electronic computing device 102 (“user device”) operable to obtain image data of a user of technologies of the present disclosure. Generally speaking, technologies of the present disclosure use the obtained image data to generate, adjust, and/or manipulate the user's unique 3D face mesh. At a high level, the user device 102 may include one or more processors and one or more memories (e.g., one or more non-transitory memories) storing instructions that, when executed via the one or more processors, cause a camera 106 (i.e., one or more cameras) associated with the user device 102 to obtain image data representing the face of the user (and/or other body parts of the user, e.g., scalp, hair, neck, etc.). The user device 102 may be, for example, a smartphone, a tablet computing device, a laptop computer, a desktop computer, a smart wearable computing device (e.g., smart watch), a virtual reality (VR) device (e.g., VR headset), a computing device disposed in a retail environment (e.g., at a cosmetic retailer) and/or another suitable computing device(s).

The camera 106 may be physically included in the user device 102, as is depicted in FIG. 1A. In some embodiments, though, the camera 106 may be located externally to the user device 102, e.g., in a webcam or a smart mirror operationally connected to the user device 102 (e.g., via direct wired and/or wireless communications, via exchange of data over the Internet, etc.). Moreover, combinations of cameras may be utilized, including for example of one or more internal cameras and one or more external cameras (e.g., a user's smartphone or laptop camera aided by an external webcam or camera-enabled mirror). In any case, image data obtained via the camera 106 may for example include still photographic images, photographic video images, thermal image data, LiDAR or other laser-based image data, and/or other image data suitable for generating a 3D face mesh and/or operating other technologies of this disclosure.

As depicted in FIG. 1A, a display 108 of the device shows image data 110 (i.e., one or more images) obtained by the camera 106. The image data 110 as obtained by the camera 106 depicts the face of a user. The display 108 may for example be a touchscreen display of the user device 102, or another type of display contained within or otherwise operatively connected to the user device 102. In various embodiments of this disclosure, one or more graphical user interfaces (GUIs) execute at the user device 102 via the display 108 to display real-time image data and/or other image data obtained via the camera 106 (and/or via other sources, e.g., images retrieved via the Internet). Moreover, in various embodiments of this disclosure, one or more GUIs executing at the user device 102 digitally manipulate facial imagery of the user displayed via the display 108, for example to virtually try on cosmetic products, to guide the user through cosmetic routines, and/or to be displayed via the display 108, for example to preview the application of cosmetic products to the user, to guide the user through cosmetic routines, and/or to present recommendations of particular cosmetic products to suit cosmetic needs of the user.

In various embodiments, GUIs at the user device 102 utilize augmented reality (AR) techniques, for example to display various AR elements over representations of the user's face to virtually apply cosmetic products or guide the user through cosmetic routines. AR elements may be visually displayed in combination with other forms of output, e.g. audio output and/or haptic output produced via the user device 102 and/or other linked devices of the user. AR elements for presentation via the user device 102 may be generated locally at the user device 102, and/or via one or more other computing devices in communication with the user device 102 (e.g., via one or more servers). In embodiments, displays of AR elements are updated substantially in real-time (i.e., without delay beyond that required for automatic processing and display of images) in accordance with real-time image data obtained at the user device 102 (e.g., to update AR elements identifying the user's facial features as the features change location in the camera frame).

In any event, technologies of this disclosure generate a three-dimensional (3D) mesh representing the face of the user based upon the image data, as represented in FIG. 1B. A 3D face mesh 130 as depicted in FIG. 1B may be generated, for example, via the one or more processors of the user device 102 of FIG. 1A, and/or via one or more other computing devices in communication therewith (e.g., via one or more servers). In some embodiments, for example, the user device 102 may be configured to provide image data substantially in real-time to one or more servers, and the one or more servers may be configured to generate or manipulate the 3D face mesh 130 substantially in real-time from the provided image data. The one or more servers may transmit data indicating the 3D face mesh back to the user device 102, which may use the received data to display or adjust a representation of the 3D face mesh still substantially in real-time from the initial obtaining of image data at the user device 102.

The 3D face mesh 130 identifies each of a plurality of facial points 132 on the face of the user and/or on surrounding body parts (e.g., the scalp, hair, neck, etc.). In the representation of the 3D face mesh 130 in FIG. 1B, each identified facial point 132 lies at the intersection of two or more lines connecting the identified points 132. Each identified facial point 132 may be associated with positional information (e.g., positions in the x-, y-, and z-axes), color information (e.g., hue, saturation, brightness, etc.), and/or other information. More particularly, the 3D face mesh 130 may identify each point 132 as corresponding to a facial feature of the user or a particular portion thereof (e.g., a corner of a mouth, an edge of a nose, a part of a lip, eye, nose, chin, forehead hair, eyelash, etc.).

In embodiments, generating the 3D face mesh 130 includes iteratively identifying and evaluating facial points 132 on the face (and/or surrounding parts) of the user to identify facial points 132 corresponding to particular facial “landmarks” of interest (e.g., the corner of the mouth, the top of the nose, the outline of the eyes, the edges of the hairline, cheekbones, etc.). For example, based upon information associated with facial points 132 identified in a first iteration of generating the 3D face mesh 130, a second, third, fourth, etc. iteration(s) of generating the 3D face mesh 130 may be executed to iteratively identify points closer to the landmarks of interest until each point of interest is positively identified. The facial points 132 in the face mesh may thus correspond to the particular facial landmarks of interest, as iteratively determined via these techniques.

In any case, the number of facial points 132 in the 3D face mesh 130 may vary based upon a number of considerations. Particularly, the number of facial points may vary based upon the quality (e.g., resolution) of facial image data from which the 3D face mesh 130 is to be generated, and/or based upon the processing power immediately available to one or more computer processing elements via which the 3D face mesh 130 is generated. For example, with reference to FIG. 1A, in scenarios where generation of the 3D face mesh 130 must rely entirely upon local processing power available to the user device 102 (e.g., when the user device 102 is not connected to one or more servers), the 3D face mesh 130 may include comparatively fewer points due to the comparatively limited available processing power at the user device 102. By contrast, when the user device 102 has substantially more processing power, and/or the user device 102 is connected to one or more servers with substantially more processing power and a high data throughput rate, the 3D face mesh 130 may include a comparatively larger number of facial points 132. The number of facial points 132 may also vary according to the needs of the application for which the 3D face mesh 130 is to be used (e.g., to include additional points when the highest level of detail and fidelity is required). Moreover, in scenarios where the 3D face mesh 130 is repeatedly regenerated and/or adapted throughout operation of the technologies described herein, the number of facial points 132 in the 3D face mesh may vary in connection with potential variance in image quality and/or available processing power over a duration of use. Accordingly, in various possible scenarios, the 3D face mesh 130 may, for any use of the technologies of this disclosure, include twenty, fifty, eighty, one hundred, three hundred, five hundred, one thousand, two thousand, five thousand or more discrete points corresponding to the face of the user. Techniques of this disclosure may include determining and adaptively re-determining the number of facial points 132 to be included in the 3D face mesh 130 based upon updates to available image quality and/or processing capabilities.

Generating the 3D face mesh 130 based upon obtained image data may include the use of various artificial intelligence (AI) and/or computer vision techniques. Particularly, AI and/or computer vision techniques for generating the 3D face mesh 130 may include machine learning and/or computer vision techniques, including but not limited to deep learning, artificial neural networks (fuzzy neural networks, feedforward neural networks, convolutional neural networks, etc.), hidden Markov models, classification, clustering, principal component analysis (PCA), discrete cosine transform (DCT), linear discriminant analysis (LDA), locality preserving projection (LPP), Gabor wavelet techniques, independent component analysis (ICA), generative adversarial networks (GANs), federated learning, and/or other approaches for facial identification/recognition/generation. It should be appreciated that generating the 3D face mesh 130 may comprise various new or existing techniques, particularly including new or existing AI techniques (e.g., new or existing machine learning techniques). These new or existing techniques may include open source techniques, proprietary techniques, and/or other techniques, including combinations thereof. As will be described further in subsequent sections, AI techniques such as those described above may additionally or alternatively be applied to other systems and methods of this disclosure, for example systems and methods for adapting the 3D face mesh 130, virtually applying cosmetic products, recommending cosmetic products, styles, looks, or routines, and/or generating or adapting directions and/or other output for the user.

In any case, the 3D face mesh 130 identifies facial features of the user, as depicted for example in FIG. 1C. As illustrated in FIG. 1C, the identified features may include a corner of the mouth 142, an eyebrow 144, an eye iris 146, a periocular region 148 around the eye, and a point of the chin 150. Identified features are not limited to the examples depicted in FIG. 1C, and can additionally or alternatively include, for example, a portion or entirety of a lip, nose, ear, forehead, cheek, hairline, piercing, tattoo, wrinkle, pimple, mole, scratch, scar tissue, etc. In some embodiments, a depiction of the features 142, 144, 146, 148, 150, and/or the underlying identified points of the 3D face mesh 130 may be displayed to the user (e.g., at the display of the user device 102), enabling the user for example to provide feedback regarding the generated 3D face mesh 130. The identifications of the features 142, 144, 146, 148, 150 may be displayed via AR techniques, for example via superimposing image data representing the face of the user with AR elements visually identifying respective ones of the features 142, 144, 146, 148, 150.

Each of the features 142, 144, 146, 148, 150 may correspond to a respective one, two, three, four, or more identified facial points 132 from the 3D face mesh 130, and/or to a respective region bounded by a plurality of identified points from the 3D face mesh 130. Each of the identified features may have various identified characteristics associated therewith, including for example position, angular orientation, color, tone, condition of skin contained therein (e.g., oily, dry, smooth, wrinkled, stretched, etc.), relative arrangement to another identified feature(s), etc. Where multiple instances of any particular feature exist on the user's face (e.g., as is the case with eyes, ears, cheekbones, etc.), each instance of the feature is identified and considered independently, so as to account for the user's natural facial asymmetries and/or other variations among the user's facial features.

As will be described in further detail herein, techniques of this disclosure may include analyzing and/or manipulating identified features from the 3D face mesh 130 to, for example (1) virtually apply (“try on”) cosmetic products, e.g. by using AR elements to virtually represent products applied to the user's corresponding features, (2) generate and provide recommendations of cosmetic products or routines for a given feature(s), and/or (3) generate and provide directions to complete steps of a cosmetic routine, and/or (4) verify whether any step of a cosmetic routine was successfully completed.

Use of the technologies of this disclosure may include repeatedly or continuously regenerating and/or adjusting the 3D face mesh 130 based upon new image data obtained via the user device 102 and/or via other sources. Accordingly, feature identification with respect to the 3D face mesh 130 may include updating and tracking the respective positions of features, e.g., as newly obtained image data reflects the user repositioning, rotating, and/or changing their facial expression while within the frame of a device camera while capturing images.

### Example Facial Processing Module

In view of FIGS. 1A-1C, FIG. 2 depicts a block diagram of an example facial processing module 200, which includes various sub-modules that will be described herein. The facial processing module 200 and sub-modules therein may, for example, include computer-executable instructions stored at one or more computer memories, including for example or more memories of the user device 102 of FIG. 1A, one or more servers in communication with the user device 102, and/or some combination thereof (e.g., with modules distributed between two or more computing devices, and/or with portions of any one module distributed among two or more computing devices). In various embodiments, additional and/or fewer sub-modules may be provided. Moreover, in some embodiments, two or more of the sub-modules may be combined.

In any case, computer-executable instructions included in each of the respective sub-modules of the facial processing module 200, when executed via one or more computer processors, may cause one or more computing devices to perform actions attributed to the respective sub-modules herein. As used herein, language such as “the module [performs an action] . . . ,” “the module is configured to [perform an action]” and the like should be interpreted to mean that the module includes computer-executable instructions that, when executed via the one or more processors, cause the module to perform the described action. In various embodiments, outputs of various ones of the sub-modules are presented to a user via one or more user interfaces, e.g., via one or more GUIs executing via a display of a device of the user (e.g., display 108 of device 102), via a voice-based interface (e.g., text-to-speech), via haptic output, etc.

The facial processing module 200 of FIG. 2 includes an image acquisition module 212 that is configured to obtain image data from which a 3D face mesh is generated and/or adapted. Particularly, in embodiments, the image acquisition module 212 is configured to cause one or more cameras to capture imagery of a face of a user (e.g., as described with respect to the camera 106 in FIG. 1A). Additionally or alternatively, in some embodiments, the image acquisition module 212 is configured to obtain one or more images from another source(s). For example, the image acquisition module 212 may be configured to obtain stored images via the user's personal device(s) and/or via one or more servers. Particularly, in embodiments, the image acquisition module 212 is configured to cause one or more user interfaces (e.g., GUIs, voice interfaces, etc.) to execute at the user's device to enable the user to select one or more stored image files (e.g., saved photos or videos) for use in generating a 3D face mesh for the user.

The facial processing module 200 of FIG. 2 further includes an image normalization module 214, which may be configured to perform preliminary processing upon obtained image data to assist in generating the 3D face mesh. For example, the image normalization module 214 may be configured to rotate, resize, and/or crop relevant facial image data from obtained image data, to assist a 3D face mesh generation module that is configured to generate and/or adjust the 3D face mesh according to the techniques of this disclosure (e.g., as described with respect to FIGS. 1A-1C). Particularly, the face mesh generation module 216 may be configured to generate the 3D face mesh based upon output of the image acquisition module 212 and/or image normalization module 214, using artificial intelligence techniques and/or other suitable techniques described herein.

Still referring to FIG. 2, the facial processing module 200 includes a feature characterization module 218 configured to identify and characterize features associated with the face of the user (and/or surrounding parts of the user) based upon identified points in the generated 3D face mesh. The feature characterization module 218 may, for example, identify and characterize features such as those described with respect to FIG. 1C, e.g., the contents and borders of features (e.g., eyes, eyebrows, nose, ears, lips, hair, etc.), as well other attributes such as size, shape, angular orientation, proportion, proximity to other features, condition of skin contained therein (e.g., texture, color/tone, or wrinkles), etc. In embodiments, operations of the face mesh generation module 216 and the feature characterization module 218 may be combined. That is, the generation of the 3D face mesh via the face mesh generation module 216 may include the identification or characterization of facial features as described with respect to the feature characterization module 218.

In various embodiments, outputs of the face mesh generation module 216 and/or the feature characterization module 218 are presented to the user via one or more user interfaces executing at a device of the user (e.g., via the display 108 of the user device 102 as described with respect to FIG. 1A, and/or via a voice interface). For example, one or more augmented reality graphical user interfaces which may execute via the device of the user to cause display of obtained image data superimposed with AR elements indicating (1) identified facial points comprising the user's 3D face mesh, (2) regions of note bounded by a plurality of identified facial points, (3) identified features of the user's face (and identified characteristics thereof), and/or (4) directions or recommendations regarding applications of cosmetic products to particular features of the face or surrounding parts of the user.

In embodiments as will be described further in this disclosure, outputs of the face mesh generation module 216 and/or the feature characterization module 218 are utilized to recommend cosmetic products, combinations of products, and/or cosmetic routines. Still more particularly, in embodiments, outputs of the face mesh generation module 216 and/or the feature characterization module 218 are utilized to generate and present customized directions to users regarding performance of cosmetic routines, for example in the form of visual, audial, and/or haptic output indicating the directions.

In embodiments, the facial processing module 200 includes a facial avatar module 220 that, in embodiments, may be configured to generate an artificial digital representation or “avatar” of the face of the user (or a relevant portion thereof), based upon outputs of the face mesh generation module 216 and/or the feature characterization module 218. That is, the facial avatar module 220 may “morph” a pre-rendered digital avatar to the characteristics of the user's face (as indicated by the user's face mesh and/or features therein) to the digital avatar to facilitate operation of the technologies of the present application, in scenarios for example where imagery of the actual face of the user is not available (e.g., to virtually try on a cosmetic product by way of applying the cosmetic product to the avatar morphed to the user's features).

The facial processing module may further include a face matching module 222 which, in embodiments, may be configured to match (i.e., recognize) a user depicted in obtained image data to a particular person in stored image or facial data. For example, the face matching module 222 may recognize a user based upon comparison of obtained image data (or a 3D face mesh derived therefrom) to a stored 3D face mesh generated based upon previously obtained image data corresponding to the face of the user. When a match is identified between a newly obtained image data and a stored 3D face mesh (e.g., based upon a face mesh comparison), technologies of the present application may operate upon the stored 3D face mesh instead of the newly obtained image data, so as to remove the need for additional facial processing. Effectively, matching and use of the stored 3D face mesh may facilitate use of the technologies of this disclosure even when the user's device does not support high-resolution image acquisition or does not have sufficient available processing power. In still other embodiments, the user may be matched to a stored 3D face mesh via other means, for example via input of a username and password, security questions, fingerprint identification, voice-based identification, etc.

Still yet referring to FIG. 2, the facial processing module 200 includes a virtual cosmetic application module 224 that may be configured to generate and present representations of cosmetic products virtually applied to a user's face. More particularly, the virtual cosmetic application module 224 may store and/or access data identifying cosmetic products, the corresponding region(s) of the faces (and/or other body parts) of users to which the cosmetic products are to be applied, and the modifications to a user's appearance that is achieved through application of the cosmetic. Based upon the stored and/or accessed data associated with the cosmetic product, the virtual cosmetic application module 224 may virtually apply given cosmetic product to a user by manipulating the 3D face mesh of the user and causing display of the manipulated face mesh via one or more GUIs (e.g., an augmented reality GUI).

For example, to virtually apply a dark eyeliner product, the virtual cosmetic application module 224 may be configured to store and/or access (1) information identifying or otherwise describing the eyeliner product (e.g., brand name, color, composition, product reviews and/or other feedback, sales and/or consumer data, criteria for recommending the product, etc.), (2) information identifying where and/or how the eyeliner is to be applied (e.g., identifying bounds of a periocular region about the eye to which the eyeliner is to be applied, and the ordered actions associated with applying/adjusting/removing the eyeliner), and/or (3) information identifying the visual effects achieved by applying the eyeliner in a directed manner (e.g., one or more parameters or functions setting forth how color and/or other aesthetic parameters of the application region are changed through application of the eyeliner). The virtual cosmetic application module 224 virtually applies the eyeliner by applying the stored/accessed information to the unique 3D face mesh of the user. That is, the user's 3D face mesh, and more particularly a corresponding identified periocular region or collection of points in the user's 3D face mesh, is manipulated according to the visual effect information accessed/stored by the virtual cosmetic application module 224. Accordingly, an augmented reality (AR) interface at a device of the user may display the user's face superimposed with one or more AR elements representing application of the eyeliner to one or more both eyes of the user. Similar or analogous techniques apply to various other cosmetic products described in this disclosure (e.g., to virtually apply lip glosses, foundations, blushes, skin creams, hair dyes, etc.).

In various possible embodiments to be described in further detail herein, the virtual cosmetic application module 224 may be integrated with other functionalities of the present disclosure, e.g. to allow the user to virtually try on looks recommended for the user or assembled by the user, to augment virtual guidance for cosmetic routines, and/or to explore or share cosmetic products, styles, looks, routines, etc.

Still referring to FIG. 2, the facial processing module 200 includes a face mesh adaptation module 226, which may be configured to adapt (i.e., modify) a previously generated 3D face mesh associated with a user, for example based upon obtained feedback indicative of the quality, accuracy, and/or usability of the previously generated 3D face mesh. Obtained user feedback may, for example, include feedback that implicitly indicates the accuracy of the 3D face mesh, or other feedback that implicitly indicates the accuracy of the 3D face mesh (e.g., based upon the user's satisfaction with use of various technologies described herein). In some embodiments, obtained feedback may more directly indicate quality or accuracy of the generated 3D face mesh, for example by indicating accuracy of particular points, regions, or features of the user's face identified by the generated 3D face mesh. In embodiments, more particularly, the face mesh adaptation module 226 may receive feedback may via one or more GUIs that enable the user to review, adjust, and refine individual face mesh points previously identified via the technologies herein (e.g., to manually modify a face mesh previously generated via the sub-modules 216 and/or 218 of FIG. 2). In any case, the face mesh adaptation module 226 may be configured to automatically and responsively adapt the 3D face mesh of a user based upon the obtained feedback, for example by using AI techniques to responsively adjust the 3D face mesh and to learn from user feedback to refine artificial intelligence models utilized to generate 3D face meshes (e.g., to adjust notes and/or weights in one or more artificial neural networks utilized to generate a 3D face mesh based upon input image data).

Subsequent portions of this description will describe functionalities similar to those described with respect to the sub-modules from FIG. 2. Unless explicitly stated otherwise, it should be appreciated that such functionalities may operate in a similar manner to that described with respect to the facial processing module 200 of FIG. 2. For example, the functionalities to be described herein may operate based upon execution of computer-executable instructions at one or more non-transitory computer memories via one or more computer processors, e.g., at a device operated by a user (e.g., a personal electronic device, a computing terminal at a cosmetic retailer, etc.), one or more servers in communication with the user device, and/or some combination thereof.

### Example Modules for Virtual Cosmetics Functionalities

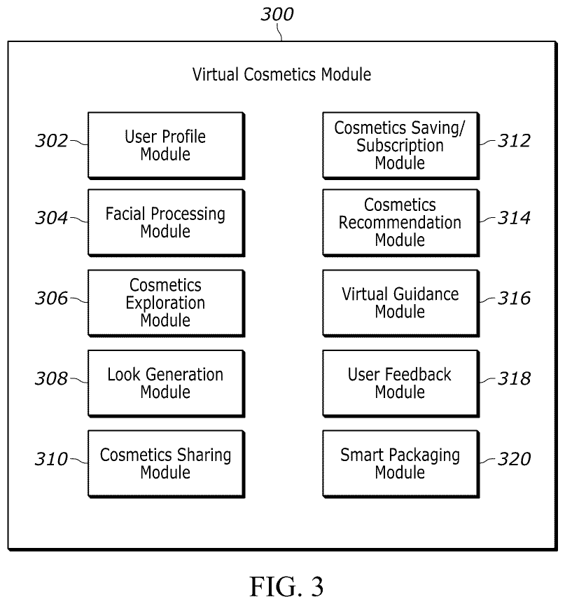

To provide an overview of envisioned functionalities of this disclosure, FIG. 3 depicts a block diagram of an example virtual cosmetics module 300, which includes various sub-modules that will be described herein. At a high level, operations of the virtual cosmetic module, individually and collectively, provide recommendations, assistance, and social functionalities for the use of cosmetic products. Moreover, the operations described herein provide these functionalities inclusively for users of various different backgrounds, skill levels, desires, needs, sensitivities, and/or limitations, including those for whom conventional cosmetics platforms have been less accessible or effective.

As with the facial processing module 200 of FIG. 2, the virtual cosmetics module 300 (and sub-modules thereof) may include computer-executable instructions stored at one or more non-transitory computer memories, such as at one or more memories of the user device 102 of FIG. 1A, one or more servers in communication with the user device 102, at another computing device(s) described herein, and/or some combination thereof (e.g., with modules distributed between two or more computing devices, and/or with portions of any one module distributed among two or more computing devices). At least some of the instructions associated with the virtual cosmetics module 300 may, for example, be contained in one or more software applications downloaded to a device of a user, and/or in one or more Internet pages accessible by the user to access the technologies described herein. In various possible embodiments, additional and/or fewer sub-modules (and corresponding functionalities) may be provided. Moreover, in some embodiments, aspects of two or more of the sub-modules may be combined. For example, a single GUI, voice-based interface, and/or haptic input/output mechanism may involve aspects of two or more of the sub-modules of the virtual cosmetics module 300.

In any case, computer-executable instructions included in each of the respective sub-modules of the virtual cosmetics module 300, when executed via one or more computer processors, may cause one or more computing devices to perform actions attributed to the respective sub-modules herein. As used herein, language such as “the module [performs an action] . . . ,” “the module is configured to [perform an action]” and the like should be interpreted to mean that the module includes computer-executable instructions that, when executed via the one or more processors, cause the module to perform the described action.

A user profile (or “account”) module 302 may generate, store, retrieve, modify, manage, import and/or export user profiles associated with any given user of the technologies described herein. User profile information contained in a user profile for a given user may include, for example, (1) information identifying the user (e.g., name, username, password, profile security information, date of birth, demographic information, emergency contact information in the instance of adverse reactions to cosmetic products, etc.), (2) information identifying preferences of the user regarding use of the technologies described herein (e.g., permissions of technologies described herein to access particular devices owned by the user, device cameras, device sensors, other device hardware, device software, etc., and/or accessibility settings preferences regarding use of visual, audial, and/or haptic forms of input and/or output, preferences to adjust for limited eyesight or colorblindness, etc.), (3) information identifying purchase activity of the user (e.g., shopping history regarding cosmetic products), (4) information identifying product preferences of the user (e.g., allergies or other sensitivities of the user, ethical preferences to filter out certain types or classes of products, etc.), and/or (5) any of various user-associated information that may be generated or manipulated via operation of the technologies described herein (e.g., a 3D face mesh of the user, cosmetic browsing information of the user, cosmetics virtually applied by the user, cosmetics/styles/looks generated or recommended for the user, cosmetics/looks/styles shared by the user, virtual cosmetic guidance provided to the user, feedback provided by the user, smart packaging information identifying products in the user's possession, etc.).

A user profile associated with a user may be stored via one or more personal devices of the user (e.g., via a memory of the user device 102), and/or via one or more servers in communication with the personal device(s). Storage of the user profile via one or more servers may enable access and modification of the user profile across two or more sessions conducted among one, two, three, four or more devices of the user. The user may, for example, log in to a website or software application hosting technologies described herein to access the user's information, previously generated 3D face mesh information, previous activity such as saved or subscribed cosmetic products, styles, looks, etc.

In some embodiments, a user profile may track and report a user's use of technologies herein over time. For example, as the user repeatedly uses virtual assistance for cosmetic routines, the user profile may track the user's progress or improvements in accuracy or efficiency in applying cosmetic products over time, for example to provide encouragement and/or recommendations of cosmetic products, routines, etc. based upon the user's progress. As another example, the user profile may track the user's past use of virtual assistance, recommendation functionalities, etc. to utilize AI techniques to improve virtual assistance, recommendation functionalities, etc. based upon the past user activity.

The virtual cosmetics module 300 includes a facial processing module 304, which may operate in a similar or identical manner to that described with respect to the facial processing module 200 of FIG. 2. By way of example and not limitation, the facial processing module 304 may be configured to obtain image data depicting the face of the user, generate a 3D face mesh representing the face of the user based upon the obtained image data, produce virtual applications of cosmetic products to the face of the user based upon the face mesh, and/or adapt the generated 3D face mesh and/or AI techniques for generating 3D face meshes based upon user feedback.

The virtual cosmetics module 300 of FIG. 3 still further includes a cosmetics exploration module 306. Generally speaking, the cosmetics exploration module 306 may enable the user to browse, sort, filter, and discover a range of cosmetic products from product information that may be stored at a device of the user and/or accessed via one or more servers. In various embodiments, the cosmetics exploration module 306 may enable the use to browse new cosmetic products, popular or “trending” cosmetic products/styles/looks, products/styles/looks recommended for the user, promoted cosmetic products, etc. In embodiments, upon selection of any particular cosmetic product (and/or style or look), the cosmetics exploration module 306 may enable the user to virtually apply the product, style, or look on the user's own face (e.g., via operations of the facial processing module 304).

Still referring to FIG. 3, a look generation module 308 may enable the user to construct “looks” composed of two, three, four or more different cosmetic products and/or styles of application thereof. For example, the user may individually select a plurality of cosmetics identified via the cosmetics exploration module 306, which may cause the facial processing module 304 to produce a virtual application of the plurality of cosmetics to the face of the user (i.e., to “try on the look”). In embodiments, the look generation module 308 enables the user to add or remove cosmetic products from the look, and/or to manually adjust or “stylize” the virtual application of individual ones of the cosmetics comprising the look (e.g., by adjusting the application location, size, color, or intensity of any particular cosmetic product comprising the look).

The virtual cosmetics module 300 of FIG. 3 still further includes a cosmetics sharing module 310, which may enable the user to socially share discovered cosmetic products, styles, and/or looks with other users of the technologies described herein, and/or over one or more social media platforms (e.g., via integration with one or more application programming interfaces (APIs) of respective social media platforms).

The virtual cosmetics module 300 may further include a cosmetics saving and/or subscription module 312. Cosmetic “saving” functionalities therein may enable the user to save, to their user profile, particular cosmetic products, styles, looks, virtual applications, recommendations, or the like to their user profile for future access and/or for public display to other users of the technologies described herein. Cosmetic “subscription” functionalities of the subscription module 312 may enable the user to be subscribed to automatically receive news, offerings, updates, recommendations, and/or other information associated with a subscribed cosmetic product, product seller or manufacturer, cosmetic application style, look, or user (e.g., via push notifications to a device of the user, and/or via a subscription feed accessible via the profile of the user).

Still referring to FIG. 3, a cosmetics recommendation module 314 may be configured to generate and/or present recommendations for the user, including for example recommendations of particular cosmetic products, product sellers, styles, looks, and/or routines. The cosmetics recommendation module 314 may generate recommendations using AI techniques (e.g., machine learning) based upon past activity of the user (e.g., past exploration, virtual application, and/or purchase of cosmetic products) and/or other factors. AI structures for recommendations may be refined based upon how the user responds to earlier recommendations (e.g., based upon whether the user engages with or makes a purchase in connection with a particular recommendation, as an indication of the quality or suitability of the particular recommendation for the user). In some embodiments, the cosmetics recommendation module 314 implements adaptive user interface (UI) and/or user experience (UX) techniques to modify the UI/UX for the user based upon past activity of the user.

The virtual cosmetics module 300 includes a virtual guidance module 316, which may be configured to present visual, audial, and/or haptic guidance for cosmetic routines (e.g., applying, adjusting, and/or removing one or more cosmetic products from the user's face and/or surrounding parts of the body). Visual guidance may, for example, include providing text-based step-by-step instructions for a cosmetic routine and/or AR elements depicting each successive step in the cosmetic routine (e.g., showing where on the face to perform a step, or virtually showing the effect on the user's face according to the step being accurately performed). Visual guidance may also include providing visual indicators of whether the user is accurately following product application instructions (e.g., based upon continuous image data received while the user applies the cosmetic product). Audial guidance may, for example, include providing text-to-speech instructions for applying the cosmetic product, and/or providing audial feedback (e.g., speech or sound effects) to indicate whether the user accurately followed or is accurately following application instructions for a product. Haptic guidance may include haptic feedback to help the user complete any particular action (step) associated with applying a product (e.g., providing vibration or other haptic output to indicate whether the user has moved the product or application instrument to a proper location with respect to the face, and/or providing vibration or other haptic output to indicate whether the user accurately completed a step in applying the product).

In embodiments, the virtual guidance module 316 additionally (or alternatively) is configured to provide virtual assistant functionalities capable of receiving and answering inquiries about cosmetic products beyond the performance of any particular cosmetic routine (e.g., questions about a software application implementing the technologies described herein, questions about a user profile, trending cosmetic products, general cosmetic application purchasing/application techniques, etc.).

As depicted in FIG. 3, a user feedback module 318 is configured to receive and/or act upon user feedback regarding the technologies described herein. The user feedback module may, for example, receive feedback indicating the quality of a particular cosmetic product, look, style, seller, or recommendation generated via the technologies herein. In embodiments, the user feedback module 318 is configured to receive feedback regarding a 3D face mesh of the user, and to cause the virtual cosmetics module 300 to adapt the 3D face mesh of the user based upon the received feedback (e.g., via interaction with the facial processing module 304).

Still yet referring to FIG. 3, the virtual cosmetics module 300 includes a smart packaging module 320 configured to detect and/or interact with smart product packaging of cosmetic products. The smart packaging module 320 may, for example, detect a cosmetic product in proximity to the user and/or the user's device via detection of Bluetooth, RFID, and/or another electronic component(s) affixed to the cosmetic product or packaging thereof. Based upon identification of the cosmetic product, the smart packaging module 320 may interact with other sub-modules described herein, for example to identify product details, ingredients, texture, warnings, expiration dates, application instructions, and/or other relevant information to facilitate use of the identified cosmetic product, or to launch virtual try-ons or virtual guidance that help the user in using the identified cosmetic product.

Subsequent portions of this description will describe functionalities similar to those described with respect to the sub-modules from FIG. 3. Unless explicitly stated otherwise, it should be appreciated that such functionalities may operate in a similar manner to that described with respect to the virtual cosmetics module 300 of FIG. 3. For example, the functionalities may operate based upon execution of computer-executable instructions at one or more non-transitory computer memories via one or more computer processors, e.g., at a device operated by a user (e.g., a personal electronic device, a computing terminal at a cosmetic retailer, etc.), one or more servers in communication with the user device, and/or some combination thereof.

### Example Computing Environment

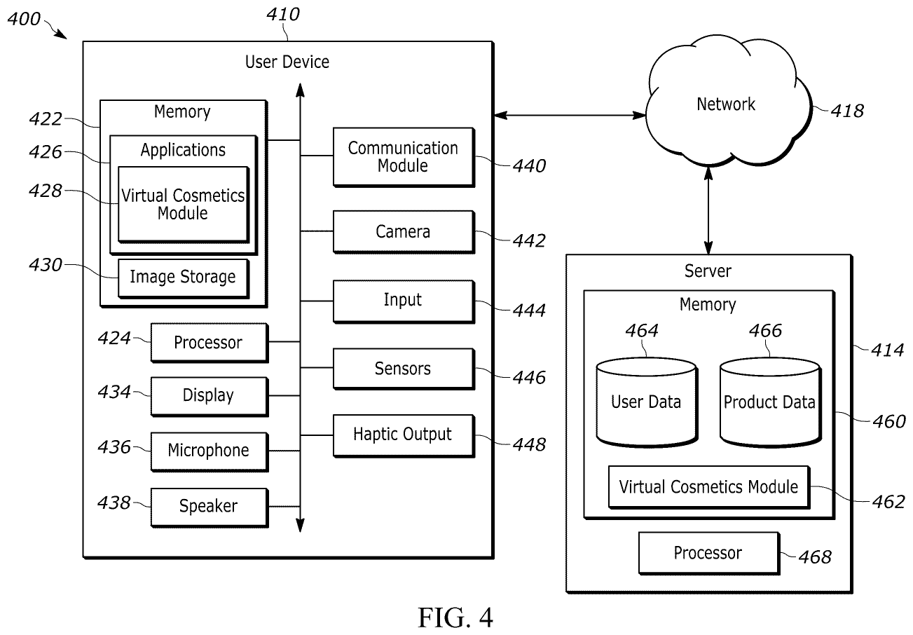

FIG. 4 illustrates components of an example computing environment 400 that may be configured to operate and utilize the technologies of this disclosure, in various embodiments. At a high level, the computing environment 400 includes a user device 410 communicating with a server 414 (i.e., one or more servers) over a network 418 (i.e., one or more communication networks). The user device 410 may correspond, for example, to any one or more of the user devices of this disclosure (e.g., user device 102 of FIGS. 1A-1C, and/or any user device described with respect to user interfaces in subsequent portions of this disclosure). The user device 410 may include, for example, a smartphone, a tablet, a laptop computer, a desktop computer, a smart wearable device (e.g., smart watch), a smart mirror, a VR device (e.g., VR headset), a computing device disposed in a retail environment (e.g., at a cosmetic retailer), and/or another suitable computing device(s) descried herein.

The user device 410 includes a memory 422, which may include one or more non-transitory memories (e.g., ROM) and/or one or more volatile memories (e.g., RAM). In particular, non-transitory portions of the memory 422 may store non-transitory, computer executable instructions that are executable by a processor 424 (i.e., one or more processing elements) to cause the user device 410 to perform actions described herein. Non-transitory portions of the memory 422 may include one or more software applications 426. Each respective one of the one or more software applications 426 may include one or more sets of non-transitory computer executable instructions that, when executed by the processor 424, cause the user device 410 to perform operations attributed to the respective software application 426 (which may include operations involving the processor 424, and/or other components of the user device 410). The one or more software applications 426 may include a virtual cosmetics module 428, which may be configured to perform some or all of the virtual cosmetic functionalities of this disclosure (e.g., functionalities described with respect to the virtual cosmetics module 300 of FIG. 3), alone and/or in combination with the server 414.

In addition to or alternatively to the one or more software applications 426, the memory 422 may include an image storage 430. From the image storage 430, a user of the user device 410 may, for example, upload images of the user's face from which a 3D face mesh is to be generated, adapted, verified, and/or loaded. In some embodiments, the image storage may store other images that the user may upload or link to the virtual cosmetic functionalities herein, e.g., images depicting desired looks or styles, and/or cosmetic products purchased by the user.

The user device 410 includes a display 434 (i.e., one or more display devices) such as a touch-enabled visual display (“touchscreen”) and/or another visual display(s). The display 434 may be physically included within the user device 410 and/or operative connected to the user device 410 via other means (e.g., a peripheral display or monitor wired or wirelessly connected to the user device 410). The user device 410 additionally may include a microphone 436 (i.e., one or more microphones) and/or a speaker 438 (i.e., one or more speakers) that, like the display 434, may be physically included within the user device 410 and/or operative connected to the user device 410 via other means. In various embodiments described herein, the microphone 436 and/or speaker 438 facilitate voice-based interactions with the technologies described herein (e.g., receiving voice commands and/or other feedback via the microphone 436, and providing audial guidance and/or other output via the speaker 438).

The user device 410 may further include a communication module 440 (i.e., one or more communication modules) configured to facilitate various types of communications (e.g., communications over the network 418, RFID, Bluetooth, near-field communications (NFC), etc.). In particular, the communication module 440 may be configured (e.g., via instructions in the memory 422) to communicate with smart packaging of cosmetic products to facilitate identification of cosmetic products. In embodiments in which the computing environment 400 includes multiple user devices 410, a respective communication module 440 of each user device 410 may facilitate communications among the user devices 410.

The user device 410 may further include a camera 442 (i.e., one or more camera devices) which may be physically included within the user device 410 (e.g., as depicted in FIG. 1A) and/or peripherally connected to the user device 410 (e.g., in the form of a webcam or a smart mirror).

Still additionally, the user device 410 may include another input 444 (i.e., still another one or more input devices in addition to or alternatively to the inputs previously described with respect to the user device 410). The input 444 may for example include a mouse, keyboard, touchpad, stylus, and/or other input. Furthermore, the user device 410 may include another one or more sensors 446, which may for example include an accelerometer, gyroscope, location sensor, temperature sensor, pressure sensor, and/or another sensing device(s).

The user device 410 may include one or more haptic output devices 448, which may provide vibration and/or other haptic feedback in accordance with techniques of this disclosure. Generally speaking, providing haptic feedback may include modulating the haptic feedback to convey particular information to the user of the user device 410. For example, the one or more haptic output devices 448 may convey information through vibration and/or other haptic output by output by varying the timing, frequency, location, direction, intensity, pattern, and/or duration of vibration and/or other haptic output, where the variation(s) indicate different respective information to the user. The different respective information may, for example, include an indication of a particular a cosmetic routine or portion thereof, a particular cosmetic tool and/or product (e.g., that the user has acquired or picked up), a particular portion of the user's body (e.g., near to which the user has moved a particular cosmetic tool or user device), an instruction to the user (e.g., to perform a particular action, or to refer to a user device to access further information), whether the user has accurately performed a cosmetic routine or particular portion thereof (e.g., indicating success or an error), and/or various other information described in this disclosure. Output provided via the one or more haptic output devices 448 may be synchronized with visual output, audial output, and/or other output provided to the user, in various embodiments (e.g., providing haptic output simultaneously with and/or in a same pattern as information displayed via one or more graphical interfaces at a smartphone, laptop/desktop computer, smart mirror, augmented reality headset or other wearable device, etc.). The one or more haptic output devices 448 may operate in accordance with one or more haptic feedback profiles, which may for example be defined by the user and stored by the memory 422 and/or server 414 and which may correspond to different respective cosmetic routines.

In some embodiments, the one or more haptic output devices 448 may particularly be provided in the form of a haptic feedback glove, other wearable device, and/or handheld cosmetic application tool containing a plurality of haptic actuators. Each of the plurality of haptic actuators therein may, for example, correspond to different respective information, e.g. to indicate different respective cosmetic routines, steps, instructions, and/or facial features of the user when activated. Additionally or alternatively, a particular one or the plurality of haptic actuators may be activated to provide haptic output when the particular haptic actuator is near a relevant facial feature of the user, so as to improve the user's spatial awareness via non-visual means. For example, a haptic feedback glove may include haptic actuators on respective fingers, and haptic output may be provided at a particular finger with increasing or decreasing frequency and/or intensity when the user's finger is near a facial feature when an action is to be performed, so as to guide the user's finger toward the appropriate facial feature.

Collectively, components of the user device 410 may operate to execute one or more user interfaces to receive user input and/or present output to the user, e.g., via operations of the memory 422, processor 424, display 434, microphone 436, speaker 438, camera 442, input 444, one or more sensors 446, and/or on or more haptic output devices 448. The one or more user interfaces executed via the user device 410 may include one or more graphical user interfaces (GUIs), one or more audial interfaces, and/or one or more haptic interfaces, which may be combined in various embodiments. Execution of the one or more user interfaces via the user device 410 may include communications with the server 414 over the network 418.

Although just one user device 410 is depicted in FIG. 4, it should be appreciated that in various embodiments, multiple user devices 410 are envisioned, each comprising some or all of the components described with respect to FIG. 4, and each configured to perform some or all of the actions attributed thereto. The multiple user devices 410 may communicate over the network 418, and may be configured to communicate with each other through local communications (e.g., Bluetooth) and/or through being mutually configured to a profile of the user (e.g., via logging into the user profile from each device).

For example, a first user device 410 may be a smartphone or tablet computing device configured to execute GUIs to implement technologies described herein, while a second user device 410 may be a wearable computing device configured to provide haptic and/or audial feedback to the user. As another example, a first user device 410 may be a smartphone or tablet configured to execute GUIs associated with guiding the user through a cosmetic routine, while a second user device 410 is a smart mirror simultaneously operating to capture images of the user to determine whether the user has followed the cosmetic routine accurately (e.g., by providing the images to the first user device 410 and/or server 414 for analysis). Still simultaneously, in this example, a third user device 410 may be a smart wearable device (e.g., smart watch) configured to receive and output haptic and/or audial feedback guiding the user through one or more steps of the cosmetic routine, indicating a cosmetic tool and/or product that the user has acquired, picked up, or brought near a particular portion of the user's face, and/or indicating whether the user has followed the cosmetic routine or a portion thereof accurately.

Thus, combinations of multiple user devices 410 augment the technologies described herein by enabling data input and/or output from a number of sources, especially in instances where particular forms of input and/or output require particular ones of the user devices 410 to be positioned or operated in particular manners that may limit any one user device 410 from implementing all of the actions described herein (e.g., because providing haptic feedback may require a device to be on the user's body, whereas obtaining real-time image data may require a device to be distanced from the user's body).

The server 414 (i.e., one or more servers) includes a memory 460, which may include one or more non-transitory memories (e.g., ROM) and/or one or more volatile memories (e.g., RAM). Non-transitory portions of the memory 460 may store non-transitory, computer executable instructions that are executable by a processor 468 (i.e., one or more processors) to cause the server 414 to perform actions described herein. The non-transitory portions of the memory 460 may include a virtual cosmetics module 462 that may, for example, be configured to perform some or all of the functionalities of the virtual cosmetics module 300 of FIG. 3, alone and/or in combination with the virtual cosmetics module 428 of the user device 410. That is, operations of certain ones of the virtual cosmetics technologies described herein may involve operations and communications among the virtual cosmetics modules 428 and 462.

The memory 460 of the server 414 may further include user data 464 and/or product data 466. User data 464 may include any data described herein that is associated with unique users, e.g., user identifying information, profile information, preferences, purchase histories, 3D face meshes, recommendations, generated looks, saved/subscribed looks, styles, or products, etc. Product data 466 may reflect a catalog of cosmetic products to which the technologies herein pertain, including for example products of a number of sellers, manufacturers, or distributers.

By interacting with the server 414 (including the information stored at the memory 460), a user device 410 may use the technologies described herein without needing to locally store various information at the user device 410, thus enabling use of the technologies described herein across multiple user devices 410 and/or across multiple use sessions. Furthermore, in embodiments, the user device 410 communicatively connected to the server 414 can rely on the virtual cosmetics module 462 to perform certain intensive processing at the server 414 (e.g., generating 3D face meshes or augmented reality elements, performing other machine learning-based tasks, etc.), with the server 414 communicating outputs to the user device 410 over the network 418. Accordingly, the memory 460 of the server 414 may include one or more application programming interfaces (APIs) configured to control communications between the server 414 and the user device 410.

The network 418 may include any suitable one or more communications networks, e.g., the Internet, a wired or wireless local area network (LAN), etc. Communications over the network 418 may include communications according to any suitable one or more communications protocols, including for example a mobile cellular communications protocol (e.g., CDMA, GSM, EV-DO, LTE, IP, etc.), one or more IEEE 802.11 protocols (e.g., Wi-Fi), Bluetooth, and/or other suitable protocols in accordance with the computing capabilities of the user device(s) 410 and/or server 414.

In embodiments, the memory 422 and/or memory 460 include one or more non-transitory computer readable media (e.g., removable memory devices) storing instructions thereon that, when executed via one or more computing devices containing other components described in this section, cause corresponding devices to perform actions attributed thereto in this disclosure.

In embodiments, the computing environment 400 may include still other computing technology. For example, in accordance with embodiments described herein, the computing environment 400 may include smart packaging affixed to products, via which the user device 410 and/or server 414 may identify a cosmetic product and relevant information associated therewith.

### Graphical User Interfaces (GUIs) and Other Input/Output Techniques

Subsequent portions of this disclosure will describe various graphical user interfaces (GUIs) and/or other interactive user interfaces executed via one or more devices associated with a user (e.g., via the user device 102 and/or 410). A user of the GUIs described herein may view and navigate aspects of the described GUIs via various forms of input/output, including for example touchscreen interactions (e.g., taps, swipes, etc.), mouse input, keyboard input, dropdown menus, etc.).

Where different GUIs are depicted (i.e., GUIs being referred to by different reference numbers), it should be understood that the different GUIs may be functionally linked to each other in various manners (e.g., enabling the user to navigate from any first GUI to any second GUI via touchscreen interactions, voice commands, and/or other input), and moreover, aspects of the GUIs may be combined. Although different reference numbers will be used with respect to a user device in each of the subsequent sections, it should be understood that in some embodiments, a same user device may execute interfaces of two or more of the subsequent sections of this disclosure. Moreover, where GUIs are described, the sizes, shapes, and/or layouts of GUIs and the elements therein may be adapted to suit the dimensions and resolutions of user device displays via which the GUIs are executed (e.g., to fit standard “portrait” and “landscape” orientations of mobile electronic devices such as smartphones, tablets, etc.).

Furthermore, where graphical input/output is described, it should be appreciated that other forms of input/output, such as audial input/output (e.g., voice commands, text-to-speech, signal tones, etc.), and/or haptic input/output (e.g., vibration output, input based upon gyroscopic and/or accelerometer input, etc.), may be equally envisioned. To generate and provide audial input/output, in some embodiments, natural language processing, computer vision, and/or other AI techniques may be applied to intelligently interpret contents of a GUI and/or convert the contents to audial description (e.g., to describe a face, image, product, or other element of GUI in terms other than the literal semantic text of the GUI). AI outputs and/or other semantic outputs may be presented to the user, for example, as audial output in the form of text-to-speech audio, as haptic output via vibrations and/or other haptic feedback indicating the semantic output, and/or via other techniques. Unless stated otherwise, suitable audial and/or haptic input/output techniques described with respect to any one user interface herein may be similarly applied to other user interfaces described herein.

In any case, execution of the interfaces described herein may occur upon execution of non-transitory instructions stored at one or more computer memories (e.g., memory 422 of the user device 410 and/or memory 460 of the server 414) via one or more computer processors (e.g., the processor 424 of the user device 410 and/or the processor 468 of the server 414). Aspects of the described interfaces may be substituted or combined with each other and/or with other technologies or techniques of this disclosure, in various embodiments. The non-transitory instructions may, for example, be instructions contained within respective ones of modules from FIG. 2 and/or FIG. 3 to which corresponding or similar actions were ascribed in the foregoing sections of this disclosure.

### Exploring and Sharing Cosmetic Products

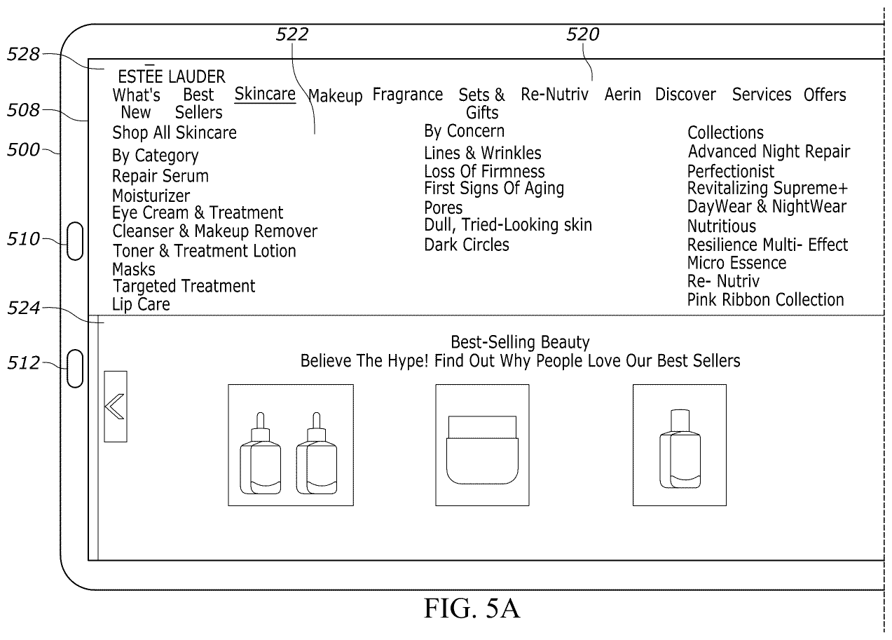

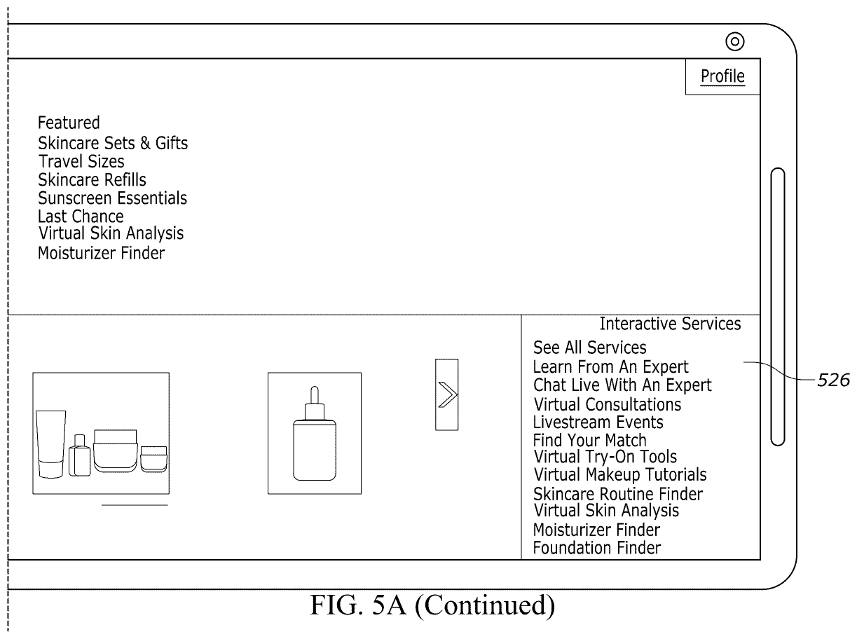

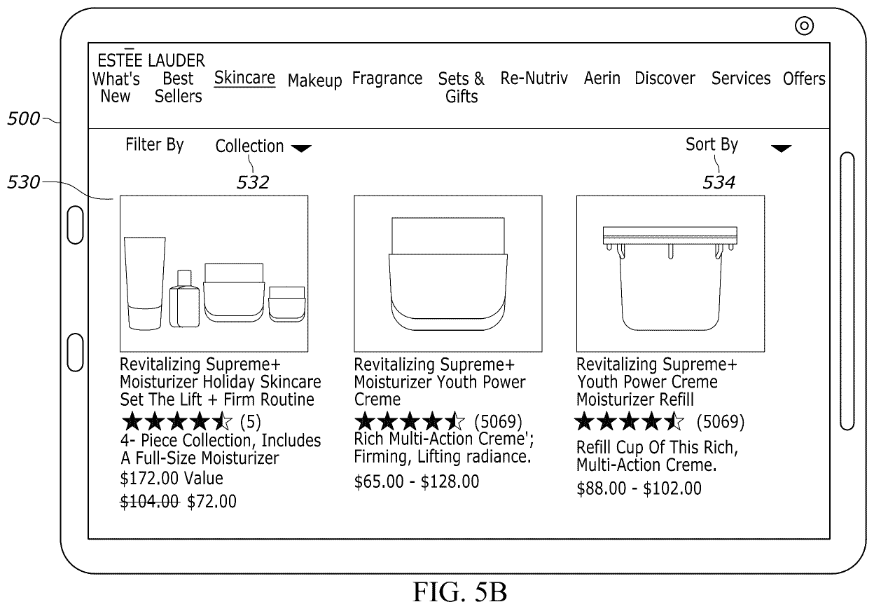

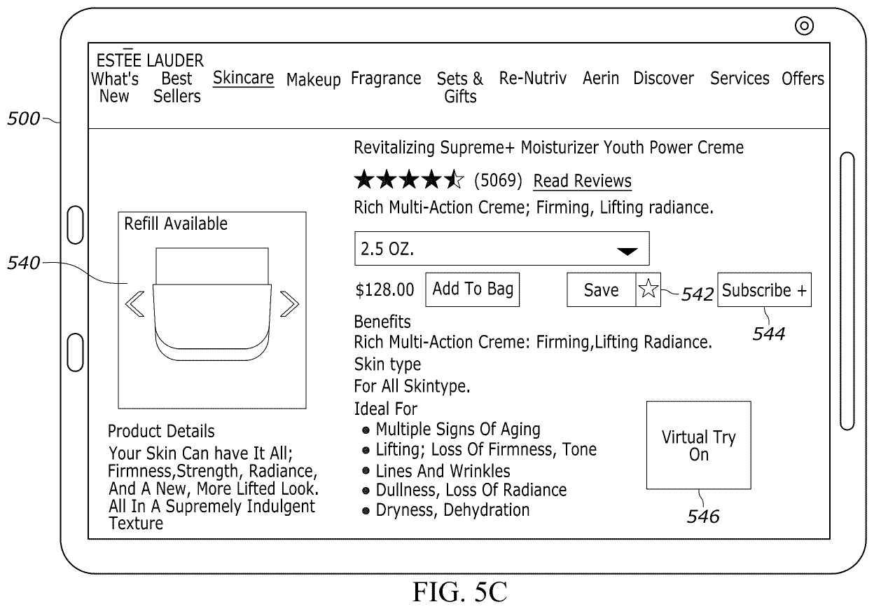

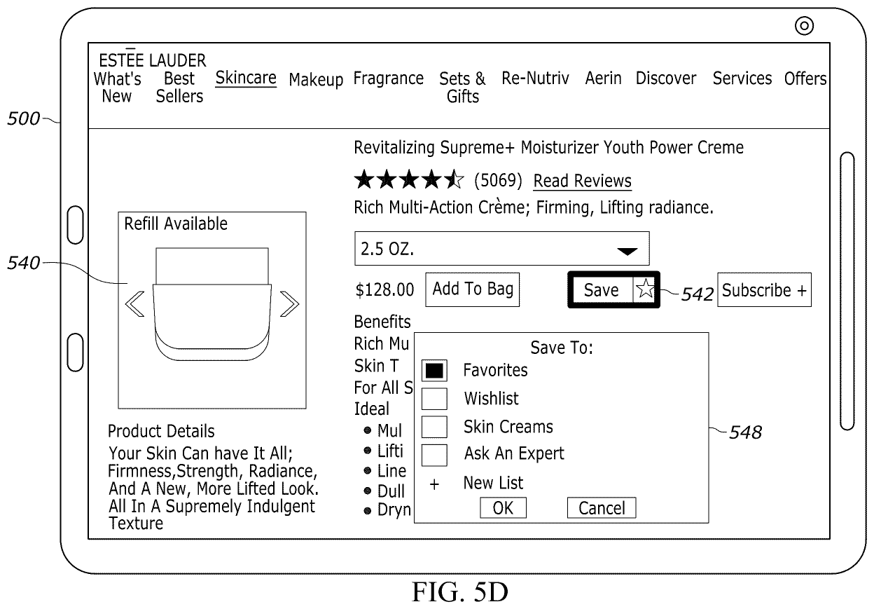

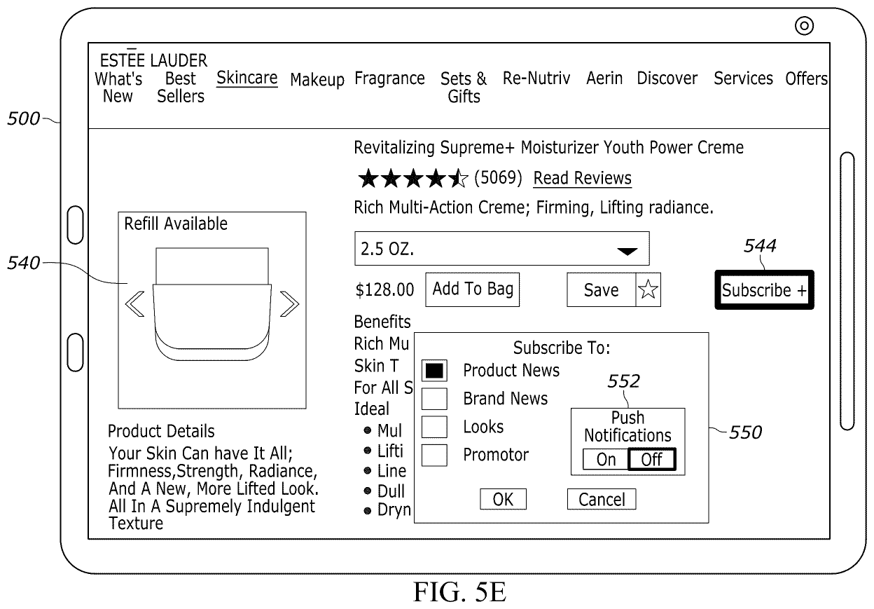

In various embodiments, GUIs and/or other interactive user interfaces enable a user to navigate (or “explore”) various cosmetic products, including virtual functionalities and/or other services associated therewith. Examples will be provided with respect to FIGS. 5A-5F, though it should be appreciated that techniques depicted therein may be combined or substituted with other aspects of this disclosure.

As depicted in FIG. 5A, a user device 500 includes a display 508 (e.g., touchscreen), via which a GUI 520 executes to allow the user to explore various cosmetic products. The user device 500 may, for example, be a smartphone, tablet, laptop or desktop computer, and/or another suitable user device (e.g., as described with respect to user device 102 of FIGS. 1A-1C and user device 410 of FIG. 4). Cosmetic products depicted in the GUI 520 may, for example, include products offered online via cosmetic manufacturer Estée Lauder®. More particularly, as depicted in a first panel 522 in FIG. 5A, the cosmetic products may include skincare products, fragrance products, makeups such as eyeliners, lip products, foundations, etc.

The GUI 520 of FIG. 5A further includes a second panel 524 displaying best-selling products among various cosmetic products offered by a cosmetics distributor. Still additionally, the GUI 520 includes a third panel 526 providing an overview of interactive services available to the user. Interactive services may include, for example, (1) virtual try-on tools to view a representation of a cosmetic product virtually applied to the user, (2) virtual tutorials to educate a user regarding application of cosmetic products and/or other cosmetic concepts, (3) a virtual skin analysis tool to recommend skincare products and/or routines based upon image data of the user's face, and/or (4) various tools allowing the user to confer with an expert advisor regarding cosmetic products, routines, etc. Various aspects of these interactive services are described in foregoing sections of this disclosure and in subsequent sections with respect to still additional example GUIs.

The GUI 520 still further includes a navigation bar 528 that, in embodiments, may persist across some or all GUIs of this disclosure. The user may sue the navigation bar 528, for example, to summon or dismiss the first panel 522 as a dropdown menu based on a selection of the “skincare” option in the navigation bar 528, and/or to summon/dismiss other panels based on similar interactions with other elements in the navigation bar 528.

As depicted in FIG. 5A, the user device 500 further includes a speaker 510 and a microphone 512. In embodiments, some or all of the output of the GUI 520 of FIG. 5A may be replaced or replicated as audial output via the speaker 510 (e.g., by using text-to-speech functionality to convert text of the GUI 520 into audio, and/or by using computer vision and/or natural language processing to convert images and/or other content of the GUI 520 into semantic text for output via audio). Additionally, or alternatively, in embodiments, some or all input into the GUI 520 may be replaced or replicated as audial input to the microphone 512 (e.g., by receiving voice commands and/or via using natural language processing and/or other techniques to interpret the user's voice commands). Moreover, although not depicted in FIG. 5A, the user device 500 may include one or more haptic feedback devices (e.g., vibration outputs) to provide outputs of the GUI 520 in haptic form and/or to receive user input in haptic form. Where not explicitly stated otherwise, similar techniques may be applied to other interfaces of this disclosure.

Moving to FIG. 5B, a GUI 530 displays a subset of cosmetic products, e.g., a portion subset of skincare products selected via interactions in the GUI 520 of FIG. 5A. Each displayed cosmetic product offering may include various associated information, including for example product name, images, brand, available variations (e.g., styles, colors/shades or sizes), ingredients, price(s) including sales or discounts, and/or product ratings.

The GUI 530 includes a filtering element 532 that, when selected, enables the user to filter the display of offered cosmetic products according to various criteria. The user may, for example, filter to include or exclude products of a particular name, brand, collection, style, ingredient, color/shade, size, price, average user rating, in-stock vs. out-of-stock, etc. The GUI 530 still further includes a sorting element that, when selected, enables the user to sort displayed cosmetic offerings, for example according to name, price (e.g., high-to-low, or vice versa), average user rating, sales volume, and/or degree of suitability to the user (e.g., as determined via cosmetic product recommendation techniques of this disclosure). Use of the sorting element 534 may be combined with the filtering element 532, to thereby sort a display of products that has been narrowed via filtering (or vice versa, to filter a sorted list of items).

Moving now to FIG. 5C, a product GUI 540 displays information for a selected cosmetic product (e.g., a product selected from the GUI 530 of FIG. 5B, for example via touchscreen input or one or more voice commands). Displayed information for the product in the GUI 540 may, for example, include the product name, description, ingredients, instructions for use, available variations (e.g., colors/shades, styles, sizes, etc.), similar or associated products, user ratings, recommendations for classes of users or for the particular user viewing the GUI 540 (e.g., using the recommendation techniques of this disclosure).

The GUI 540 includes a “save” element 542, a “subscribe” element 544, and a “virtual try-on” element 546. Selecting the save element 542 enables the user to place the depicted cosmetic product in one or more lists associated with the user, for easy future access. Selecting the subscribe element 544 enables the user to subscribe to information associated with the product. Selecting the “virtual try-on” element enables the user to apply the cosmetic to a virtual representation of the user's face, via the 3D face mesh and other technologies of this disclosure.

As depicted in FIG. 5D, selecting the save element 542 from FIG. 5C summons an overlay 548 into the GUI 540. Respective controls in the overlay 548 enable the user to save the cosmetic product to one or more lists, e.g., one or more default lists and/or one or more user-created lists. In embodiments, the user may subsequently access and/or modify lists of saved products via the user's personal profile.

As depicted in FIG. 5E, selecting the subscribe element 544 from FIG. 5C summons another overlay 550 into the GUI 540. Respective controls in the overlay 550 enable the user to subscribe for example to news about the cosmetic product, news about the brand to which the cosmetic product belongs, looks containing the cosmetic product, and/or other users (“promoters”) associated with the cosmetic product. In embodiments, the user may easily access their subscriptions (e.g., news associated with subscribed entities) via the user's personal profile and/or via other easily accessible means. Still referring to FIG. 5E, the overlay 550 contains an element 552 to enable the user to configure whether subscription news is provided to the user device 500 (and/or to other devices of the user) via push notifications.

FIG. 5F depicts a user profile GUI 560 displayed via the user device 500. Generally speaking, the user profile GUI 560 enables the user to access and configure various information and functionalities particular to the user.

For example, selecting a “profile info” element 562 may enable the user to view and/or modify basic information associated with the user (e.g., name, username/password, email address, shipping address, billing information, profile security information, date of birth, demographic information, emergency contact information in the instance of adverse reactions to cosmetic products, etc.). Selecting a “preferences” element 564 may enable the user to view and/or modify information identifying preferences of the user regarding use of the technologies described herein (e.g., permissions of technologies described herein to access particular devices owned by the user, device cameras, device sensors, other device hardware, device software, etc., and/or accessibility settings preferences regarding use of visual, audial, and/or haptic forms of input and/or output, preferences to adjust for limited eyesight or colorblindness, etc.). The user may view and/or their order history via selecting an “orders” element 566.

Still referring to the user profile GUI 560 of FIG. 5F, selecting a “saved items” element 568 enables the user to view and/or modify lists of saved cosmetic products, as discussed for example with respect to FIG. 5D. Similarly, the user may select a “subscriptions” element 570 to access and/or modify subscription lists, including news regarding subscribed entities, as discussed for example with respect to FIG. 5E.

By selecting a “tutorials” element 572, the user may access various virtual guidance, including guidance for performing cosmetic routines with respect to a particular cosmetic product or look, and/or more general guidance e.g., regarding storage, disposal, sanitary practices, or first aid. Further examples of virtual guidance will be provided in subsequent portions of this disclosure. Via selecting a “beauty advisor” element 574, the user may access a cosmetics expert to guide the user through product recommendations, cosmetic routine recommendations, questions, etc. (e.g., by text chat and/or video conference). Still additionally, the GUI 560 includes a “recommendations” element 576, which the user may select to access various cosmetic recommendations (e.g., recommendations of looks, styles, cosmetic products, tutorials, routines, etc.). Further examples of GUIs and techniques for generating and displaying recommendations will be provided in subsequent portions of this disclosure.

### Virtual Application (“Try-Ons”) of Cosmetic Products

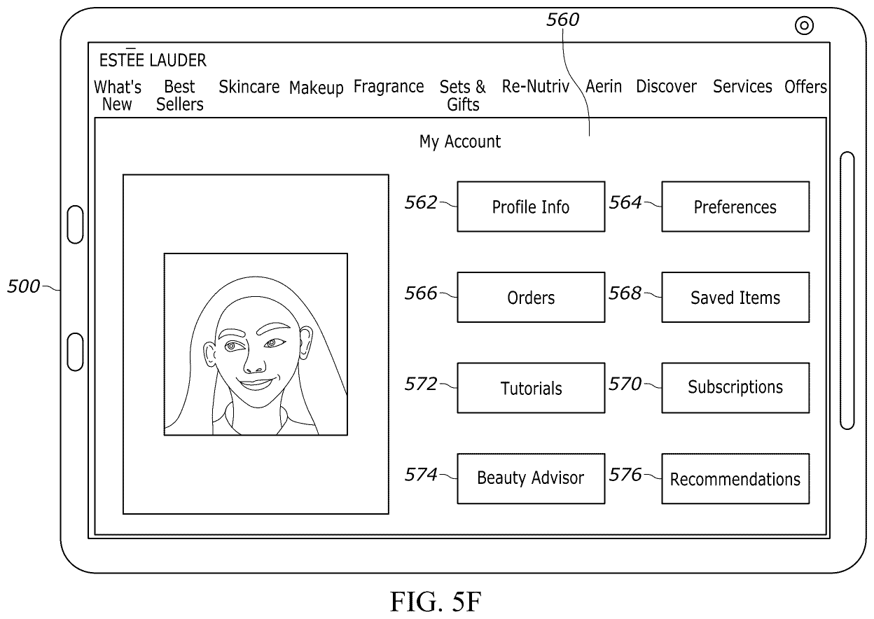

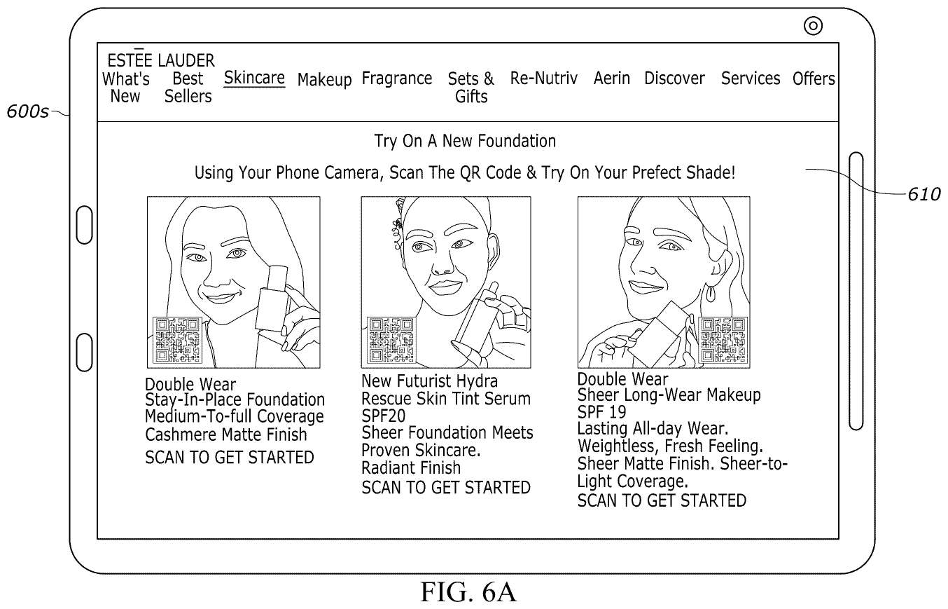

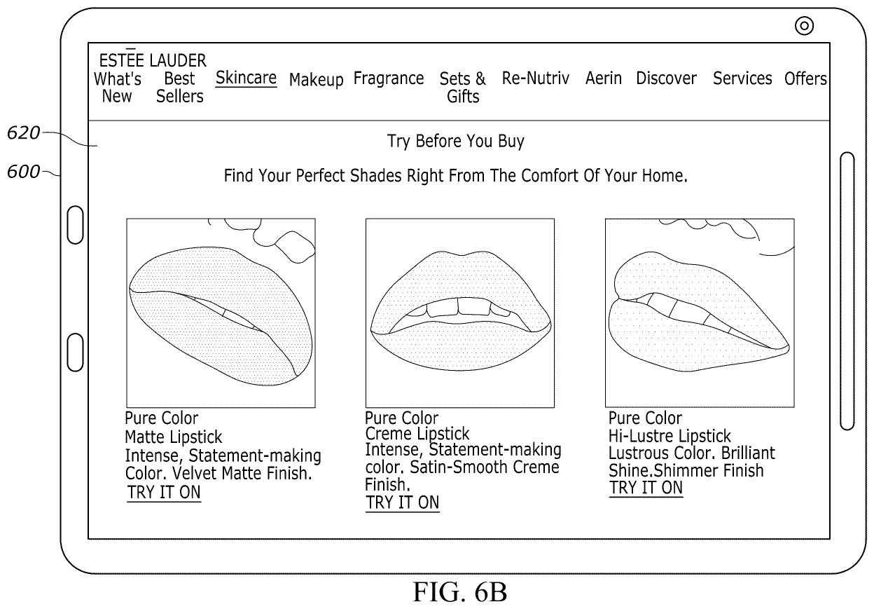

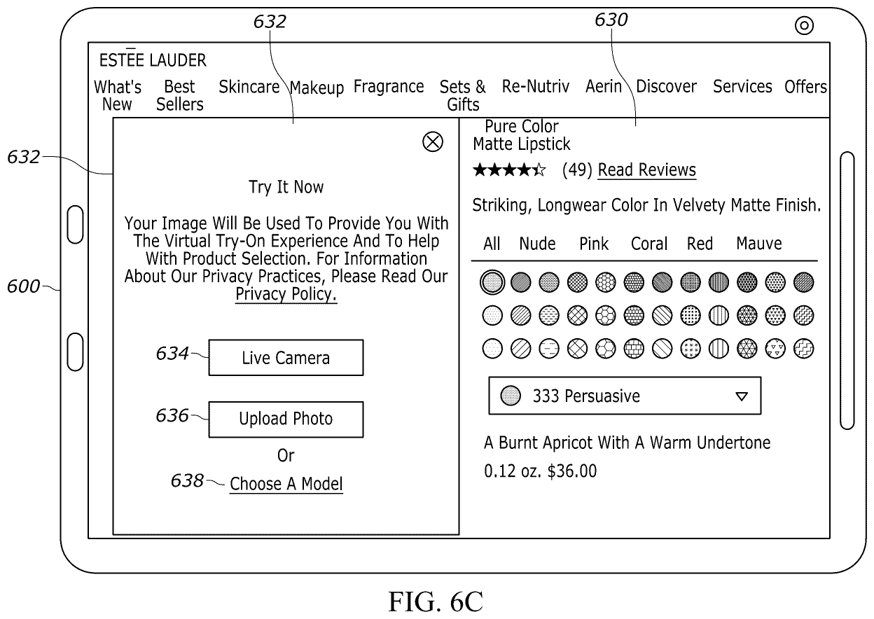

In various embodiments, GUIs and/or other interactive user interfaces enable a user to virtual apply or “try on” cosmetic products, such as lipsticks, foundations, skin creams, blushes, etc. At a high level, as previously described, virtually applying a cosmetic product may include modifying a three-dimensional (3D) face mesh of the user to virtually represent the cosmetic product on the user's face (and/or surrounding parts of the body). Examples of these techniques be provided with respect to FIGS. 6A-6D, though it should be appreciated that techniques depicted therein may be combined or substituted with other aspects of this disclosure.

Beginning with FIG. 6A, a GUI 610 executing at a display of a user device 600 displays indications of respective cosmetic products available for virtual try-ons. The user device 600 may, for example, be a smartphone, tablet, laptop or desktop computer, and/or another suitable user device e.g., as described with respect to user device 102 of FIGS. 1A-1C and user device 410 of FIG. 4.

In embodiments, accessing the GUI 610 via a first user device, the user may scan a QR code (or another suitable code, e.g., bar code) appearing on the GUI 610 with a second user device to cause the second user device to open a virtual try-on tool (e.g., embodied by one or more GUIs at the second user device). For example, the user may access the GUI 610 on a desktop or laptop computer, and scan the QR code via a camera application of a smartphone. The QR code is associated with a uniform resource identifier (URI, e.g., a URL), and accordingly, scanning of the QR code may direct the second user device to the associated URI. In embodiments, each QR code in the GUI 610 (and the corresponding URI) is uniquely associated with try-on of a respective product. Thus, scanning the QR code directs the second device to a URI associated with virtual try-on of the corresponding cosmetic product. Alternatively, in embodiments, the QR code may be common to two or more cosmetic products, where scanning the QR code leads to the virtual try-on tool where the user may virtually apply one, two, three or more cosmetic products.

In some embodiments, accessing the virtual try-on tools described herein do not require using a second user device to scan a QR code displayed via a first user device in the manner depicted in FIG. 6A. For example, FIG. 6B depicts a GUI 620 representing an alternate embodiment, with each respective cosmetic product having an associated “try it on” link, activation of which directs the user device 600 to a URI that facilitates virtual application of the respective cosmetic product. As with FIG. 6A, in embodiments, each “try it on” link in the GUI 620 (and the corresponding URI) is uniquely associated with try-on of a respective product. Thus, activating the link directs the second device to a URI associated with virtual try-on of the corresponding product. Alternatively, in embodiments, the QR code may be common to two or more products, where activating the link leads to the virtual try-on tool where the user may virtually apply one, two, three or more cosmetic products.

Moving to FIG. 6C, an example virtual try-on GUI 630 executes at the user device 600, e.g., in response to scanning of a QR code or activation of a link from FIG. 6A or FIG. 6B. Specifically, in the example of FIG. 6C, the virtual try-on GUI 630 provides the try-on tool for a lipstick, of which the user may select any of a plurality of colors for virtual try-on.

In the embodiment of FIG. 6C, a 3D face mesh may still need to be obtained for the user. Accordingly, an image panel 632 of the virtual try-on GUI 630 prompts the user to provide image data from which a 3D face mesh is to be generated. By selecting a first option 634, the user may cause a camera application of the user device 600 to cause the virtual try-on GUI 630 to obtain live camera data from the user device 600. A real-time representation of the user device's camera frame may then be displayed in the image panel 632. Alternatively, selecting a second option 636 (“upload photo”) enables the user to select a previously captured photo(s) or video(s) from which the 3D face mesh is to be generated. Selecting the second option 636 may, for example, cause the image panel 632 to display a representation of a local image storage of the user device 600, to enable the user to select one or more images from which the 3D face mesh is to be generated. Alternatively, the second option 636 may enable the user to select the image(s) via other means, e.g., by opening a cloud-based image gallery corresponding to the user, or by defining the one or more images via a URI to the image(s).

The image panel 632 still further includes a third option 638, selection of which enables the user to select a pre-configured digital face model to which the cosmetic product is to be applied. The face of the pre-configured digital model may not be precisely representative of the user, but nonetheless, virtual application of the cosmetic product to the digital model may enable the user to visualize the user's appearance were the user to apply the cosmetic product.

In embodiments, if a 3D face mesh has already been obtained for the user, but the user device 600 does not have access to a camera (or permission to use the camera), the virtual try-on tool may virtually apply the product to the user's face by loading a digital avatar morphed to the user's features as indicated by the previously obtained 3D face mesh.

Moving to FIG. 6D, the image panel 632 of the virtual try-on GUI 630 is updated to display obtained image data of the face of the user (e.g., obtained via interactions as described with respect to FIG. 6C, and/or via other means). More particularly, the image panel 632 in FIG. 6D includes an augmented reality (AR) interface 642 that augments the image data with a virtual representation (or “overlay(s)”) of one or more selected cosmetic products applied to the user (e.g., in this case, a selected shade of a lipstick virtually applied to the user's lips in the manner of a lipstick. The region of the user's face to which a cosmetic product is to be virtually applied in the AR interface 642 is identified by comparing 3D face mesh data of the user (defining the user's facial features, and the points/boundaries thereof) to stored data associated with the cosmetic product to be virtually applied. That is, in the case of the lipstick in FIG. 6D, the AR techniques herein involve comparing stored information associated with the lipstick (e.g., indicating that the lipstick is to be applied to the entirety of the user's visible lips, with same or varying intensity) to 3D face mesh data of the user indicating the location of the lips on the user's face. Similar techniques are utilized in virtual try-ons of other cosmetic products described herein.

In embodiments where the AR interface 642 operates upon real-time image data of the user (e.g., with the image panel 632 displaying a real-time view of a camera feed of the user device 600), the AR interface 642 updates substantially in real time, e.g., to update the virtual display of the lipstick as an angle, expression, zoom, position, etc. of the user's face changes with respect to a device camera. Furthermore, if the user selects a different shade, style, product, etc. to virtually try on, the AR interface 642 may update accordingly to display a virtual representation of the selected product to the face of the user.

In some embodiments, the virtual try-on techniques herein involve social functionalities to allow one or more other users (e.g., friends or family of the user) to contribute to a virtual try-on session of the user by selecting one or more cosmetic products to be virtually applied to the user in the AR interface 642. For example, rather than the user selecting the lipstick to be represented in the AR interface 642, another user(s) may select the cosmetic product(s) for the user to cause the AR interface 642 to virtually apply the selected cosmetic product(s) to the face of the user. In embodiments, the user may control or moderate the use of these social functionalities by providing input to control at least (1) which other users are authorized to select a cosmetic product(s) to be virtually applied in the AR interface 642, and/or (2) how the other authorized users are permitted to select a cosmetic product(s) to be virtually applied (e.g., automatically upon the other user's selection, or as suggestions to be virtually applied to the user only upon an approval by the user).

In embodiments, the user may “save” the output of a virtual try-on, e.g., by causing one or more images representing the virtual try-on to be stored at the user device 600 and/or at one or more servers. Saved images representing the virtual try-on may, for example, include one or more angles of the user's face as displayed in the AR interface 642 with the cosmetic product (e.g., lipstick) virtually applied.

Thus, the use of virtual try-on technologies as described herein, the user may obtain a realistic representation of how a cosmetic product(s) might look on the user, without needing to purchase or otherwise physically access the cosmetic product(s). Moreover, using virtual try-on technologies in combination with other technologies of this disclosure, the user may for example save, share, combine, stylize, and/or learn about the application of any cosmetic product(s) that may be of interest to the user.

Generating “Looks” With Multiple Cosmetic Products and/or Styles

Often, users of cosmetic products wear not just one, but instead two, three, four or more cosmetic products simultaneously, ranging across various product types (e.g., foundations, eyeshadows, lipsticks, serums, etc.). Accordingly, a user, when considering any first cosmetic product to potentially purchase or wear, often considers not just the first cosmetic product alone, but also how the first cosmetic product can or should be combined with other cosmetics the user might already own or consider obtaining. Thus, for a user to construct their desired “look” might require the user tracking the cost, availability, and aesthetic qualities of each of two, three, four or more cosmetic products comprising the look, as well as envisioning or recalling the precise manner (style) of applying each of the cosmetic products.

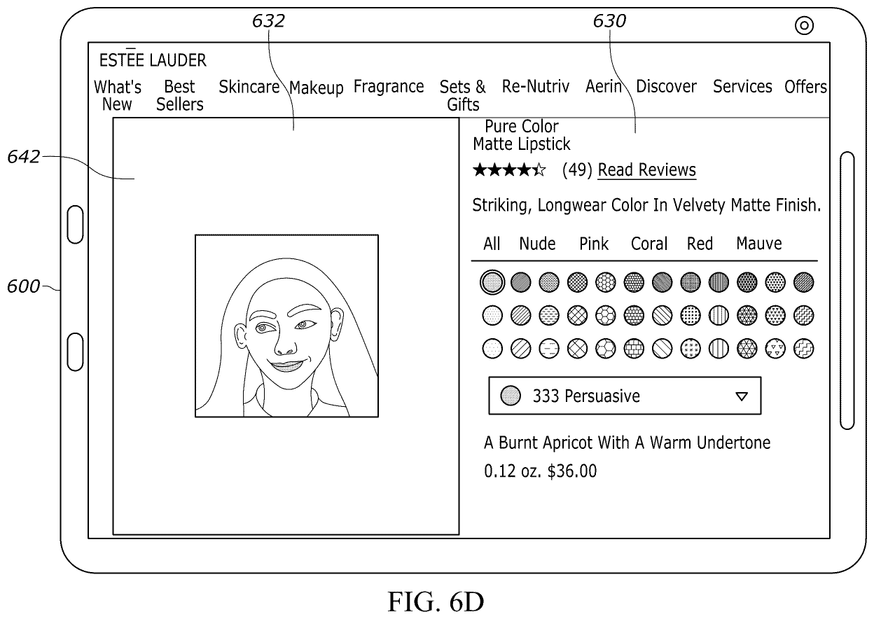

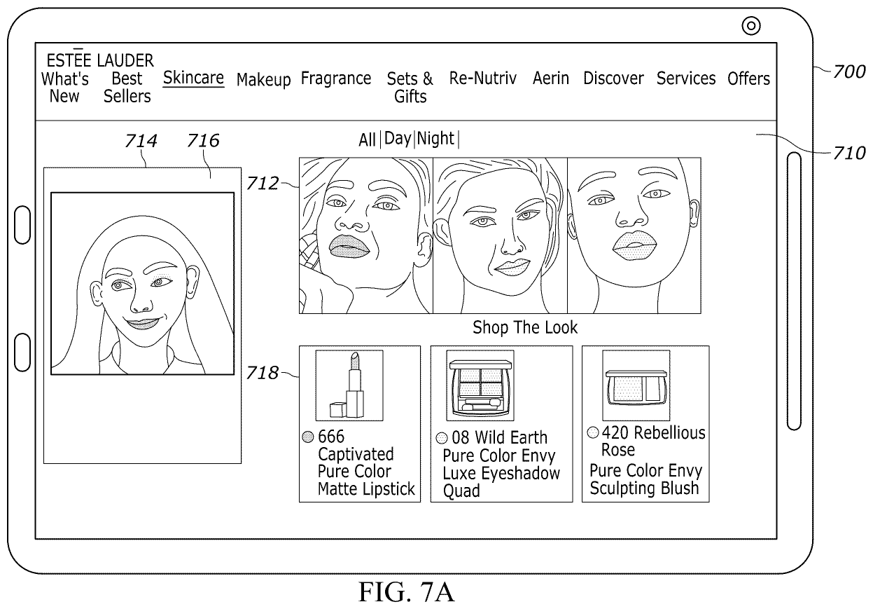

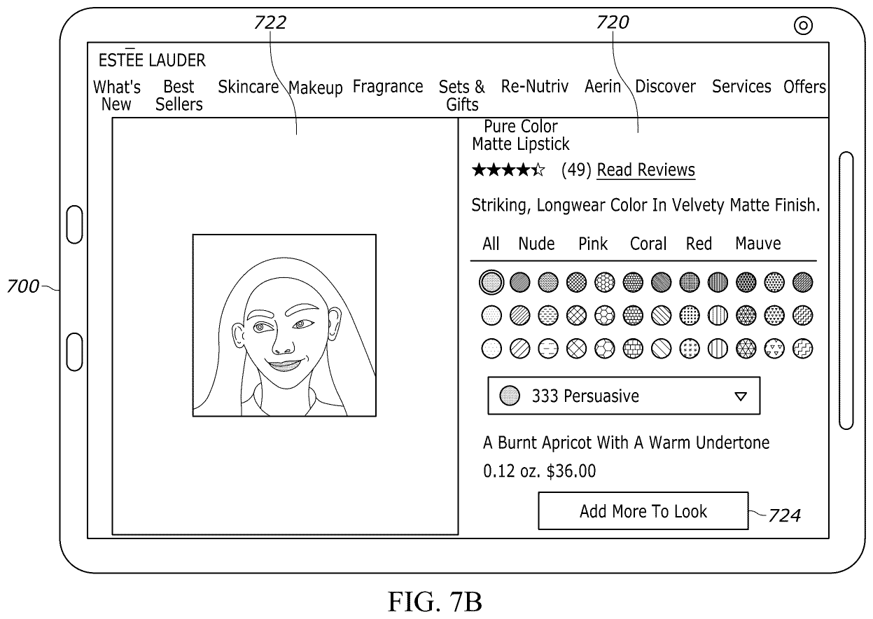

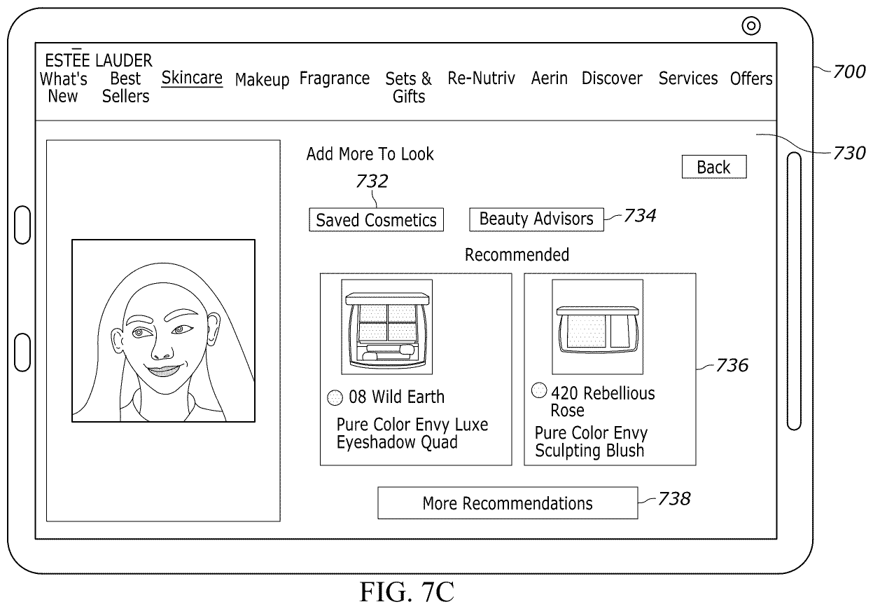

In view of these challenges, technologies are envisioned for creating, virtually applying, saving, and/or sharing looks including a plurality of cosmetic products for a user. Example embodiments of these technologies will be described with respect to FIGS. 7A-7D, which depict various GUIs executing via a display of a user device 700. The user device 700 may, for example, be a smartphone, tablet, laptop or desktop computer, and/or another suitable user device (e.g., as described with respect to user device 102 of FIGS. 1A-1C, user device 410 of FIG. 4, and/or other user devices of this disclosure).

First referring to FIG. 7A, a GUI 710 displays options for the user to select one of a plurality of pre-defined looks (titled in FIG. 7A as “Bold & Jewel-Toned,” “Thrill Me,” and “After Hours”). Pre-defined looks may include looks defined or constructed by the user (e.g., using techniques of this disclosure), and/or looks constructed by another entity offering a cosmetic product, cosmetics website, etc. Looks constructed by the other entity (ies) may be offered to the user based for example on the user's previously explored or purchased products or looks, the user's skill or experience level with cosmetics, and/or various other recommendation factors contemplated in this disclosure. Using interfaces to be described herein, the user may use any of these looks as a starting point for another look, e.g., by removing and/or adding other products to a previously generated look.

In any case, upon the user selecting a GUI element 712 corresponding to a particular look (e.g., the “Bold & Jewel-Toned” look), an image panel 714 displays an augmented reality (AR) interface 716 depicting the plurality of cosmetics in the selected look virtually applied to the face of the user, e.g., in the manner described with respect to FIG. 6D. However, whereas the AR interface 642 of FIG. 6D that includes only a first set of AR elements (e.g., overlay(s)) to represent one cosmetic product virtually applied to the user's face, the AR interface 716 of FIG. 7A may include two or more sets of AR elements to represent respective cosmetic products in the selected look. Similarly to the AR interface 642 from FIG. 6D, though, the AR interface 716 may update automatically responsive to updated image data from the camera of the user device 700 (e.g., as the user's face and the features therein reposition, rotate, change expression, etc. in the frame of the camera).

Still referring to FIG. 7A, the GUI 710 further includes an exploration panel 718 to enable the user to navigate (e.g., shop) among the plurality of cosmetic products included in the look. For example, for the selected look in FIG. 7A, the user may select respective products therein to navigate to product pages for each respective product, e.g., to be presented to the user in the manner described with respect to FIGS. 5A-5E, or more particularly, in a manner to be described with respect to FIG. 7B.

A product GUI 720 depicted in FIG. 7B enables the user to view details of a selected product (e.g., a lipstick), and includes a virtual application of the selected product in an AR interface 722, e.g., using techniques similar to those described with respect to FIGS. 5A-5F and 6A-6D). From the product GUI 720, the user may select an “add more to look” option 724 to use the selected product as one of a plurality of products to be included in a look.

Selecting the option 724 from FIG. 7B may, for example, cause the user device 700 to display a GUI 730, as depicted in FIG. 7C. The GUI 730 enables the user to select additional cosmetics to include in a look in combination with the first cosmetic from FIG. 7B. More particularly, the user may select from among products previously “saved” by the user (option 732), and/or connect with an expert “beauty advisor” (option 734) to discuss and/or obtain recommendations for the look. Still additionally, a recommendations panel 736 presents system-generated recommendations of other cosmetics to combine in a look with the first cosmetic from FIG. 7B. Recommendations included in the recommendations panel 736 may be based, for example, upon cosmetic products previously explored, purchased, saved, or subscribed to by the user, and/or based upon other recommendation factors contemplated in this disclosure.

Based upon selection of one or more additional cosmetics to include in the look, a custom look GUI 740 as depicted in FIG. 7D tracks the cosmetics included in the look constructed by the user. More particularly, the custom look GUI 740 includes indications of the cosmetics currently included in the look (elements 742, 744), and an AR interface 746 representing the cosmetic products simultaneously virtually applied to the face of the user (e.g., as described with respect to other AR interfaces herein). For the cosmetics already included in the look, the user may select the elements 742, 744 for example to adjust a shade, style, or other parameter of the selected cosmetic in the look (e.g., to change the color of an otherwise identical lipstick). Effectively, the AR interface 746 may update automatically (e.g., display additional or fewer AR elements) in accordance with cosmetic products added to or removed from the user-defined look. The custom look GUI 740 includes still additional GUI elements that the user may select to add an additional cosmetic(s) to the look (748, e.g., as described with respect to FIGS. 7A-7C), save the look (750, e.g., to access the look later, for example as described with respect to FIG. 5F and/or FIG. 7A), and/or share the look with another user(s) (752).

The techniques described above may be repeated as the user continues to add two, three, four or more cosmetics to a look. For example, after a user augments the look with an eyeshadow or blush, further interfaces may provide still additional options or recommendations regarding the look to the user, with recommendations being updated in view of the products currently contained in the look. For example, upon the user adding an eyeshadow to the look, system-generated recommendations generated might no longer include other eyeshadows, but instead include a foundation, an eyeliner, a serum, and/or another class of cosmetic products not yet represented in the look.

As with the virtual-try on techniques described with respect to FIGS. 6A-6D, embodiments of look generation techniques herein may involve social functionalities that allow one or more other users (e.g., friends or family of the user) to contribute to generation of a look, e.g., by adding, removing, or adjusting cosmetics to be included therein. In embodiments, a first user may control or moderate the use of these social functionalities by another user(s), for example by defining which other users are authorized to modify the look, and/or defining how the other authorized users are permitted to modify the look (e.g., with or without an approval by the first user).

Collectively, the look generation techniques described herein may enable the user to construct and visualize combinations of cosmetic products as they would appear when applied to the face of the user. Moreover, implementation of the look generation techniques herein in combination with social sharing features allows users having a variety of tastes, backgrounds, skill levels, etc. to not just create looks for themselves, but also share the looks and products therein as a means of mutual inspiration.

### Virtual Guidance for Cosmetic Routines

In various embodiments, various interactive user interfaces, including for example audial interfaces, haptic interfaces, and/or GUIs enable a user to request and receive virtual guidance for performing a cosmetic routine, for example involving the application, removal, or adjustment of one or more cosmetic products or a look. In particular, the present disclosure envisions that audial and/or haptic interfaces for virtual guidance may be of particular value to users having one or more visual impairments (e.g., at least partial blindness, colorblindness, cataracts, glaucoma, severe farsightedness, etc.).

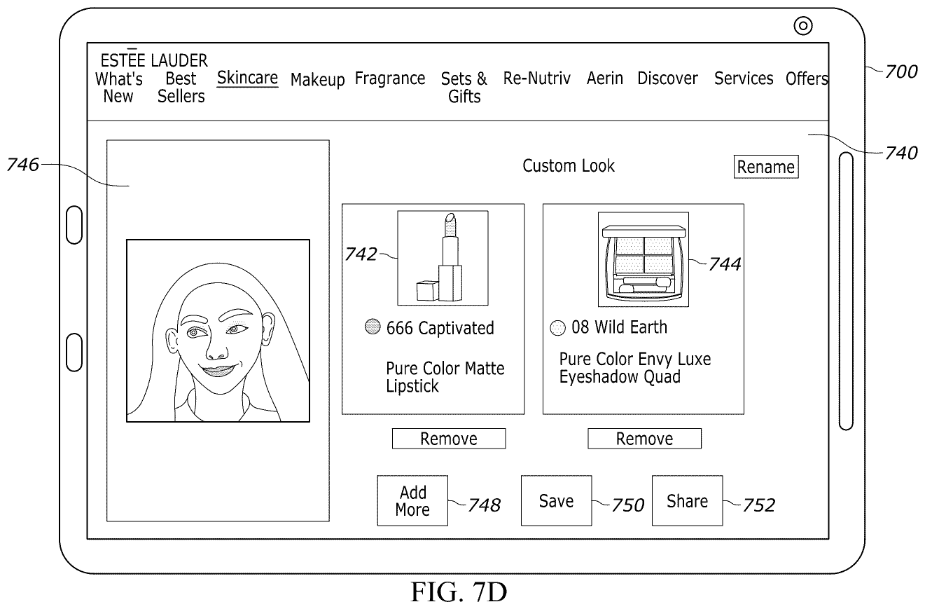

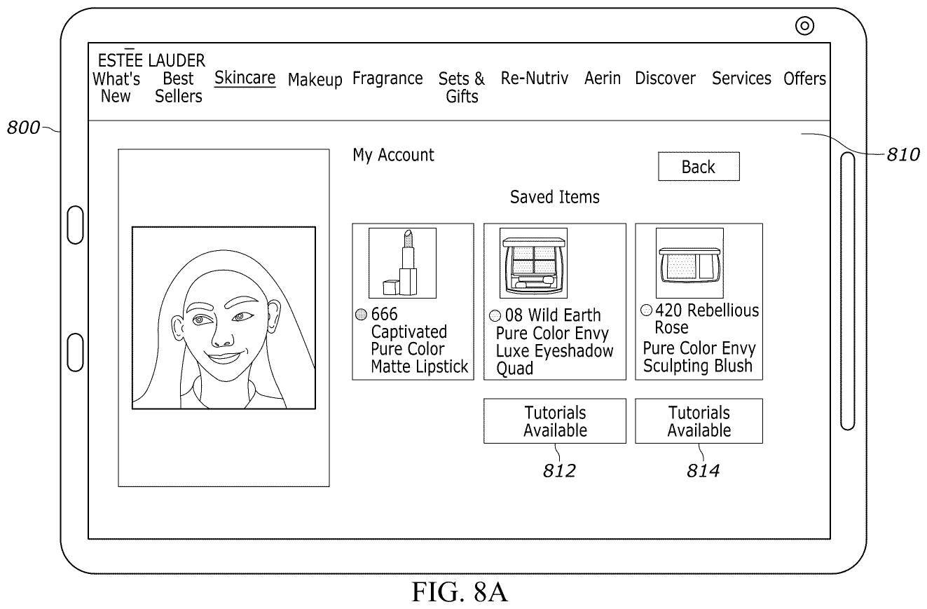

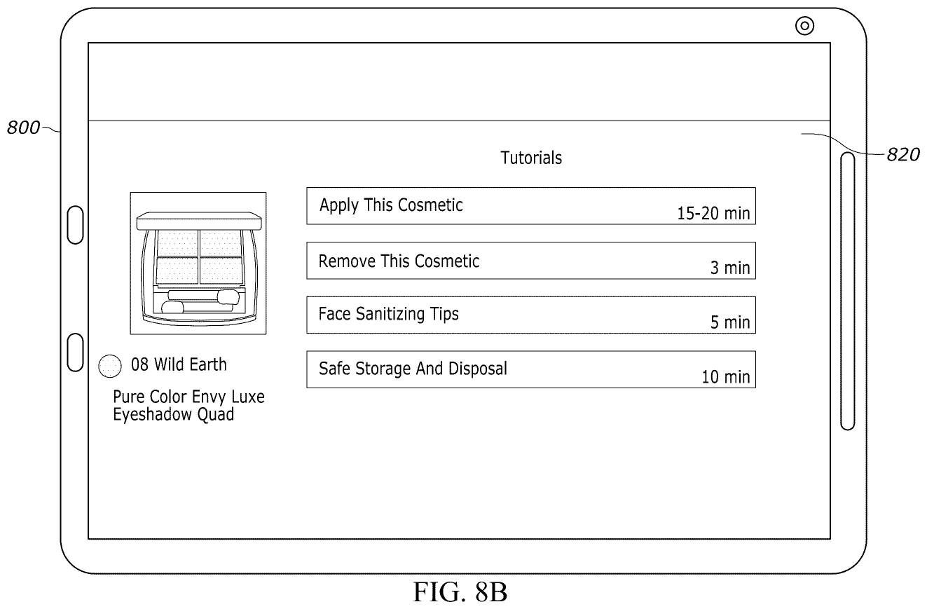

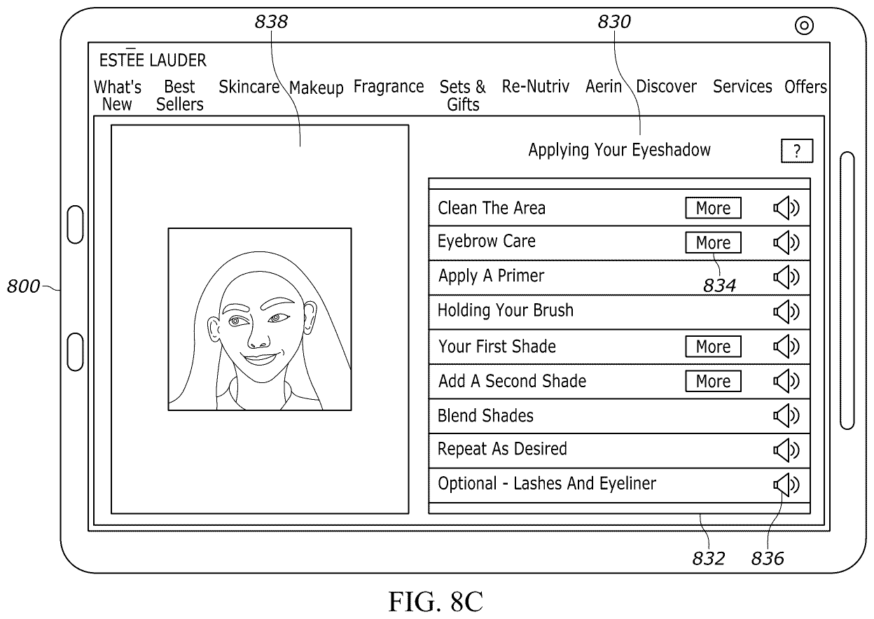

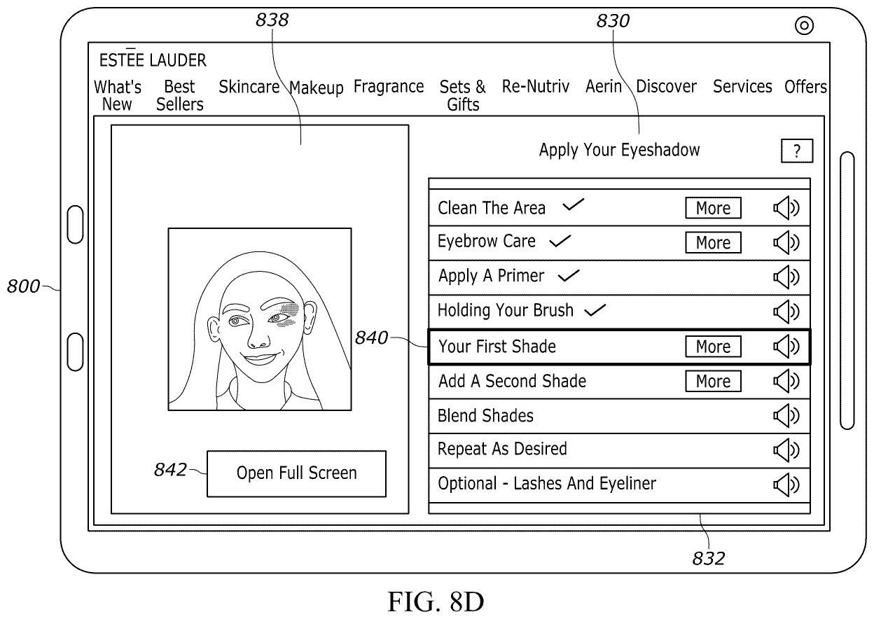

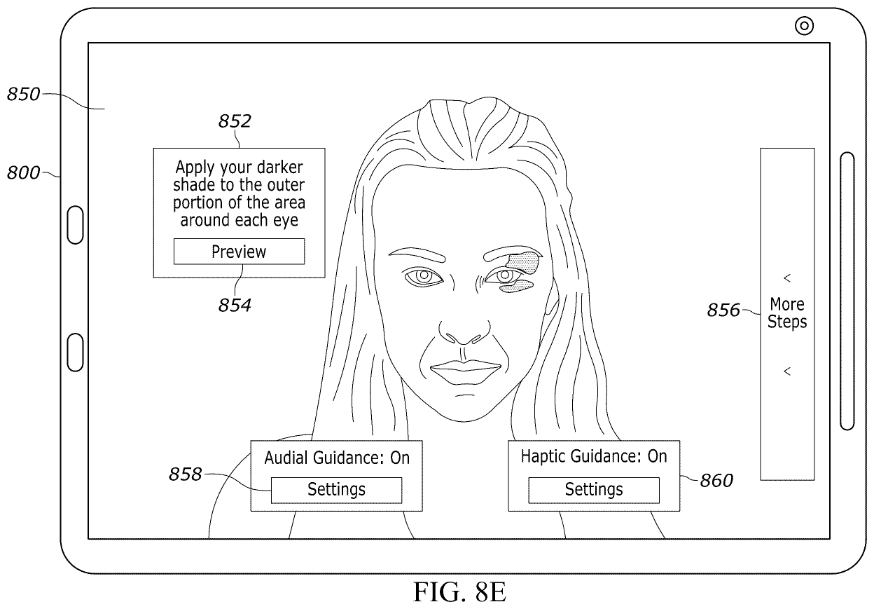

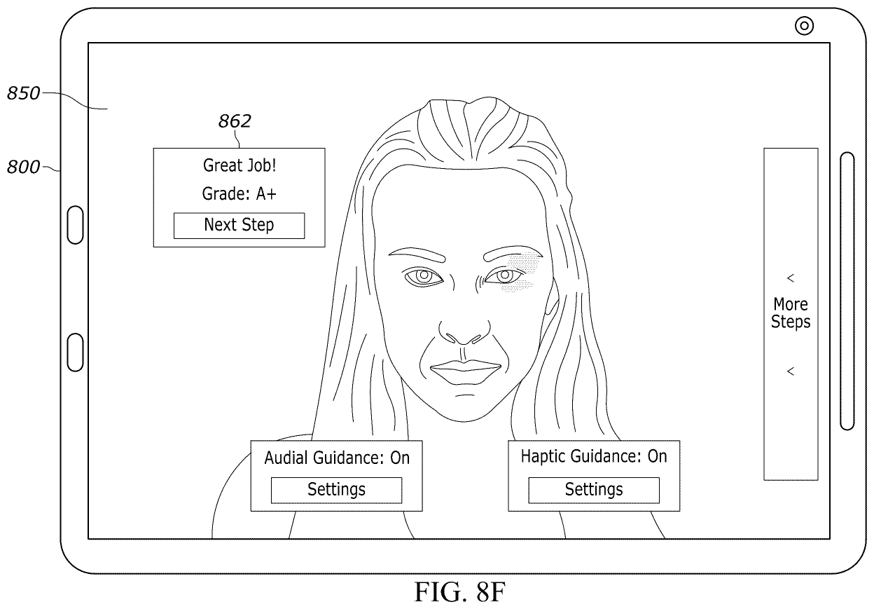

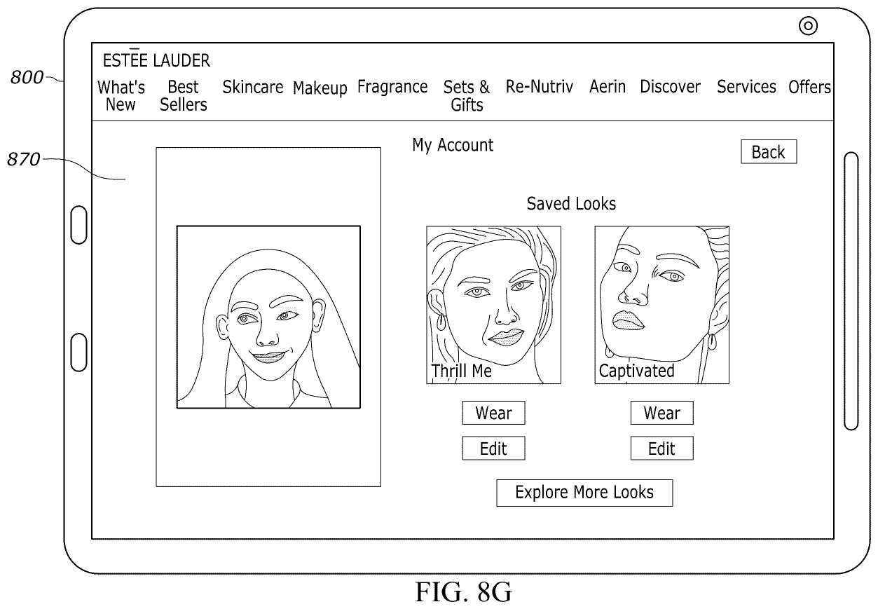

For ease of description, examples of virtual guidance techniques will be described with respect to graphical user interfaces (GUIs) of a user device 800 depicted in FIGS. 8A-8H. The user device 800 may for example be a smartphone, tablet, smart wearable device, laptop computer, or another suitable device as described herein. Where example GUIs will be described, it should be appreciated that, unless indicated otherwise, any of the techniques herein may be adapted and/or augmented by other modes of input/output, including audial input/output using one or more microphones and/or speakers of the user device 800, and/or haptic input/output (e.g., motion detection input, vibration feedback, etc.) using one or more haptic output devices and/or sensors of the user device 800. Moreover, execution of interfaces herein may involve the user device 800 operating in combination with one or more other devices belonging to the user. For example, in embodiments, GUIs and/or audial input/output is provided at a smartphone, tablet, or desktop/laptop computer of the user, while a wearable device physically connected to the user facilitates haptic input/output (e.g., vibration feedback) and/or further audial input/output to place input/output physically closer to the user where appropriate.

Beginning with FIG. 8A, an example GUI 810 provides a list of cosmetic products saved by the user, with GUI elements 812, 814 indicating respective cosmetic products for which virtual guidance (or at least one “tutorial”) is available. An available tutorial associated with a given cosmetic product might include, for example, a tutorial for applying, removing, and/or adjusting the cosmetic, and/or for performing some other actions relevant to the cosmetic (e.g., for performing first aid, storing or disposing of cosmetic products, etc.). Although the GUI 810 involves accessing tutorials for a cosmetic product by navigating the user's saved cosmetics, it should be appreciated that tutorials may be accessed via various other functionalities, including for example any interface that involves presenting information related to a cosmetic product or products. For example, tutorials might be accessed via interfaces for exploring cosmetic products, virtually applying cosmetics, generating looks, etc. In any case, the user may select the GUI elements 812, 814 to advance to virtual guidance associated with the cosmetic product (and/or to other types of virtual guidance described herein). In some embodiments, a particular type of haptic output (e.g., a particular vibration pattern) may be provided to the user to signify availability of virtual guidance for any particular cosmetic product saved or navigated to by the user, so as to prompt the user to associate the particular type of haptic output with availability of virtual guidance (or, more specifically in some cases, a particular type of virtual guidance, e.g. for applying or for removing a particular cosmetic product).

FIG. 8B depicts another example GUI 820 indicating virtual guidance in the form of tutorials associated with a selected product (e.g., via selection of the GUI element 812 from FIG. 8A). As depicted in FIG. 8B, available virtual guidance may include tutorials particularly customized to the selected cosmetic product, e.g., a tutorial for applying or for removing the selected cosmetic product. Additionally or alternatively, though, available virtual guidance may include tutorials relevant to the selected product but not uniquely associated with the selected product, e.g., tutorials for face or hand sanitization, first aid, identifying counterfeit, harmful, or tampered-with products, organizing the user's cosmetic products, or safe cosmetic storage and/or disposal (e.g., to promote safe and/or environmentally conscious use of cosmetics). The user may select GUI elements associated with any respective tutorial to obtain further information regarding the tutorial and/or to launch the tutorial at the user device 800, as will be described with respect to subsequent figures.

Although the GUI 820 shows just the tutorials that may be relevant for one particular product, the user in some embodiments may access a full “library” of virtual guidance, e.g., including tutorials associated with any number of cosmetic products and/or other cosmetic topics.

Moving to FIG. 8C, a GUI 830 provides virtual guidance for applying an eyeshadow (e.g., the eyeshadow from FIGS. 8A and 8B, based on selection of corresponding GUI elements therein). The GUI 830 includes a steps panel 832 displaying, at a glance, an ordered (or, in some cases, unordered) list of steps involved with applying the eyeshadow. As will be described further herein, the user may interact with particular steps displayed in the steps panel 832 to obtain further information and/or virtual guidance associated with each particular step. In embodiments, at least some steps involved in virtual guidance are denoted hierarchically, where a step is composed of a plurality of actions for which virtual guidance is individually available. Accordingly, for some steps in the steps panel 832, the user may select a “More” icon 834, which may for example expand the corresponding step to display the plurality of actions involved therein within the steps panel 832. Additionally, each step as displayed in the steps panel 832 may include a sound icon 836, which the user may select for example to cause and/or configure the provision of audial guidance for the corresponding step.

In the steps panel 832, a final step regarding eye lashes and eyeliner is labeled as “Optional,” where the step does not need to be completed to apply an eyeshadow and hence is not required in order to complete the tutorial. Nevertheless, the user may choose to complete additional optional steps insofar as the steps may relate to and improve the application of the eyeshadow. In some instances, “optional” steps in the steps panel 832 may link to entire related tutorials, e.g., for applying additional cosmetic products in combination with the eyeshadow, or for performing some other task relevant to eyeshadow application (e.g., safely storing or disposing of the eyeshadow, sanitizing the user's face or hands in advance of applying the eyeshadow, etc.).

Still referring to FIG. 8C, the GUI 830 includes an augmented reality (AR) panel 838 configured to provide virtual guidance through the use of AR element. At any point while the user accesses virtual guidance, the AR panel 838 may display image data depicting the face of the user (e.g., using any suitable techniques described in this disclosure). As the user proceeds through each step in the virtual guidance sequentially, the AR panel 838 may display various AR elements to visually guide the user through each step (e.g., by displaying overlays over the user's face to indicate where and/or how a step is to be performed, or via other AR techniques described in this disclosure).

An example of proceeding through a particular step in a cosmetic routine will be described with respect to FIGS. 8D-8F. It should be appreciated that analogous techniques may be applied to virtual guidance for each step in a cosmetic routine, and for various other cosmetic routines including those described in this disclosure.

Beginning with FIG. 8D, an active or “in-progress” step 840 is highlighted in the steps panel 832 to denote an active step in the virtual guidance. In this example, the step 840 is titled “Your First Shade,” and corresponds to applying a first shade comprising an eyeshadow to a first portion of the area around each of the user's eyes. Previously completed steps in the steps panel 832 are denoted via check marks. In some embodiments, particularly where a given cosmetic routine does not strictly require certain steps to be performed in a particular ordered manner, the user may select any particular step in the steps panel 832 to activate that particular step. In some embodiments, the user device 800 may provide a particular type of haptic output (e.g., a particular vibration intensity, pattern, frequency, etc.), to indicate a transition to a new step in the cosmetic routine, and/or to indicate the particular type of the step 840, thereby providing non-visual updates as to the user's progress through the steps listed in the steps panel 832.

While the step 840 is in-progress, the AR panel 838 is updated to display one or more AR elements to guide the user through completion of the step 840. In this example, AR overlays 844 are displayed around the eye of the user to denote the area to which the first shade of eyeshadow is to be applied. The AR panel 838 further includes an “Open Full Screen” option 842, selection of which may allow the AR panel 838 to expand to occupy more of the GUI 830 (or the entirety of the GUI 830), for example as depicted in FIGS. 8E and 8F.

Moving to FIG. 8E, a full-screen AR panel 850 provides additional virtual guidance for performing the step 840 from FIG. 8D. The full-screen AR panel 850 includes the overlays 844 from FIG. 8D, denoting where the first shade of the eyeshadow is to be applied (with respect to one or both eyes of the user). The full-screen AR panel 850 also includes an instructional overlay 852 including text describing the in-progress step to be performed. The instructional overlay 852 includes a “Preview” option 854, selection of which may cause the full-screen AR panel 850 to display additional AR elements to preview an appearance of the user's eye(s), i.e., to demonstrate what the user's eye(s) will look like when the in-progress step has been completed. The full-screen AR panel 850 further includes an element 856 to view the full listing of steps in the cosmetic routine (e.g., by returning to the GUI from FIG. 8D, or by displaying steps in a similar manner).

Still additionally, the full-screen AR panel 850 includes an audial guidance panel 858 via which the user may cause or configure audial guidance to be provided for the in-progress step (and/or for other steps in the cosmetic routine). Audial guidance for a step may, for example, include text-to-speech audial output for the instructions contained in the instructional overlay 852, and/or other verbal instructions relevant to performing the step. The user may for example use the audial guidance panel 858 to configure audial guidance playback speed, volume, tone, language, and/or other relevant parameters. Audial guidance may additionally or alternatively include audial output indicating whether the user correctly performed (or is in the progress of correctly performing) the step 840. For example, computer vision techniques may be implemented to determine whether the user has moved their hand (or a cosmetic application instrument) close to a correct location relative to the user's face for performing the step, and a tone may be provided to indicate the determination (e.g., by playing the tone only when the user's hand or application instrument to the correct location, or by changing the pitch, frequency, or another aspect of the tone when the user's hand or application instrument is close to the correct location). Still additionally or alternatively, audial guidance may enable the user device 800 to receive audial input from the user, e.g., as input to a voice assistant to inform the user how to perform the step, what comes before or after the step, etc. In some embodiments, natural language processing techniques are performed upon received voice input, for examine to identify one or more steps or other aspects of the cosmetic routine for which clarification or repetition is required.

Still referring to the full-screen AR panel 850 of FIG. 8E, the user may interact with a haptic guidance panel 860 to cause or configure haptic guidance to be provided for the in-progress step (and/or for other steps in the cosmetic routine). In embodiments, haptic guidance for the in-progress step may include a particular type(s) of vibration indicating to the user any of (1) an action(s) to be performed for the in-progress step, (2) a particular cosmetic tool and/or product to be used to perform the in-progress step, and/or (3) a location on the user's face (e.g., a particular facial feature(s)) upon which the in-progress step is to be performed. Additionally or alternatively, haptic guidance may include vibration output based upon proximity of the user's wearable device or cosmetic application tool to a relevant location on the user's face. For example, one or more haptic actuators of the user device 800 and/or another device of the user may provide varying patterns, frequency, and/or intensity of haptic output based upon a distance of the user's cosmetic application tool, hand, or finger to a particular location on the user's face upon which the in-progress step is to be performed (e.g., increasing vibration intensity as the user's finger approaches the region around the user's eye as depicted in FIG. 8E).

Still yet additionally or alternatively, haptic guidance may include haptic output at the user device 800 and/or at another device of the user (e.g., a smart wearable device) to indicate whether the user correctly performed the step (or is correctly performing the step), or has made an error with respect to the step. For example, haptic guidance may cause a device of the user to vibrate (or vibrate more intensely) based upon whether the user has moved their hand or cosmetic application to a correct location relative to the user's face, e.g., as determined based upon computer vision techniques. In still another example, haptic guidance may obtain and analyze input from sensors of one or more devices of the user (e.g., an accelerometer of a wearable device, a cosmetic application tool, etc.) to determine whether the user has moved in a manner appropriate for the in-progress step (e.g., whether the user moved their hand or application instrument with an appropriate precision or speed, whether the user contacted a particular feature at an appropriate angle, duration, pressure, etc.). In addition to indicating any errors in performance of the in-progress step, haptic guidance may help the user correct errors, e.g., by providing particular types of haptic output corresponding to the necessary correction(s) to be made. The haptic guidance described herein may be synchronized with other forms of output, e.g., to synchronize with audial and/or visual output provided via the full-screen AR panel 850, other GUIs of the user device 800, and/or other outputs of another device(s) of the user. Thus, various forms of virtual guidance including visual, audial, and/or haptic guidance can be applied for any particular step in a cosmetic routine, in various combinations.

Access to still other accessibility settings may be provided via the full-screen AR panel 850 and/or other interfaces herein, in various embodiments. For example, the user may adapt the provision of virtual guidance based on specific visual preferences or impairments, for example by increasing the size of text, adapting the color scheme of text and/or other visual elements to accommodate color blindness, etc. Moreover, the user may configure the provision of haptic guidance, e.g., to customize particular types of haptic output to be associated with particular information to be communicated to the user (e.g., associating a particular vibration pattern or frequency with a particular type of cosmetic product or unique cosmetic product, tool, facial feature, direction to move the user's hand, type of corrective action, etc.).

Moving to FIG. 8F, as the user performs an in-progress step (e.g., applying the first shade of the eyeshadow, in this example), computer vision techniques are implemented on real-time image data from the user device 800 (in combination with the 3D face mesh technologies herein) to determine whether the user performed the step, and more particularly, whether the user performed the step correctly or accurately. In this example, analysis of live image data (as displayed through the full-screen AR panel 850) indicates that the user applied the eyeshadow accurately to the region around an eye (e.g., the user applied a proper amount of the eyeshadow in a correct location(s)). Accordingly, the full-screen AR panel 850 updates to display a visual indicator 862 to recognize the user correctly performing the step and to invite the user to proceed to a subsequent step of the virtual guidance. Audial and/or haptic output may be provided additionally or alternatively to the visual indicator 862, and may be synchronized in timing with the visual indicator 862, e.g., to indicate correct completion of the step via outputting a tone, vibrating the user device 800 or another device of the user, etc.

In some embodiments, the full-screen AR panel 850 includes still other information relating to the in-progress step. For example, the full-screen AR panel 850 may preemptively alert the user about common mistakes or oversights made by other users during the cosmetic routine or more particularly during the in-progress step, as determined for example based upon AI techniques and/or other analyses of trends involving use of the technologies of this disclosure by the same user and/or by other comparable users. In another example, where performing the in-progress step involves using a particular tool or other equipment, the full-screen AR panel 850 may present invitations to the user to schedule reminders to perform cleaning or maintenance of the tool/equipment, or to re-purchase a particular cosmetic product or tool where the user may run out of the product. In some embodiments, AR elements in the full-screen AR panel 850 includes one or more videos, e.g., to animate the performance of one or more steps of the routine).

Various other arrangements of the interfaces and techniques herein may be envisioned, in various embodiments. For example, any of the elements from the full-screen AR panel 850 may additionally (or alternatively) in the GUI 830 from FIGS. 8C and 8D, e.g., as AR elements in the AR panel 838 and/or elsewhere in the GUI 830. Likewise, any of the elements from the GUI 830 may additionally or alternatively be provided via the full-screen AR panel 850 and/or via other interfaces described herein.

In any case, similar techniques to those described above may be repeated as the user progresses through virtual guidance for a plurality of steps in a cosmetic routine. In various embodiments, once the user progresses through the virtual guidance, the user can review their performance of the cosmetic routine. For example, the GUIs of FIGS. 8C-8F may allow the user to view “before-and-after” images representing the user's face before and after completing the cosmetic routine (or at any particular point in between). Additionally or alternatively, in some embodiments, the GUI 830 as depicted in FIG. 8D may update to show respective scores or other assessments of each of the steps of the cosmetic routine as indicated in the steps panel 832. Based on the scores or assessments of each step, an overall score or assessment may be provided to the user to quantify how correctly or accurately the user performed the cosmetic routine. These overall scores or assessments may be tracked and displayed over time, e.g., for the user to track how the user has improved their skills in performing the cosmetic routine (and/or other cosmetic routines) with each successive repetition.

In some embodiments, the user may modify and/or re-arrange the steps within any cosmetic routine, so as to create their own personalized cosmetic routines. For example, referring back to the eyeshadow example above, a user may customize the eyeshadow routine to include three or more shades, to include the application of another supporting cosmetic product(s), to include applying an eye cream or serum, etc. The user may save customized cosmetic routines to their user profile, e.g., to enable later access to customized virtual guidance in a manner similar to the user accessing saved products, styles, looks, etc. Furthermore, a user may structure cosmetic routines (and the cosmetic products involved therein) together, to effectively generate and store a personalized cosmetic plan for the user, where virtual guidance is available for any particular portion of the cosmetic plan. For any cosmetic routines and/or products for which virtual guidance is not yet available, AI techniques may be applied to produce computer-generated virtual guidance, e.g., based upon existing knowledge regarding the application of similar cosmetic products, performing similar steps in cosmetic routines, etc.

In some embodiments, in addition to (or alternatively to) the forms of virtual guidance already described herein, virtual guidance may be offered to guide the user through application of a plurality of cosmetic products comprising a look. For example, as depicted in FIG. 8G, the user may access their user profile via GUI 870 to access one, two, three, four or more looks saved to the user profile (“saved looks”). Each of the saved looks includes one, two, three, four or more cosmetic products (and in some cases, specific manners of applying said cosmetic products). For each saved look, the GUI 870 provides elements that the user may select to “Edit” the selections of cosmetic products/styles in the look, and to “Wear” the look via receiving virtual guidance for applying a plurality of cosmetic products in the look.

In response to selecting the “Wear” option for a particular look, a GUI 880 is provided at the user device 800 to virtually guide the user through application of the look, via techniques similar to those for applying a single cosmetic product as described with respect to FIGS. 8A-8F. The GUI 880 includes a steps panel 882, in which easy of the initially listed steps corresponds to application of a respective one of a plurality of cosmetic products in the look. The steps may be arranged hierarchically, where each of the initially listed steps may be expanded to list a plurality of “sub-steps” contained therein. The GUI 880 also includes an AR panel 884, which may operate similarly to as described with respect to FIGS. 8C-8F, e.g., to display real-time image data of the user and various additional AR elements. As with virtual guidance for applying a single cosmetic product, virtual guidance for applying a look may include audial and/or haptic input and/or output techniques to facilitate guiding users (including users having one or more visual impairments) through the application of a look.

Thus, in view of the foregoing, virtual guidance is provided to guide users not only through the typical application, removal, and/or adjustment of cosmetic products, but through various other routines associated with managing one's cosmetic products. By introducing various combinations of visual, audial, and/or haptic guidance techniques, the technologies herein make virtual guidance available and accessible to wide arrays of users, regardless of the user's existing skills, knowledge, physical capabilities or limitations.

### Other Virtual Assistant Functionalities

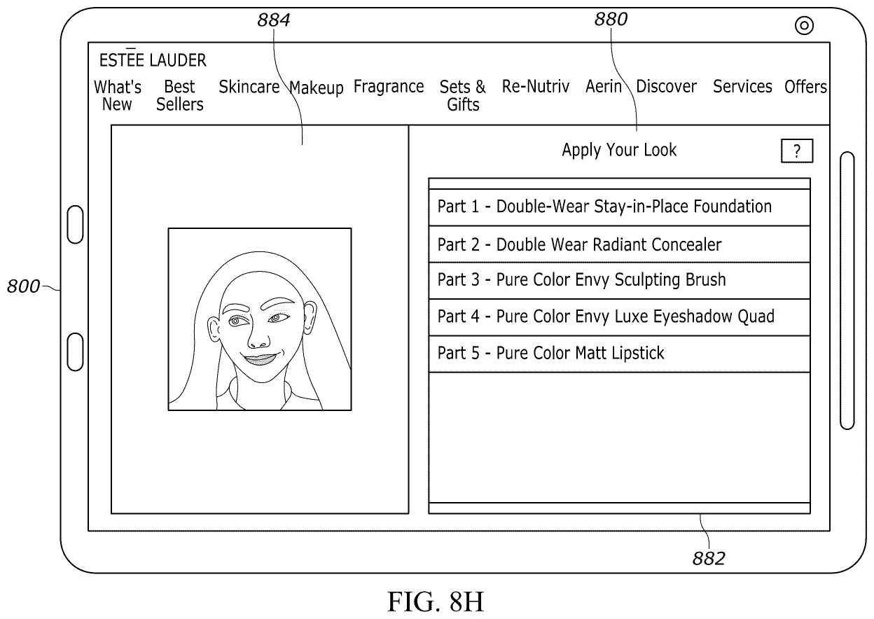

In various embodiments, still additional virtual assistant functionalities are envisioned to assist the user in exploring, acquiring, and/or using cosmetic products, and/or with using the virtual cosmetic functionalities of this disclosure. Examples of these additional virtual assistant functionalities will be provided with respect to FIG. 9, which depicts a user device 900 executing a graphical user interface (GUI) 910. The user device 900 may for example be a smartphone, tablet, smart wearable device, laptop computer, or another suitable device as described herein (e.g., user device 102 of FIG. 1A, user device 410 of FIG. 4, and/or another user device as described in other sections of this disclosure).

The GUI 910 includes elements that the user may select to access respective virtual assistant functionalities (e.g., via keyboard/mouse input, touchscreen input, voice input, etc.). For instance, the user may select a “voice commands” functionality 912 (i.e., the GUI element representative of the functionality) to view and/or configure the use of voice commands and/or other voice input in connection with any of the technologies of this disclosure. The user may, for example, view and/or configure voice commands to be used to navigate among user interfaces herein and/or use virtual cosmetic functionalities (e.g., voice commands to navigate among elements of a virtual tutorial).

A “track my progress” functionality 914 (i.e., an element on the GUI selectable to access the functionality) allows the user to track his or her usage of the technologies herein over time. The user may, for example, track their improvement in performing one or more cosmetic routines over time (e.g., as measured via the virtual guidance technologies described with respect to FIGS. 8A-8H). Additionally or alternatively, the user may track the improvement in health and/or appearance of one or more facial features of the user over time (e.g., as a given facial feature is detected and evaluated at various points in time via use of various technologies involving the 3D face mesh as described in this disclosure).

The GUI 910 additionally provides access to a social “leaderboards” functionality 916, which may allow the user to compare their use of technologies herein to that of friends, family, users of same or similar products, and the like. For example, the leaderboards functionality 916 may compare the user's performance in a cosmetic routine to performance of the same or similar routine by another user(s) (e.g., comparing a user's application of an eyeshadow to the application of same or similar eyeshadows by another user(s)). In some embodiments, the leaderboards functionality 916 provides challenges for completion by the user, for example to successfully use technologies of this disclosure (e.g., to complete a set of virtual tutorials, to use a virtual tutorial a particular number of times, to achieve a particular score in a virtual tutorial, etc.). Completion of challenges may be recognized by providing rewards upon completion, for example in the form of discounts or gifts of cosmetic products, and/or access to additional challenges. In some embodiments, accessed challenges may escalate in difficulty, thereby helping the user to evaluate progression of the user's skills as the user completes the challenges.

Still referring to FIG. 9, the GUI 910 provides access to an expiry notifications functionality 918, which may allow the user to be warned of expiration of cosmetic products owned by the user. The user may register cosmetic products owned by the user to the expiry notifications functionality 918, for example by the user capturing images of the products, by the user entering product codes of the products, and/or by the technologies herein referencing the user profile to identify products purchased by the user. In embodiments, notifications may be provided to the user (e.g., as push notifications) if a cosmetic product owned by the user has reached its expiration date or is approaching its expiration date (e.g., to warn the user that the cosmetic product may not be at its best quality in one day, one week, one month, etc.). In embodiments, a notification may be provided to the user any time an indication is received that the user may be using a cosmetic product near or past its expiration date (e.g., when the user launches a tutorial for applying an eyeshadow, but the only eyeshadow(s) registered to the user are at or near their expiration date(s)).

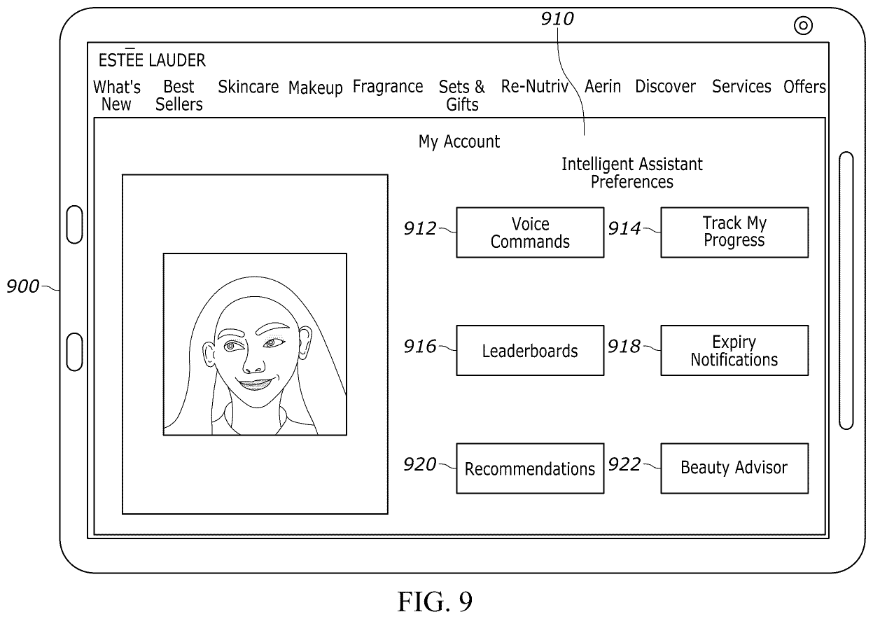

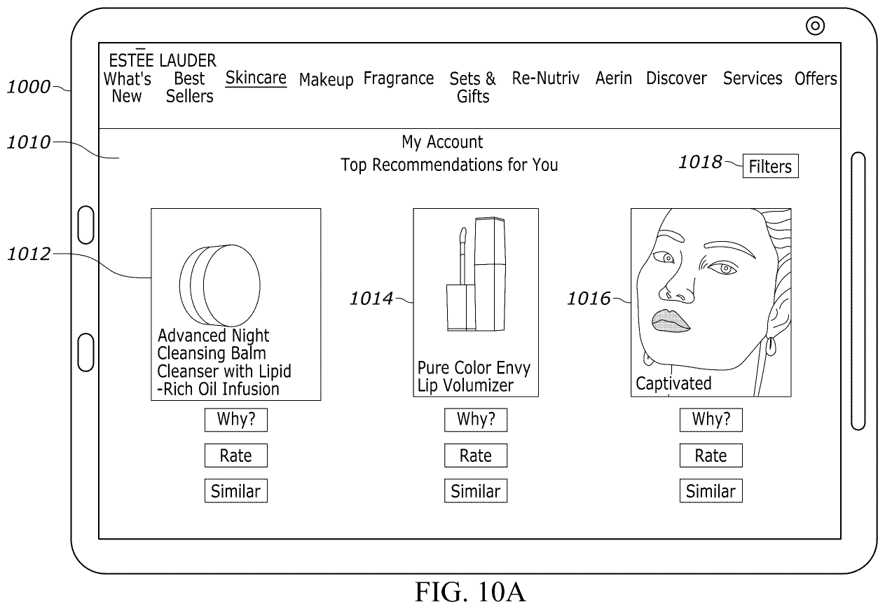

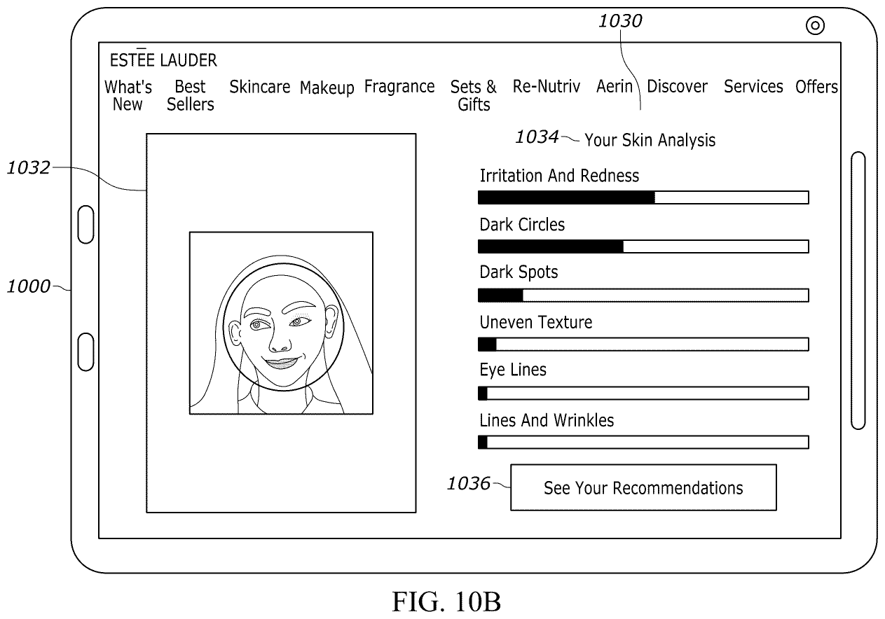

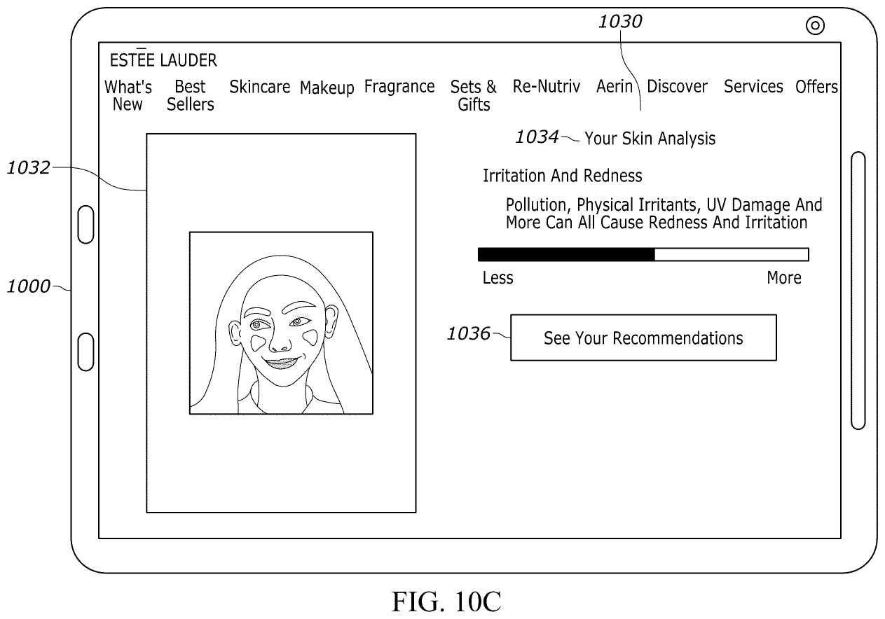

The GUI 910 includes a recommendations functionality 920, which may for example enable the user to access cosmetic products and/or routine recommendations generated for the user, as will be described for example with respect to FIGS. 10A-10C. In embodiments, the recommendations functionality 920 enables the user to view and/or configure settings associated therewith the recommendations of cosmetic products to the user (e.g., to define what parameters are to be prioritized in the recommendations of products, what products or classes of products are to be preferred or excluded, and/or what data of the user is permitted to be used to generate recommendations for the user).

Still referring to FIG. 9, the GUI 910 includes a beauty advisor functionality 922 which may allow the user to connect to a live advisor via text chat, audio chat, video chat, etc. The user may use the beauty advisor functionality 922 for example to obtain recommendations of cosmetic products or routines, obtain combinations of cosmetic products or styles to include in a look, or ask any nuanced questions about their acquiring and/or using cosmetic products.

The GUI 910 is only one example arrangement of access to various assistant functionalities of this disclosure. In various embodiments, the GUI 910 may incorporate still additional and/or alternate functionalities, including those described herein. Moreover, although a GUI 910 is represented for ease of description, it should be appreciated that audial and/or haptic interfaces may additionally or alternatively be used, in various embodiments.

### Recommendations of Cosmetic Products, Styles, and Looks

In various embodiments, technologies of this disclosure provide users with recommendations of cosmetic products, styles, looks, routines, tutorials, and/or other elements that may help users being, adapt, or improve their use of cosmetic products. Generally speaking, recommendations may be generated and provided to a user based for example upon aspects unique to the user (e.g., the user's preferences, favorite products, skin tone, the user's use of technologies herein, etc.), and/or based upon aspects of other similar users or the cosmetic community at large.

Techniques for providing recommendations will be described with respect to user interfaces depicted in FIGS. 10A-10C. The user interfaces of FIGS. 10A-10C are executed at a user device 1000, which may for example be a smartphone, tablet, smart wearable device, laptop computer, or another suitable device as described herein (e.g., user device 102 of FIG. 1A, user device 410 of FIG. 4, and/or another user device as described in other sections of this disclosure). Although visual interfaces are described, it should be appreciated that audial interfaces may additionally or alternatively be used, in embodiments (e.g., voice command input to control user interfaces, and/or text-to-speech output to communicate recommendations and/or other information described with respect to of FIGS. 10A-10C).

Beginning with FIG. 10A, the user may access a recommendation GUI 1010, for example by selecting the recommendations functionality 920 from FIG. 9. The recommendation GUI 1010 as depicted in FIG. 10A provides recommended products 1012, 1014, and a recommended look 1016. For each recommended product or look, the recommendation GUI 1010 enables the user to identify why the product/look was recommended for the user (“Why?” E.g., based upon the user's recently viewed cosmetic products, purchases, favorite cosmetic routines, features identified from the user's 3D face mesh, etc.). The recommendation GUI 1010 also enables the user to rate the product/look (e.g., to inform subsequent recommendations), and/or to explore similar products/looks potentially of interest to the user. A filtering functionality 1018 may enable the user to sort/filter among recommendations generated for the user (e.g., to explore only recommended products but not looks, to explore only recommended types of cosmetic products, to explore products recommended for a particular reason, etc.).

For simplicity, the example recommendation GUI 1010 of FIG. 10A products just a few products/looks that may be recommended to the user. Various types of recommendations may be provided, including recommendations of cosmetic products, styles for applying products, looks (e.g., comprising, two, three, four or more products tailored to the user), cosmetic routines, or tutorials. Recommendations may be provided based upon various techniques and considerations, examples of which will be described in more detail below.

In embodiments, as will be described with respect to FIGS. 10B and 10C, skin care recommendations may be generated and provided to the user based upon analysis of skin features in the user's 3D face mesh. As depicted in FIG. 10B, a virtual skin analysis GUI 1030 executing via the user device 1000 includes an image panel 1032, which displays image data of the face of the user as obtained via techniques of this disclosure (e.g., image data obtained in real-time upon execution of the virtual skin analysis GUI 1030, and/or previously obtained image data). Using the 3D face mesh of the user (as generated based upon the image data), information regarding skin features of the user is identified and displayed in a skin analysis panel 1034. Particularly, the skin analysis panel 1034 indicates the presence and prevalence of features such as irritation and/or redness, dark circles (e.g., under the eyes), dark spots, uneven skin texture, eye lines, and other lines and wrinkles. For example, as indicated in FIG. 10B, the skin analysis panel 1034 indicates moderate presence of both skin irritation/redness and dark circles, and little to no prevalence of other features. Selection of a recommendations functionality 1036 enables the user to view recommendations for skin care products, styles, looks, and/or routines based upon the skin features identified for the user, e.g., to address irritation/redness and/or dark circles through particular cosmetic products and/or other elements of a skincare regimen. Skincare recommendations may be arranged, for example, as described with respect to FIG. 10A and/or other cosmetic product or routine exploration GUIs as presented in this disclosure.

FIG. 10C depicts additional example functionality of the virtual skin analysis GUI 1030 from FIG. 10B. Particularly, the virtual skin analysis GUI 1030 in FIG. 10C displays additional information regarding skin irritation/redness, for example upon the user selecting the corresponding skin feature from the virtual skin analysis GUI 1030 in FIG. 10B. As depicted in FIG. 10C, the skin analysis panel 1034 provides more details information regarding causes and/or remedies for skin irritation/redness. Furthermore, using augmented reality (AR) techniques of this disclosure, the representation of the user's face in the image panel 1032 is augmented to particularly indicate areas where the skin irritation/redness is more prevalent. When accessed from the virtual skin analysis GUI 1030 as shown in FIG. 10C, selection of the recommendations functionality 1036 may enable the user to view recommendations of cosmetic products, styles, looks and/or routines particularly generated to address the user's skin irritation and/or redness. These recommendations may be based for example upon the size and/or severity of the affected area(s) of the user's face, and/or other obtained data corresponding to the user (e.g., the user's other facial features, the user's preferences, purchase history, wardrobe, favorite cosmetic products or routines, etc.), so as to make the skincare recommendations personalized to the user.

Although skin care recommendations are described above, recommendations may be generated and provided relating to other facial features of the user, as indicated by the user's 3D face mesh. For example, recommendations may be provided for the user's hair, eyes, eyebrows, nose, lips, cheeks, ears, etc., and the characteristics thereof (e.g., hair color, hair style, skin tone(s), oily or dry skin, lip shade, eyelash length, piercings, shape of a nose, cheeks, ears, etc.). Such recommendations may be provided using analogous user interfaces and/or techniques to those described above, so as to provide personalized recommendations based upon the characteristics of the user's features individually and/or collectively.

Various other considerations are contemplated for generating and providing recommendations, examples of which will be provided below. In various considerations, these criteria may be combined with each other and/or with other information regarding the user to provide further personalized recommendations for the user.

In embodiments, cosmetic products, styles, looks, routines, etc. (hereinafter simply referred to collectively as “cosmetic elements”) are provided based upon aspects of the user's geographic location. For example, cosmetic recommendations may be generated and provided based upon the season, climate, and/or weather of the user's location, e.g., to match seasonal styles or to recommend products that suitable for heat, cold, humidity, and/or other near-or long-term weather conditions in the user's location. Additionally or alternatively, cosmetic recommendations may be generated and provided based upon the availability of cosmetic products at or near the user's geographic location. For example, the systems herein may obtain and analyze data indicating availability of cosmetic products at local retailers, and may provide recommendations of cosmetic products verified to be locally available. For cosmetic looks and routines, recommendations may be provided upon verifying that each of one, two, three, four or more cosmetic products therein are locally available.

In embodiments, recommendations of cosmetic products are generated and provided based upon product preferences of the user. Product preferences of the user may include, for example, preferences of particular brands, manufacturers, ingredients, or pricing (e.g., an optimum budget or maximum product cost(s) defined by the user. Pricing preferences of the user may be inferred, for example, based upon the cosmetic product purchase history of the user.

In embodiments, recommendations of cosmetic elements are generated and provided to fill in “gaps” in the user's cosmetic regimen. For example, cosmetic products purchased and/or saved by the user might include cosmetic products for the user's eyes, lips, etc., but may lack a foundation or skincare products. Upon such a determination, technologies herein may recommend foundation and/or skincare products to fill in the gaps in the user's regimen.

In embodiments, collaborative filtering techniques are applied to generate and provide recommendations to a user based upon activity of other users of the technologies herein. For example, where similar users are identified based upon their respective purchases and/or usage of same or similar cosmetic products, routines, etc., recommendations of same or similar products, looks, or routines may be provided to the user. These recommendations may still be further adapted to the user to whom the recommendation is provided (e.g., systems herein may provide a recommendation of a popular lipstick brand as commonly used by similar users, with the recommendation being adapted to select the user's favorite shade when the favorite shade is available from the popular brand).

In embodiments, recommendations of cosmetic elements for a user are generated and provided based upon clothing and/or personal accessories owned and worn by the user. For example, in some embodiments, systems herein may receive indications of clothing and/or accessories worn by the user via one or more user interfaces. Additionally or alternatively, in some embodiments, systems herein may obtain images of the user's personal wardrobe and/or accessories (e.g., by the user uploading photos). In any case, recommendations may be adapted, for example to complement colors, tones, textures, materials, seasonality, and/or other aspects of the user's wardrobe and/or accessories. Moreover, in embodiments, recommendations of cosmetic elements for a user are generated and provided to suit particular cultural trends, practices, or occasions.

In embodiments, recommendations of cosmetic elements for a user are generated and provided based upon the skill level and/or experience of the user with respect to cosmetics. In some cases, the user may provide explicit input to systems herein indicating the user's skill level or experience. In other cases, skill level or experience may be inferred from the user's use of technologies of this disclosure (e.g., based upon the user's success in performing cosmetic routines, and/or based upon the skill level commonly associated with cosmetic products viewed and/or purchased by the user).

In embodiments, recommendations of cosmetic elements are based upon natural language processing (NLP) of natural language input provided by the user, e.g., expressing the user's favor or disfavor of particular products, looks, styles, routines, etc.

In embodiments, a “look inspiration” functionality allows the user to upload or link images of another person(s) whose appearance the user would like to emulate or draw inspiration. For example, as depicted in FIG. 10D, a look inspiration GUI includes an image panel 1052 that displays one or more images (e.g., photo and/or video) of one or more other persons for inspiration. The user may provide the one or more videos, for example, via image upload, via identifying images previously saved by the user via technologies herein, or via linking to another location on the Internet (e.g., a URL).

Upon providing one or more inspiration images, systems herein may analyze the inspiration image(s) to identify the inspiration's facial features, characteristics, and/or worn cosmetic products (e.g., via generation of a 3D face mesh for the person(s) in the provided images, and/or via other image processing techniques). The analysis may further include comparing the analysis of the inspiration image(s) to image data of the user, e.g., to determine whether a same or similar look to that found in the inspiration image(s) would be applicable to the user. As depicted in FIG. 10D, systems herein may provide an indication of a look for the user, e.g., containing same or at least analogous cosmetic products and/or styles to those worn by the person(s) in the inspiration image(s). The user may interact with the GUI to virtually apply the generated look, e.g., as described with respect to FIG. 7A (e.g., using AR technology to virtually apply the product(s) in the look to the user's face).

Furthermore, as depicted in FIG. 10D, systems herein may provide indications of still additional cosmetic products potentially of interest to the user based upon the inspiration image(s), as further informed by other obtained data relevant to the user (e.g., the user's cosmetic preferences, purchase/usage history, etc.). Effectively, the look inspiration functionality generates recommendations of looks and/or products to emulate the inspiration photos, while still accounting for the user's unique facial features and other personal preferences. The look inspiration functionality may further include a feedback functionality, enabling the user to rate the recommended cosmetic look(s) and/or product(s) to inform subsequent recommendations generated by the systems herein.

In various embodiments, the cosmetic element recommendation techniques herein involve artificial intelligence techniques. For example, one or more machine learning structures (e.g., deep learning, neural networks, and/or generative adversarial networks) for generating recommendations for one or more users may iteratively adapted based upon user feedback, which may include for example user ratings of suggested cosmetic products, looks, routines, etc. That is, inputs to the one or more machine learning structures may include user feedback and/or other characteristics of the user, and the one or more machine learning structures may be trained to provide output indicative of suggested products, looks, etc. based upon the inputs. Through training and retraining, the one or more machine learning structures may be trained and/or adapted to further improve recommendations for users.

### Feedback-Based Adaptation of a 3D Face Mesh

In embodiments, interfaces are provided to receive and utilize user feedback to adapt (e.g., adjust or augment) a previously generated 3D face mesh representing the face of a user. Conventionally, techniques for generating a 3D face mesh pose the risk of inaccurately capturing points or features of the user's face, and/or failing to capture enough points or features to make the 3D face mesh truly personalized to the user's unique facial composition. By receiving and utilizing user feedback (e.g., adding or modifying points of the 3D face mesh), techniques allow for improved accuracy and robustness of the generated 3D face mesh. In turn, these user feedback techniques allow for improved accuracy and personalization in using other technologies of this disclosure (e.g., improved accuracy or fidelity in virtual product try-ons or tutorials based upon a more accurate 3D face mesh, and increased personalization of recommendations based on a 3D face mesh that accurately captures more points, features, and characteristics of the user's face).

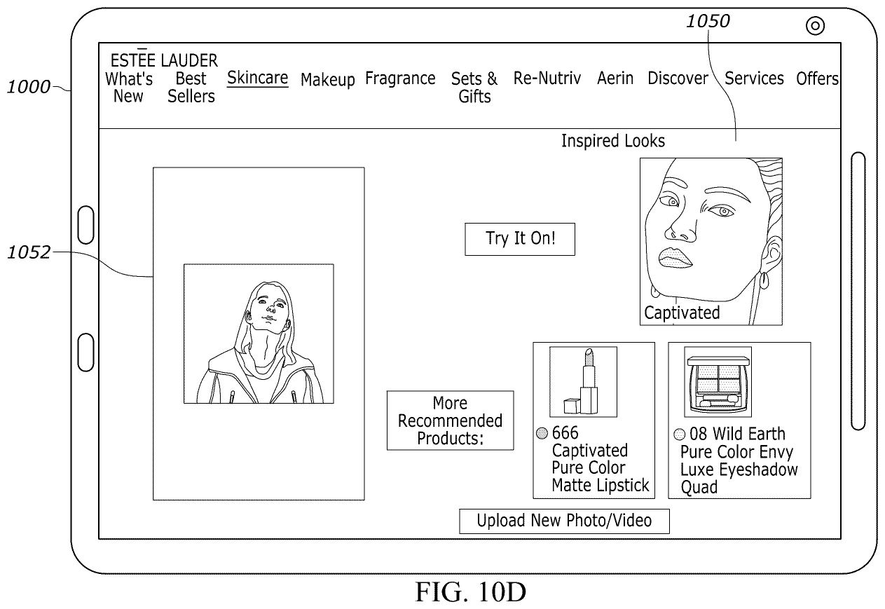

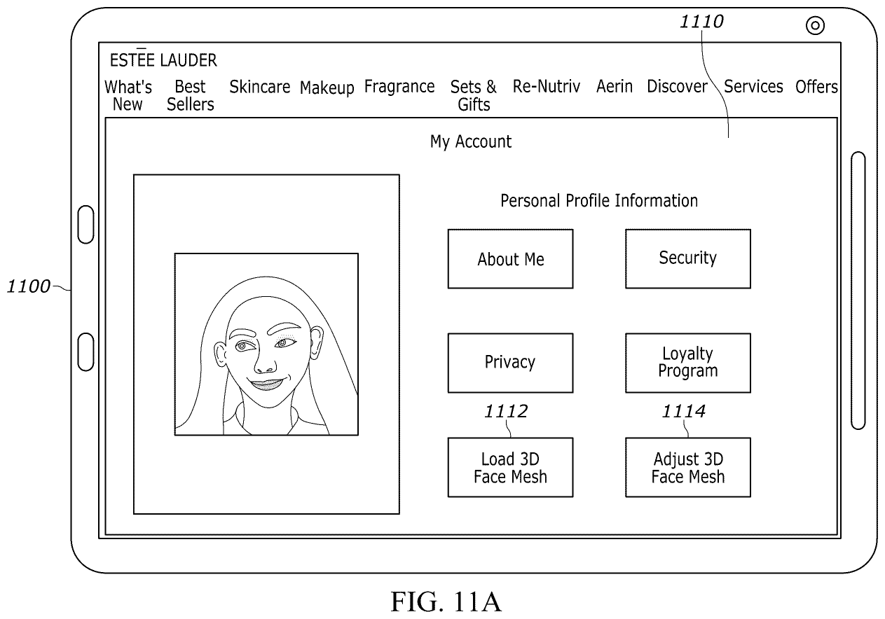

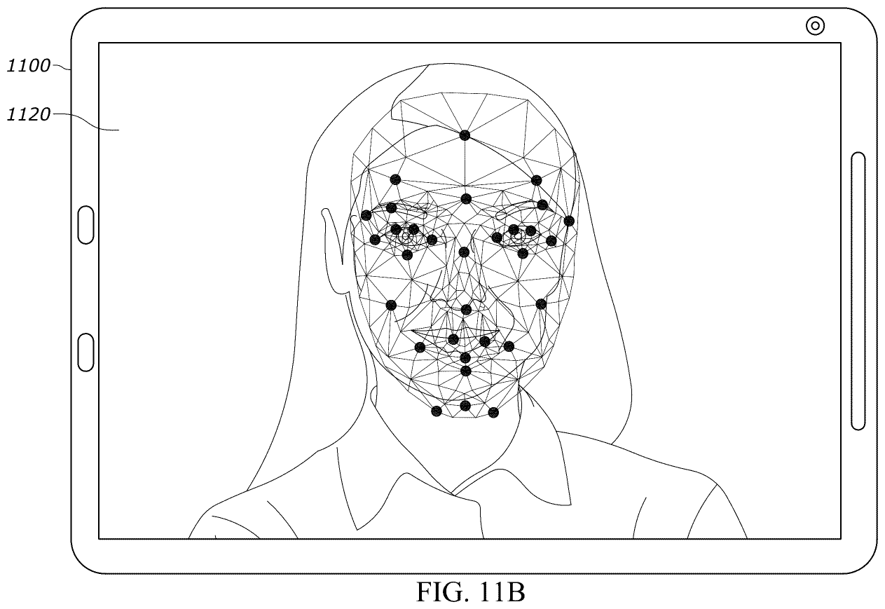

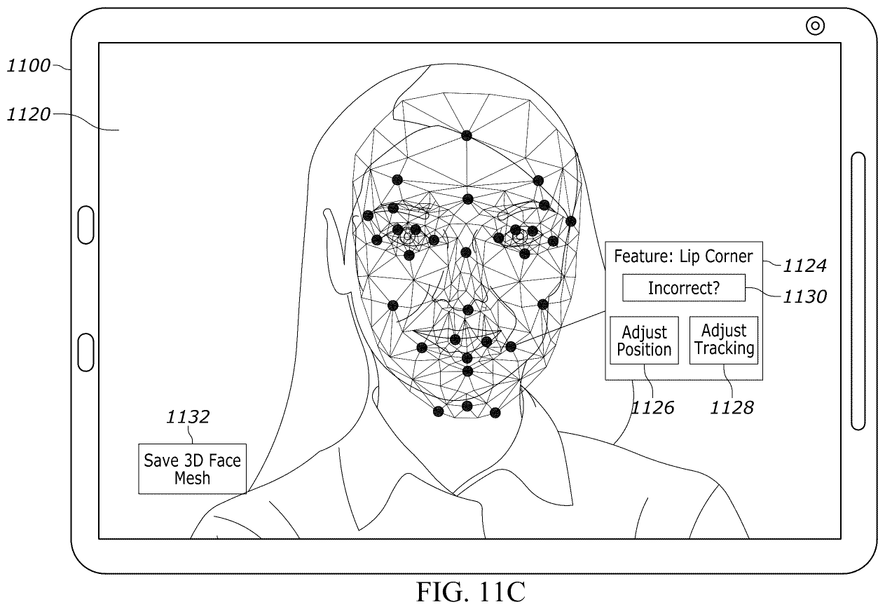

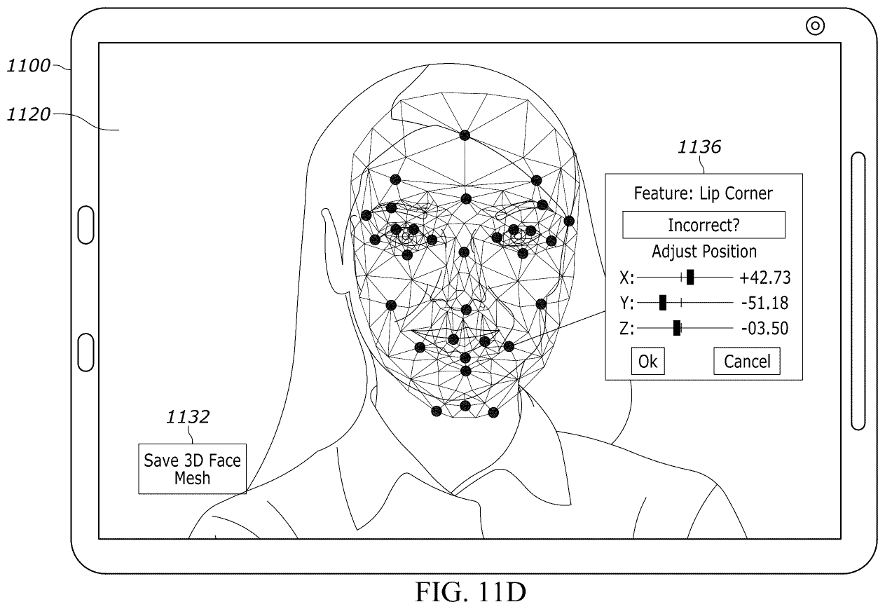

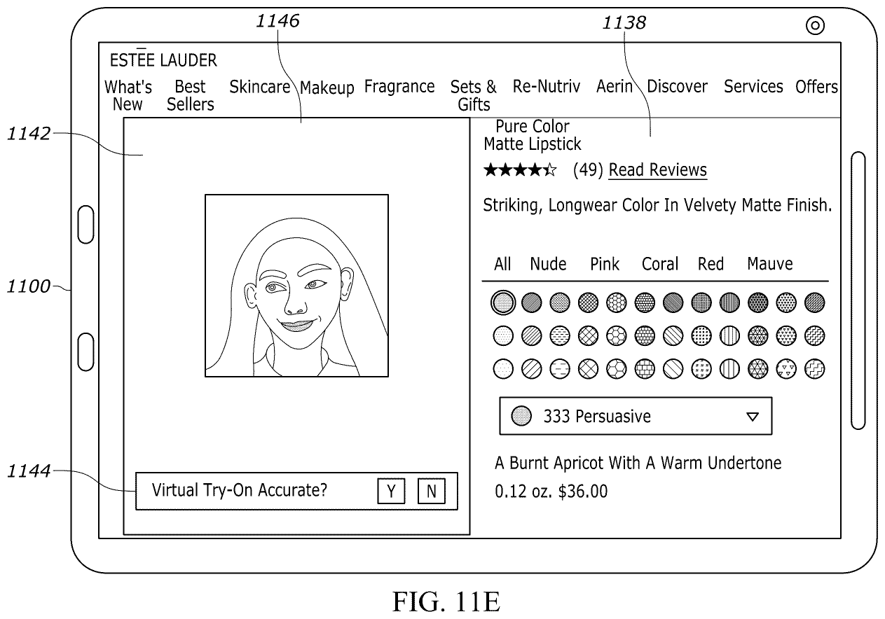

FIGS. 11A-11D depict example user interfaces associated with adapting a 3D face mesh of a user. The user interfaces of FIGS. 11A-11D are executed at a user device 1100, which may for example be a smartphone, tablet, smart wearable device, laptop computer, or another suitable device as described herein (e.g., user device 102 of FIG. 1A, user device 410 of FIG. 4, and/or another user device as described in other sections of this disclosure). Although visual interfaces are described, it should be appreciated that audial interfaces may additionally or alternatively be used, in embodiments (e.g., voice command input to control user interfaces, text-to-speech output, etc.).

FIG. 11A depicts an example user profile GUI 1110 that generally allows the user to view and/or modify personal information associated with the user. In particular, personal information of the user may include a 3D face mesh generated via techniques of this disclosure. Accordingly, the user profile GUI 1110 includes an element 1112 that the user may select to load a previously generated 3D face mesh, and an element 1114 that the user may select to adjust the previously generated 3D face mesh.

The 3D face mesh may be loaded, for example, from one or more servers that store the 3D face mesh after generation of the 3D face mesh via the user device 1100 and/or via another logged-in device of the user. Loading the 3D face mesh at the user device 1100 may enable operation of technologies of this disclosure at the user device 1100 without needing to recapture image data of the face of the user and/or regenerate the 3D face mesh. Accordingly, the ability to load the 3D face mesh to the user device 1100 may also enable the user to use at least some technologies of this disclosure even if the user device 1100 does not have camera access and/or sufficient processing availability for generation of a new 3D face mesh.

Selection of the element 1114 may direct the user to one or more user interfaces (e.g., one or more GUIs) via which the user may adapt the 3D face mesh of the user, for example by modifying existing facial points in the 3D face mesh and/or by adding new points not yet included in the 3D face mesh. Examples of user interfaces for adding/modifying points (and/or otherwise adapting a 3D face mesh) will be depicted in FIGS. 11B-11D.

Beginning with FIG. 11B, a 3D face mesh adaptation GUI 1120 depicts the 3D face mesh of the user, for example using augmented reality (AR) elements to superimpose points of the 3D face mesh upon image data of the face of the user. In some embodiments, the image data upon which the AR elements are displayed includes a still image of the user's face (e.g., as previously captured via use of technologies of this disclosure). In other embodiments, the image data includes real-time imagery captured via one or more cameras of the user device 1100, and accordingly, the GUI 1120 may update the representation of the facial points (e.g., the respective locations thereof) responsive to receiving updated real-time imagery. That is, the represented locations of points, which are each anchored to a feature or portion of a feature of the user's face, may move in relation to each other as the user changes their facial expression, moves closer or farther to the camera, etc.

In any case, from the 3D face mesh adaptation GUI 1120, the user may select any particular facial point to modify (or, in some cases, a group of facial points, e.g., corresponding to the user's eye, nose, upper or lower lip, chin, etc.). Selection of one or more facial points to modify may be received, for example, via touchscreen or mouse input to the GUI 1120, via voice input (e.g., “edit my lip”), and/or via other suitable input techniques of this disclosure. FIG. 11C depicts the GUI 1120 with an example overlay 1124 presenting options for modifying an identified facial point (e.g., a point corresponding to a corner of the user's lip). Particularly, the overlay 1124 in FIG. 11C presents options for adjusting the position of the identified facial point (1126), for adjusting the behavior (“tracking”) of the facial point in following movements of the user's face (1128), and for indicating that the facial point is incorrectly mapped to a feature of the user's face (1130, e.g., if the overlay 1124 indicates that the point is the lip corner when the point actually appears over the user's cheek). The GUI 1120 as depicted in FIG. 11C also includes a “save” option 1132, enabling the user to save any modifications or augmentations to the 3D face mesh for future use of technologies of this disclosure.

In response to selection of the option 1128, the GUI 1120 may present an overlay 1136 via which the user may edit the position of the selected facial point independently along the x, y, and z axes (e.g., relative to an identified center of the user's face). By receiving input adjusting the facial point location for any one image of the user's face, the 3D face mesh technology may be trained to track the facial point location according to the adjusted location. For example, as depicted in FIG. 11D, upon the user adjusting the location of the lip corner for a displayed image of the user's face, the 3D face mesh technology is trained to track the adjusted lip corner as the user changes their facial expression, proximity to the camera, etc. Once again, as depicted in FIG. 11D, the GUI 1120 provides the option 1132 to save the updated 3D face mesh for future use.

In various embodiments, the interfaces of FIGS. 11B-11D may be integrated into other technologies of the present description. For example, referring back to the virtual try-on techniques of this disclosure, a virtual try-on interface may include mechanisms for providing user feedback regarding the virtual application of a selected cosmetic product to the user's face. For example, as depicted in FIG. 11E, a virtual try-on GUI 1138 provides an AR interface 1142 in an image panel 1146 displaying a lipstick virtually applied to the lips of the user (e.g., in a manner similar to that described with respect to FIG. 6D). The AR interface 1142 includes an element 1144 soliciting user input as to whether the AR interface 1142 correctly represents the cosmetic product is correctly applied (e.g., based upon whether the AR interface 1142 shows the lipstick over the entirety of the user's lips and not over any other portion of the user's face).

If the virtual application of the cosmetic product is incorrect, the user may use the virtual try-on GUI 1138 to correct the virtual application, for example by indicating particular points or regions on the user's face where the cosmetic should or should not be applied, as depicted in FIG. 11F (e.g., via touchscreen input, and/or via voice input and natural language processing techniques). Based upon the user feedback through the virtual try-on GUI 1138, technologies herein may update the user's 3D face mesh, e.g., by correcting the points or regions of the user's face identified as corresponding to the user's lips. More particularly, an artificial intelligence (AI) model(s) for generating and/or adapting the 3D face mesh (e.g., models described with respect to FIG. 2) are trained or re-trained based upon the user feedback that indicates the quality of initial output. Thus, leveraging the adapted 3D face mesh and/or AI models, subsequent use of virtual try-ons may more accurately represent the virtual application of lip products and/or other cosmetic products based upon the 3D face mesh as improved by user feedback. In embodiments, the re-trained AI model(s) may be applied substantially in real-time, so as to update the virtual try-on of the cosmetic product promptly responsive to user feedback. By iteratively implementing user feedback and presenting results to the user, the interfaces herein may enable the user to progressively improve the level of accuracy and personalization of the 3D face mesh-based technologies herein.

Similar techniques for receiving and utilizing user feedback may be applied to other technologies of this disclosure, in various embodiments. For example, in embodiments, user interfaces for virtually applying a look (e.g., as described with respect to FIGS. 7A-7D) may include elements for soliciting and receiving feedback regarding the accuracy of the virtual application of any one or more cosmetic products comprising the look. Technologies of this disclosure may update the user's 3D face mesh and/or AI models for generating 3D face mesh based upon the user feedback, so as to learn from the user feedback and improve subsequent use of technologies herein.

In embodiments, virtual guidance technologies of this disclosure (e.g., as described with respect to FIGS. 8A-8H) provide one or more tutorials for using the 3D face mesh adaptation technologies as described herein. For example, a listing of tutorials as described with respect to FIG. 8B can include a tutorial including steps for launching a virtual application of one or more cosmetic products, indicating whether the virtual application of the cosmetic product(s) is accurate, providing specific details regarding any inaccuracies in the virtual application, refining facial points comprising the 3D face mesh, sharing a 3D face mesh updated based upon user feedback, and/or providing other relevant feedback from which a 3D face mesh and/or 3D face mesh models may be improved.

Still additionally or alternatively, in embodiments, feedback mechanisms may be provided specifically to adapt and improve the haptic feedback techniques of this disclosure. For example, a feedback loop mechanism may be provided to collect user reactions to different haptic feedback settings or outputs during use of the technologies of this disclosure (e.g., exploring cosmetic products, generating looks, virtual guidance for cosmetic routines, etc.). Received user feedback may be provided to one or more machine learning models to adapt and personalize haptic feedback techniques (e.g., particular haptic feedback patterns utilized to communicate particular types of information to the user) according to the user's personal preferences or the effectiveness of the user in utilizing the haptic feedback techniques.

### Smart Packaging Technologies

In embodiments, technologies of this disclosure integrate with “smart packaging” elements. Smart packaging, generally speaking, refers to one or more computing elements affixed to a cosmetic product or tool or to the packaging thereof, so as to link the smart packaging element(s) to the cosmetic product or tool. Smart packaging elements may include, for example, one or more elements capable of RFID, Bluetooth, and/or near-field communications (NFC) with one or more user device(s), so as to be detectable when in proximity to the user device(s). In embodiments, the smart packaging elements transmit or otherwise indicate product identifying information, including for example a product identification number, brand, name, expiration date, and/or other identifying information (e.g., by encoding the identifying information in an RFID signal, a Bluetooth communication, etc.). In some embodiments, a smart packaging element may additionally include one or more sensors configured to measure one or more condition of a cosmetic product, e.g., to determine the integrity or safety of the cosmetic product. Information transmitted via one or more smart packaging elements may indicate the measurements of the one or more sensors and/or other determinations derived therefrom (e.g., the integrity or safety of the cosmetic product as determined by the smart packaging element(s) based upon the sensor measurements).

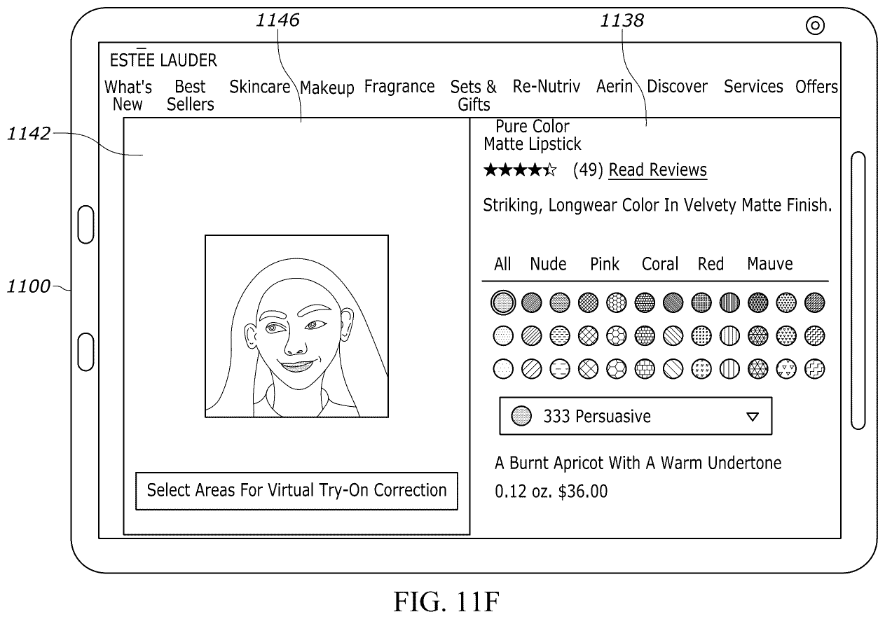

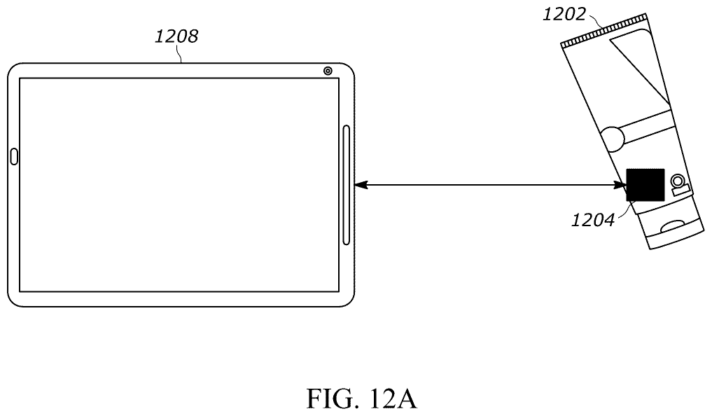

In view of the above, FIGS. 12A and 12B depict example systems incorporating smart packaging elements into technologies of this disclosure. Referring first to FIG. 12A, a cosmetic product 1202 (e.g., a skin cream) has a smart packaging element 1204 affixed thereto (i.e., one or more smart packaging elements physically affixed to the cosmetic product 1202 and/or to the packaging thereof). When the cosmetic product 1202 (and in turn, the smart packaging element 1204) is in proximity to a user device 1208 (i.e., any one or more user devices herein), the smart packaging element 1204 engages in signal communications with the user device 1208. In some embodiments, the user device 1208 contains an RFID reader and the smart packaging element includes an RFID tag, such that the user device 1208 receives RFID information from the RFID tag after transmitting an interrogation signal to the RFID tag. Additionally or alternatively, in other embodiments, the user device 1208 and the smart packaging element 1204 communicate via Bluetooth, near-field communications (NFC), and/or another communication protocol(s) capable of facilitating short-range communications between the user device 1028 and the smart packaging element 1204.

In any case, the user device 1208 receives product identifying information of the cosmetic product 1202 (e.g., a serial number, product name, brand, manufacturing date, manufacturing source, expiration date, sensor readings, etc.). Based upon the receives product identifying information, one or more graphical user interfaces (GUIs) execute at the user device 1208 to display the product identifying information and/or other information derived therefrom.

FIG. 12B depicts an example GUI 1220 that the user device 1208 may execute based upon product identifying information received at the user device 1208. As depicted in FIG. 12B, the GUI 1220 may display the product identifying information itself, and/or other data regarding the detected product that the GUI 1220 retrieves based upon the product identifying information. For example, where the product identifying information includes a name and/or serial number of the detected product, the GUI 1220 may retrieve corresponding additional product information from local memory of the user device 1208 and/or from one or more servers (e.g., an image of the product, product ingredients, manufacture or expiration dates, etc.).

The capability to identify the cosmetic product 1202 and obtain additional information about the cosmetic product 1202 through the smart packaging element 1204 can be integrated into various technologies of this disclosure. For example, as depicted in FIG. 12B, the user may select user interface elements in the GUI 1220 to save the product to their user profile (1222), share the product with other users (1224), virtually try on the product (1226), and/or add the product to a look (1228). Additionally or alternatively, the user may select another user interface element and/or obtain recommendations of other cosmetic products, routines, etc. (1230), with the recommendations being generated and presented based upon the user's possession of the cosmetic product 1202 (e.g., recommendations may include products similar to the cosmetic product 1202, routines or virtual guidance involving the cosmetic product 1202, and/or other cosmetic products complementing use of the cosmetic product 1202).

The smart packaging functionalities described herein may be incorporated into still other technologies of this disclosure, in various embodiments.

For example, in some embodiments, product identifying information received via smart packaging may be used to determine while the user browses products to determine whether the user is already in possession of same or similar products.

As another example, in some embodiments, smart packaging functionalities is integrated into virtual try-ons of cosmetic products and/or looks. For example, when the user virtually tries on one or more cosmetic products, systems of this disclosure may analyze received product identifying information to determine whether the user owns the one or more cosmetic products or similar products that would be needed to achieve a look. If the user does not own the required products, systems herein may present recommendations of the additional cosmetic product(s) the user may need to achieve the look.

As still another example, in embodiments, identification of cosmetic products via smart packaging is integrated into virtual guidance. For example, where one or more steps of a cosmetic routine require the use of a particular cosmetic product or tool, systems herein may analyze received product identifying information to verify whether the user has correctly retrieved the particular cosmetic product or tool upon performing the step(s). Systems herein may provide haptic output to indicate whether the user has correctly retrieved or placed the cosmetic product or tool, e.g., by generating and outputting a distinct haptic output type (e.g., vibration intensity, pattern, duration, location, etc.) corresponding to the identified cosmetic product or tool, where each product or tool may be associated with a unique vibration type.

As still yet another example, systems herein use identification of cosmetic products or tools via smart packaging to generate and present cosmetic regimens for the user. For example, upon identification of a cosmetic product or tool, systems herein may generate and present a regimen for the user that indicates (1) when and/or how to use the identified cosmetic product or tool, (2) how much of the identified cosmetic product to use in particular portions of the user's face or surrounding body parts, (3) when to purchase more of the identified cosmetic product or replace a cosmetic tool, and/or (4) what products to use in combination or in sequence with the identified cosmetic product or tool.

Where GUIs are described in this section, it should be appreciated that other types of user interfaces may be envisioned, in various embodiments. In embodiments, the user device 1208 provides audial output and/or haptic output of the received product identifying information (or other information derived therefrom), for example to aid users with one or more visual impairments in retrieving or identifying their cosmetic products to facilitate use of other technologies of this disclosure (e.g., to indicate that the user has or has not retrieved the correct product involved in a cosmetic routine where the user may not be able to recognize the cosmetic product 1202 through sight).

### Example Computer-Implemented Methods

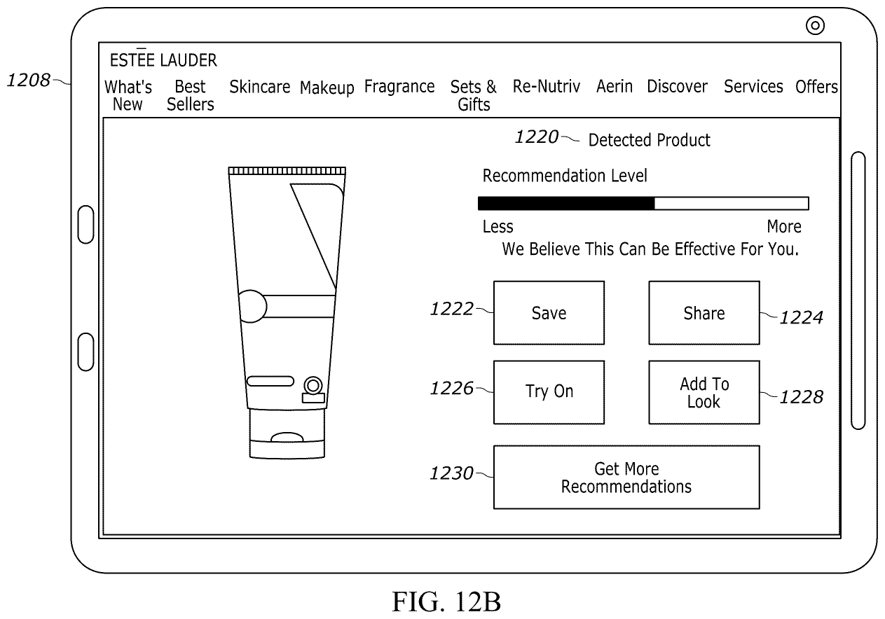

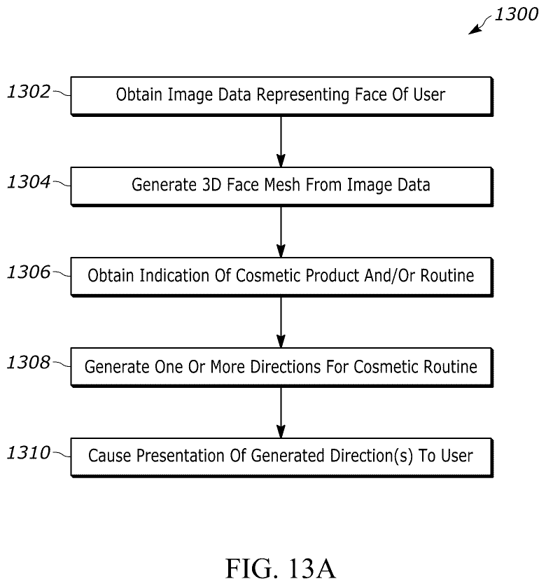

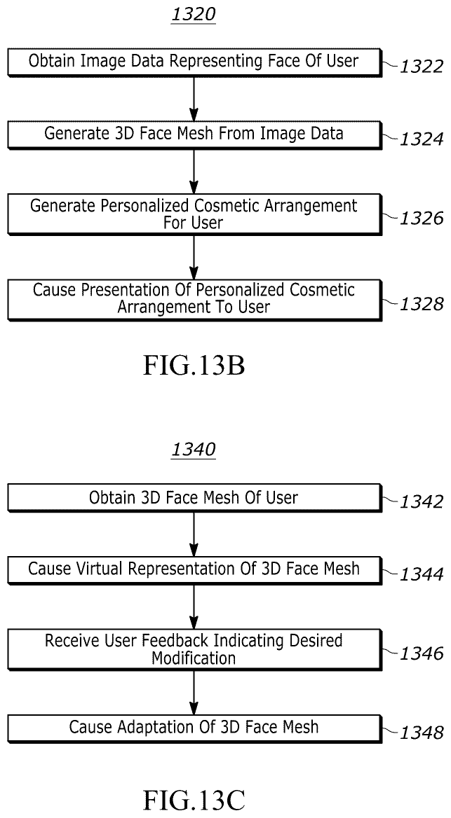

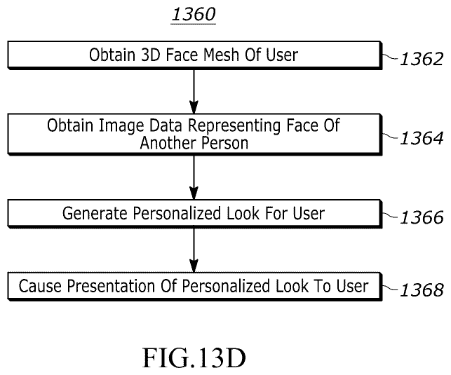

FIGS. 13A-13D depict example computer-implemented methods in view of the foregoing description. In various embodiments, the methods of FIGS. 13A-13D may be executed via one or more user devices of this disclosure, one or more servers of this disclosure, and/or some combination thereof. The methods of FIGS. 13A-13D may, for example, be performed via one or more processors executing instructions stored at one or more computer memories and/or one or more non-transitory computer readable media. Portions of the methods of FIGS. 13A-13D may be combined with each other and/or with other actions of this disclosure, in various embodiments.

Beginning with FIG. 13A, an example computer-implemented method 1300 includes obtaining image data representing a face of a user (1302). The method also 1300 includes generating a 3D face mesh of the user based upon the obtained image data (1304, e.g. using AI techniques of this disclosure). Additionally, the method 1300 includes obtaining an indication of a cosmetic product and/or a cosmetic routine associated with the cosmetic product (1306). Based upon the indicated cosmetic product and/or routine, the method 1300 generates one or more directions for the user with respect to a cosmetic routine (1308, e.g., to walk the user through one or more steps of the routine). Still additionally, the method 1300 includes causing the generated one or more directions to be presented to the user (1310), e.g., via one or more graphical user interfaces (GUIs), audial output (e.g., via natural language processing and/or text-to-speech), and/or haptic output (e.g., vibration).

Moving to FIG. 13B, another example computer-implemented method 1320 includes obtaining image data representing a face of a user (1322). The method 1320 also includes generating a three-dimensional face mesh based upon the obtained image data, the three-dimensional face mesh representing a plurality of facial features corresponding to the face of the user (1324). The method 1320 still further includes generating, based upon the three-dimensional face mesh of the user, a personalized cosmetic arrangement particular to the user (1326). Specifically, the personalized cosmetic arrangement may include (1) a plurality of cosmetic products to be applied to respective ones of the plurality of facial features represented by the generated three-dimensional face mesh, (2) one or more cosmetic routines to be performed upon at least one of the plurality of facial features represented by the generated three-dimensional face mesh, and/or (3) a recommendation one or more styles or techniques for applying at least one of the plurality of cosmetic products to the face of the user. Still yet further, the method 1320 includes causing an indication of at least a portion of the personalized cosmetic arrangement to be presented to the user via one or more output devices of one or more computing devices accessible to the user (1328, e.g., by virtually applying one or more of the cosmetic products to the user's face for example via AR techniques, via presenting directions for performing a cosmetic routine).

Proceeding to FIG. 13C, still another example computer-implemented method 1340 includes obtaining data indicating a three-dimensional face mesh representing a plurality of facial features corresponding to a face of a user (1342, e.g. via generating the three-dimensional face mesh). The method 1340 also includes causing a virtual representation of the three-dimensional face mesh to be presented to the user via one or more user interfaces at one or more computing devices accessible to the user (1344, e.g., via AR techniques of this disclosure). Still further, the method 1340 includes receiving, via the one or more user interfaces, user feedback indicating a desired modification of the three-dimensional face mesh (1346, e.g., indicating inaccurate facial point positioning, inaccurate characterization of a facial feature(s), and/or overall user satisfaction with a virtual application of one or more cosmetic products). Still yet further, the method 1340 includes causing the three-dimensional face mesh of the user to be adapted based upon the received user feedback (1348, e.g., by adapting, validating, and/or reapplying one or more machine learning algorithms/models for generating the face mesh, and/or causing the virtual representation of the face mesh to be updated at the user device(s) accordingly).

Moving now to FIG. 13D, still yet another example computer-implemented method 1360 includes obtaining a three-dimensional face mesh representing a plurality of facial features corresponding to a face of a user (1362). The method 1360 also includes obtaining image data representing a face of another person (1364). The image data representing the face of the another person indicates a desired cosmetic appearance or “inspiration” for the user. The method 1366 still further includes, based upon the obtained image data, generating a personalized look comprising a plurality of cosmetic products to be applied to the face of the user to replicate the desired cosmetic appearance on the plurality of facial features of the user (1366, e.g., indicating cosmetic products, styles for applying the cosmetic products, directions for applying/removing/adjusting the cosmetic products, etc., which can be based upon the user's previous activity with respect to looks, styles, products,). The method 1360 still yet further includes causing an indication of the generated look to be presented to the user via one or more user interfaces at one or more computing devices accessible to the user (1368).

### Additional Considerations

Use of “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise. A device or structure that is “configured” in a certain way is configured in at least that way but may also be configured in ways that are not listed.

The performance of certain of the operations described herein may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other embodiments, the one or more processors or processor-implemented modules may be distributed across a number of geographic locations.

Further, as used herein, the expressions “in communication,” “coupled” and “connected,” “communicatively coupled,” etc. including variations thereof, encompasses direct communication and/or indirect communication through one or more intermediary components, and does not require direct mechanical or physical (e.g., wired) communication and/or constant communication, but rather additionally includes selective communication at periodic intervals, scheduled intervals, aperiodic intervals, and/or one-time events. The embodiments are not limited in this context

Further still, unless expressly stated to the contrary, “or” refers to an inclusive or and not to an exclusive or. For example, “A, B or C” refers to any combination or subset of A, B, C such as (1) A alone, (2) B alone, (3) C alone, (4) A with B, (5) A with C, (6) B with C, and (7) A with B and with C. As used herein, the phrase “at least one of A and B” is intended to refer to any combination or subset of A and B such as (1) at least one A, (2) at least one B, and (3) at least one A and at least one B. Similarly, the phrase “at least one of A or B” is intended to refer to any combination or subset of A and B such as (1) at least one A, (2) at least one B, and (3) at least one A and at least one B.

Moreover, in the foregoing specification, specific embodiments have been described. However, one of ordinary skill in the art appreciates that various modifications and changes can be made in view of aspects of this disclosure without departing from the scope of the invention as set forth in the claims below. Accordingly, the specification and figures are to be regarded in an illustrative rather than a restrictive sense, and all such modifications made in view of aspects of this disclosure are intended to be included within the scope of present teachings.

Additionally, the benefits, advantages, solutions to problems, and any element(s) that may cause any benefit, advantage, or solution to occur or become more pronounced are not to be construed as a critical, required, or essential features or elements of any or all the claims.

Finally, any references, including, but not limited to, publications, patent applications, and patents cited herein are hereby incorporated in their entirety by reference to the same extent as if each reference were individually and specifically indicated to be incorporated by reference and were set forth in its entirety herein.

The patent claims at the end of this patent application are not intended to be construed under 35 U.S.C. § 112(f) unless traditional means-plus-function language is expressly recited, such as “means for” or “step for” language being explicitly recited in the claim(s). The communication systems and methods described herein are directed to improvements to computer and communication system functionality and performance.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

This detailed description is to be construed as exemplary only and does not describe every possible embodiment, as describing every possible embodiment would be impractical, if not impossible. One could implement numerous alternate embodiments, using either current technology or technology developed after the filing date of this application.

1. One or more non-transitory computer readable media storing instructions that, when executed via one or more processors of one or more computers, cause the one or more computers to:
obtain, via a camera unit, first real-time image data representing a face of a user;
generate a three-dimensional face mesh based upon the obtained first real-time image data, the three-dimensional face mesh representing a plurality of facial features corresponding to the face of the user;
obtain a first indication of at least one of (i) a cosmetic product, or (ii) a cosmetic routine to be performed upon the face of the user;
responsive to obtaining the first indication, generate a first one or more directions to the user for performing the cosmetic routine using the cosmetic product, the first one or more directions being generated based upon one or more features from among the plurality of facial features in the three-dimensional face mesh; and
cause a representation of the generated first one or more directions to be presented to the user as one or more augmented reality (AR) overlays over the first real-time image data in a graphical user interface (GUI) executing at the one or more output devices of one or more computing devices accessible to the user.

2. The one or more non-transitory computer readable media of claim 1, wherein the instructions to cause the representation of the generated first one or more directions to be presented comprise instructions to cause audial output of the first one or more directions to be presented via one or more speakers of the one or more computing devices accessible to the user.

3. The one or more non-transitory computer readable media of claim 1, wherein the instructions to cause the representation of the generated first one or more directions to be presented comprise instructions to cause haptic output indicating the first one or more directions to be presented via the one or more computing devices accessible to the user.

4. The one or more non-transitory computer readable media of claim 1, wherein the instructions, when executed via the one or more processors, further cause the one or more computers to:
obtain further image data representing the face of the user while the user performs the cosmetic routine after receiving the generated first one or more directions;
determine, based upon the further image data, whether the user accurately followed the generated first one or more directions; and
cause a second indication of whether the user accurately followed the generated first one or more directions to be presented via the one or more output devices of the one or more computing devices accessible to the user.

5. The one or more non-transitory computer readable media of claim 4, wherein the instructions to cause the second indication to be presented comprise instructions to cause audial or haptic feedback to be presented via the one or more output devices.

6. The one or more non-transitory computer readable media of claim 4, wherein the instructions, when executed via the one or more processors, further cause the one or more computers to:
modify a generation or provision of a second one or more directions for performing the cosmetic routine based upon whether the user accurately followed the generated first one or more directions.

7. The one or more non-transitory computer readable media of claim 4, wherein the instructions, when executed via the one or more processors, further cause the one or more computers to:
generate a recommendation of another cosmetic product, a cosmetic style, a cosmetic look, or another cosmetic routine for the user based upon whether the user accurately followed the generated first one or more directions.

8. The one or more non-transitory computer readable media of claim 1, wherein the instructions to obtain the first image data comprise instructions to obtain real-time image data via a camera unit of the one or more computing devices accessible to the user.

9. (canceled)

10. The one or more non-transitory computer readable media of claim 1, wherein the instructions, when executed via the one or more processors, cause the one or more computers to:
based upon the generated three-dimensional face mesh, track respective locations of the one or more features in further obtained image data representing the face of the user; and
update respective locations of at least one of the one or more AR overlays based upon the tracked respective locations of the one or more features.

11. The one or more non-transitory computer readable media of claim 1, wherein the first indication of the cosmetic product or cosmetic routine is based upon output of a recommendation module for recommending cosmetic products or cosmetic routines to the user.

12. The one or more non-transitory computer readable media of claim 11, wherein the instructions to obtain the first indication comprise instructions to receive, from among output of the recommendation module, a selection by the user indicating the cosmetic product or the cosmetic routine.

13. The one or more non-transitory computer readable media of claim 1, wherein the instructions to obtain the first indication comprise instructions to:
obtain further image data depicting a person, the further image data representing a desired cosmetic look for the user; and
analyze the further image data to identify the cosmetic product or the cosmetic routine for the user to achieve the desired cosmetic look.

14. The one or more non-transitory computer readable media of claim 1, wherein the instructions to obtain the first indication comprise instructions to:
via the one or more computing devices accessible to the user, detect a smart packaging element indicating product identifying information associated with the cosmetic product; and
identify the cosmetic product based upon the product identifying information indicated by the smart packaging element.

15. The one or more non-transitory computer readable media of claim 1, wherein at least one of the one or more computers is at least one of the one or more computing devices accessible to the user.

16. A computer-implemented method performed via one or more processors of one or more computers, the computer-implemented method comprising:
obtaining, via a camera unit, first real-time image data representing a face of a user;
generating a three-dimensional face mesh based upon the obtained first real-time image data, the three-dimensional face mesh representing a plurality of facial features corresponding to the face of the user;
obtaining a first indication of at least one of (i) a cosmetic product, or (ii) a cosmetic routine to be performed upon the face of the user;
responsive to obtaining the first indication, generating a first one or more directions to the user for performing the cosmetic routine using the cosmetic product, the first one or more directions being generated based upon one or more features from among the plurality of facial features in the three-dimensional face mesh; and
causing a representation of the generated first one or more directions to be presented to the user as one or more augmented reality (AR) overlays over the first real-time image data in a graphical user interface (GUI) executing at the one or more output devices of one or more computing devices accessible to the user.

17. The computer-implemented method of claim 16, wherein causing the representation of the generated first one or more directions to be presented comprises causing audial output of the first one or more directions to be presented via one or more speakers of the one or more computing devices accessible to the user.

18. The computer-implemented method of claim 16, wherein causing the representation of the generated first one or more directions to be presented comprises causing haptic output indicating the first one or more directions to be presented via the one or more computing devices accessible to the user.

19. The computer-implemented method of claim 16, further comprising:
obtaining further image data representing the face of the user while the user performs the cosmetic routine after receiving the generated first one or more directions;
determining, based upon the further image data, whether the user accurately followed the generated first one or more directions; and
causing a second indication of whether the user accurately followed the generated first one or more directions to be presented via the one or more output devices of the one or more computing devices accessible to the user.

20. The computer-implemented method of claim 19, wherein causing the second indication to be presented comprises causing audial or haptic feedback to be presented via the one or more output devices.

21. The computer-implemented method of claim 19, further comprising modifying a generation or provision of a second one or more directions for performing the cosmetic routine based upon whether the user accurately followed the generated first one or more directions.

22. The computer-implemented method of claim 19, further comprising generating a recommendation of another cosmetic product, a cosmetic style, a cosmetic look, or another cosmetic routine for the user based upon whether the user accurately followed the generated first one or more directions.

23. The computer-implemented method of claim 16, wherein obtaining the first image data comprises obtaining real-time image data via a camera unit of the one or more computing devices accessible to the user.

24. (canceled)

25. The computer-implemented method of claim 16, further comprising:
based upon the generated three-dimensional face mesh, tracking respective locations of the one or more features in further obtained image data representing the face of the user; and
updating respective locations of at least one of the one or more AR overlays based upon the tracked respective locations of the one or more features.

26. The computer-implemented method of claim 16, wherein the first indication of the cosmetic product or cosmetic routine is based upon output of a recommendation module for recommending cosmetic products or cosmetic routines to the user.

27. The computer-implemented method of claim 26, wherein obtaining the first indication comprises receiving, from among output of the recommendation module, a selection by the user indicating the cosmetic product or the cosmetic routine.

28. The computer-implemented method of claim 16, wherein obtaining the first indication comprises:
obtaining further image data depicting a person, the further image data representing a desired cosmetic look for the user; and
analyzing the further image data to identify the cosmetic product or the cosmetic routine for the user to achieve the desired cosmetic look.

29. The computer-implemented method of claim 16, wherein obtaining the first indication comprises:
via the one or more computing devices accessible to the user, detecting a smart packaging element indicating product identifying information associated with the cosmetic product; and
identifying the cosmetic product based upon the product identifying information indicated by the smart packaging element.

30. The computer-implemented method of claim 16, wherein at least one of the one or more computers is at least one of the one or more computing devices accessible to the user.

31. A computing system comprising:
one or more processors; and
one or more non-transitory memories storing computer executable instructions that, when executed via the one or more processors, cause the computing system to:
obtain, via a camera unit, first real-time image data representing a face of a user;
generate a three-dimensional face mesh based upon the obtained first real-time image data, the three-dimensional face mesh representing a plurality of facial features corresponding to the face of the user;
obtain a first indication of at least one of (i) a cosmetic product, or (ii) a cosmetic routine to be performed upon the face of the user;
responsive to obtaining the first indication, generate a first one or more directions to the user for performing the cosmetic routine using the cosmetic product, the first one or more directions being generated based upon one or more features from among the plurality of facial features in the three-dimensional face mesh; and
cause a representation of the generated first one or more directions to be presented to the user as one or more augmented reality (AR) overlays over the first real-time image data in a graphical user interface (GUI) executing at the one or more output devices of one or more computing devices accessible to the user.

32. The computing system of claim 31, wherein the one or more processors are included in the one or more computing devices accessible to the user.
